(19) United States
(12) Patent Application Publication
(10) Pub. No.: US 2025/0143372 A1
(43) Pub. Date: May 8, 2025

(54) PERSONAL VAPORIZING UNIT

(71) Applicant: Aether Innovations, LLC, Boise, ID (US)

(72) Inventors: Noah Mark MINSKOFF, Boise, ID (US); John William RUHSAM, Boise, ID (US); David Ryan CROWE, Seattle, WA (US); Mark S. McCOY, Foster City, CA (US); Alexis Marie Tivet RUHSAM, Lodi, CA (US)

(21) Appl. No.: 18/727,923

(22) PCT Filed: Jan. 5, 2023
(86) PCT No.: PCT/US2023/010238

§ 371 Date: Jul. 10, 2024

(51) Int. Cl. A24F 40/46; A24F 40/10; A24F 40/20; A24F 40/42; A24F 40/48; H05B 3/00

(52) U.S. Cl. CPC A24F 40/46; A24F 40/10; A24F 40/20; A24F 40/42; A24F 40/48; H05B 3/0052

(57) ABSTRACT

A vaporizer includes a reservoir (or cartridge) to hold a precursor composition. The reservoir has a passageway that is configured to not allow the free flow of the precursor composition out of the reservoir at ambient temperatures. An infrared radiation source, when activated, heats the precursor composition reducing its viscosity. An entrainment passageway is in communication with an exterior end of the passageway such that when an air flow is induced to pass through the entrainment passageway, the air flow draws the heated precursor composition from the passageway entrains it in the air flow. The entrained precursor may be vaporized and/or further vaporized by heat from the infrared radiation source before being inhaled by the user.

### BRIEF DESCRIPTION OF THE DRAWINGS

FIGS. 1A-1J are diagrams illustrating the elements of personal vaporizing units.

FIGS. 2A-2E illustrate a first example personal vaporizing unit.

FIGS. 3A-3C illustrate a second example personal vaporizing unit.

FIGS. 4A-4C illustrate a second example personal vaporizing unit.

FIGS. 5A-5D illustrate a third example personal vaporizing unit.

FIGS. 6A-6D illustrate a fourth example personal vaporizing unit.

FIGS. 7A-7D illustrate a fifth example personal vaporizing unit.

FIGS. 8A-8C illustrate a sixth example personal vaporizing unit.

FIG. 9 illustrates a seventh example personal vaporizing unit.

FIG. 10 illustrates an eighth example personal vaporizing unit.

FIGS. 11A-11D illustrate nineth and tenth example personal vaporizing units.

FIGS. 12A-12B illustrate an eleventh example personal vaporizing unit.

FIGS. 13A-13B illustrate an example sealing and filling system for a personal vaporizing unit cartridge.

FIG. 14A-14C illustrate a vacuum filling systems for a personal vaporizing unit cartridge.

FIGS. 15A-15B illustrates examples of systems that seal personal vaporizing unit cartridges.

FIGS. 16A-16F illustrate a twelfth example personal vaporizing unit.

FIGS. 17A-17E illustrate variations of a thirteenth example personal vaporizing unit.

FIGS. 18A-18B illustrate an example reservoir body of a personal vaporizing unit cartridge.

FIGS. 19A-19C illustrate example flow channel assemblies of a personal vaporizing unit.

FIGS. 20A-20C illustrate a fourteenth example personal vaporizing unit.

FIGS. 21A-21B illustrate a fifteenth example personal vaporizing unit.

FIGS. 22A-22B illustrate a sixteenth example personal vaporizing unit.

FIGS. 23A-23G illustrate variations of a seventeenth example personal vaporizing unit.

FIGS. 24A-24B illustrate an eighteenth example personal vaporizing unit.

FIGS. 25A-25D illustrate a nineteenth example personal vaporizing unit.

FIG. 26 illustrates example particle impaction features and flowpath.

FIGS. 27A-27B illustrates an example heater and heater housing assembly.

FIGS. 28A-28D illustrate example flow directing features and flowpath.

FIGS. 29A-29D illustrate a twentieth example personal vaporizing unit.

FIGS. 30A-30D illustrate a twenty-first example personal vaporizing unit.

### DETAILED DESCRIPTION OF THE EMBODIMENTS

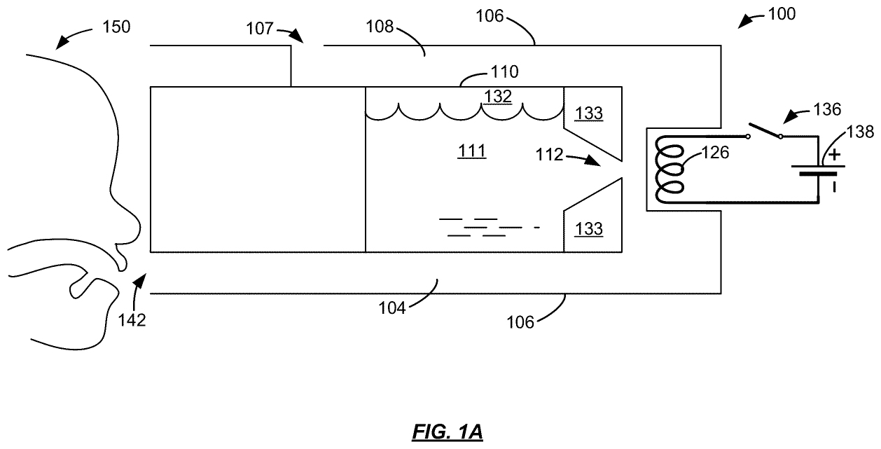

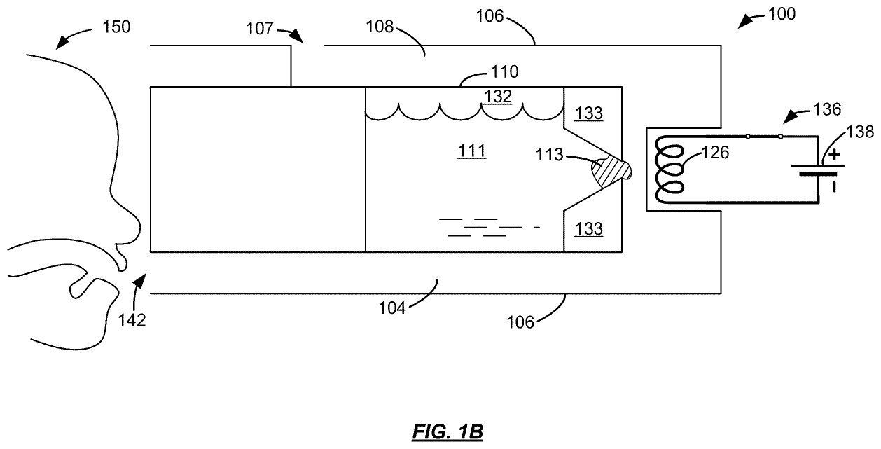

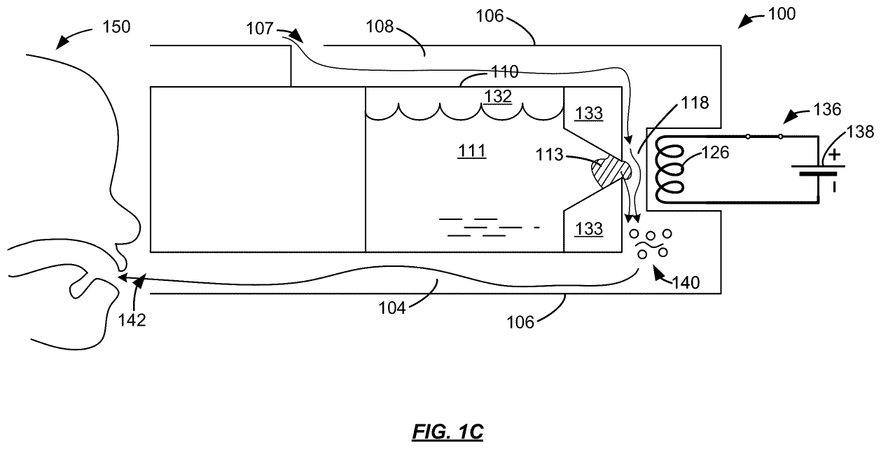

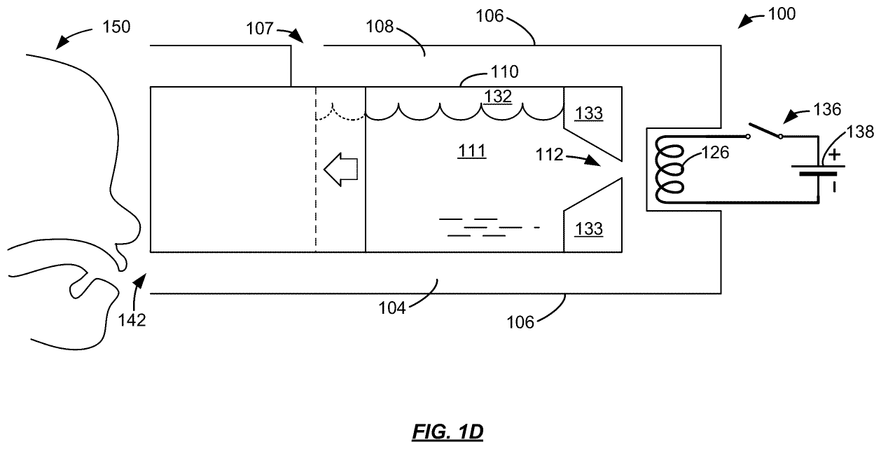

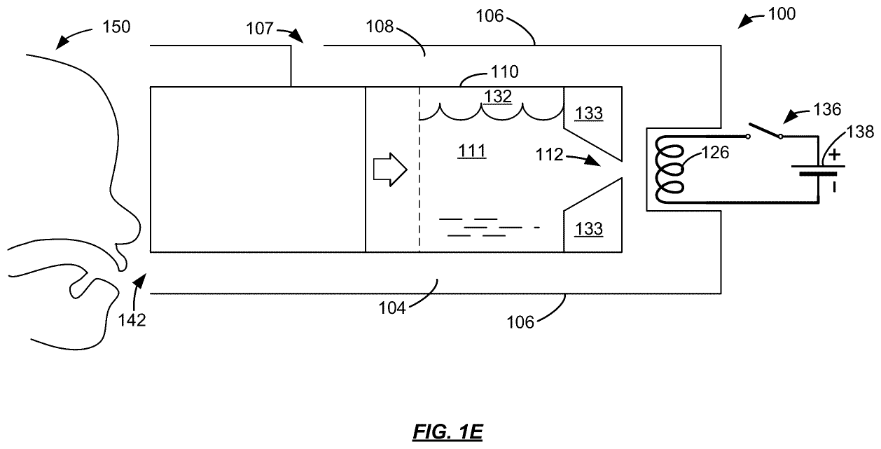

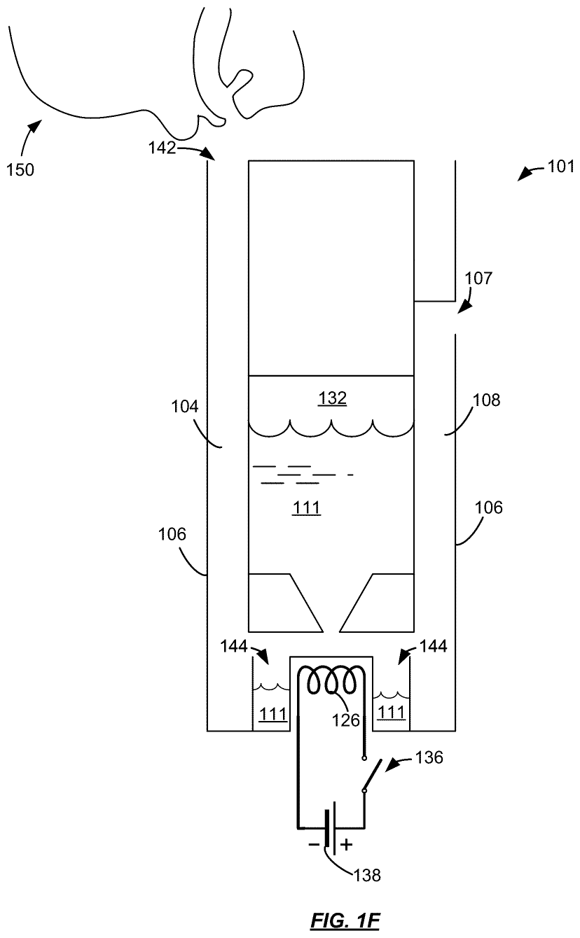

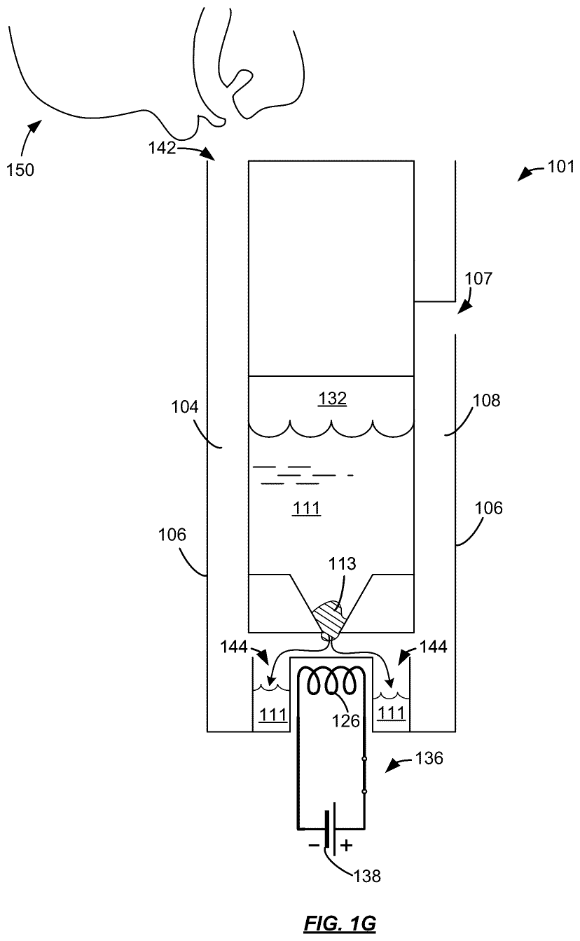

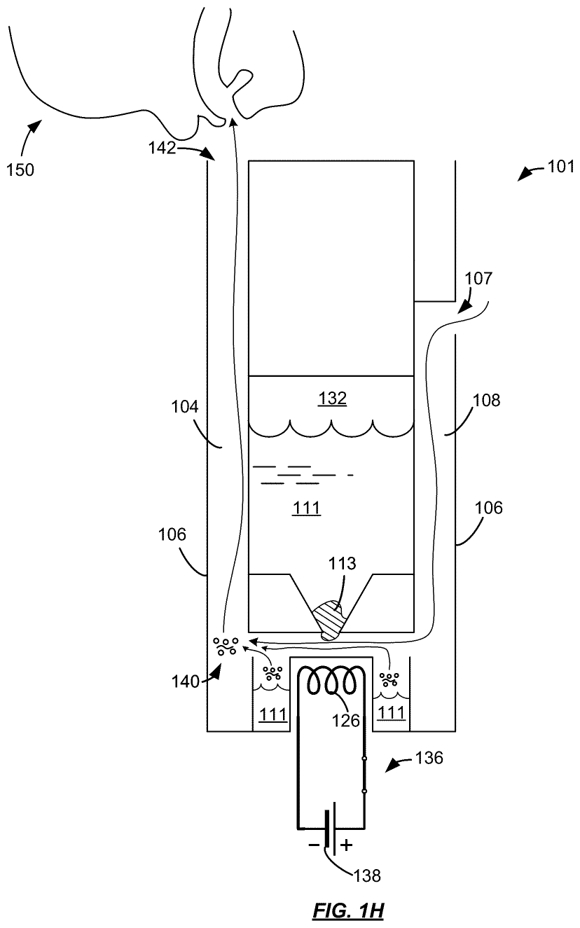

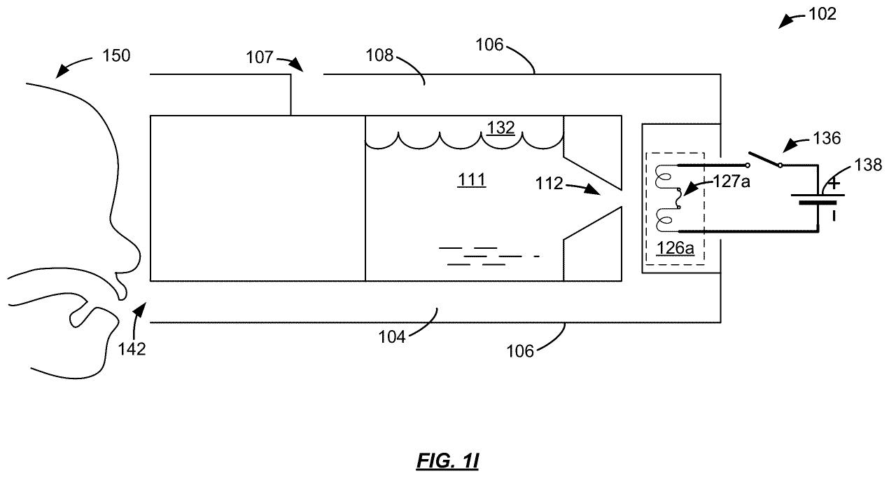

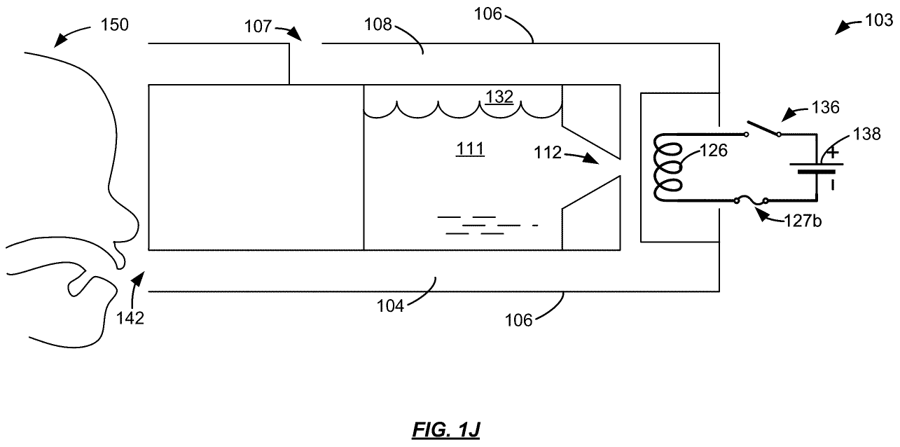

FIGS. 1A-1J are diagrams illustrating the elements of personal vaporizing units. In FIGS. 1A-1J, personal vaporizing unit (PVU) 100, PVU 101, PVU 102, and PVU 103 arc operated by user 150. User 150 inhales the vaporized substance produced by PVU 100 or PVU 101. PVU 100 and PVU 101 comprise housing 106, precursor composition 111, precursor reservoir 132, heater 126, switch 136, and battery 138. PVU 101 further comprises secondary reservoir 144 configured to hold at least some of precursor composition 111 that has exited precursor reservoir 132. In particular, secondary reservoir 144 is configured to hold at least some of precursor composition 111 that has exited precursor reservoir 132 in thermal contact with or in thermal proximity to heater 126. Housing 106 includes air intake 107. In an embodiment, housing 106 may be or comprise a polycarbonate material and/or other thermoplastic polymer. In some embodiments, precursor reservoir 132 is configured as a cartridge that is removable from PVU 100 and/or PVU 101 and replaceable. This removability and replaceability of reservoir 132 allows PVU 100 and/or PVU 101 to be provisioned with different precursor composition 111 compositions and/or refilled with precursor composition 111. In some embodiments, reservoir 132 is a cavity defined wholly or in part by reservoir body 110. Reservoir body 110 may comprise a glass tube or be formed from a glass tube. It should be understood that reservoir 132 comprises at least some of the volume inside reservoir body 110. In some embodiments, the wall 133 of reservoir 132 which defines precursor passageway 112 comprises glass (e.g., fused to a glass tube or formed from a portion of a glass tube).

A first gap between the interior surface of housing 106 and the exterior surface of precursor reservoir 132 defines an air intake passageway 108 running from air intake 107 to heater 126. A second gap between the interior surface of housing 106 and the exterior surface of precursor reservoir 132 defines a vapor passageway 104 running from heater 126 to a vapor outlet 142. Precursor reservoir 132 includes precursor passageway 112. The opening of precursor passageway 112 is in close proximity to heater 126 such that when heater 126 is activated, heater 126 may melt or soften (i.e., lower the viscosity of) precursor composition 111. In some embodiments, precursor composition 111 may be a solid at room temperatures. In some embodiments, precursor composition 111 may be a semi-solid (e.g., consistency of warm but not melted butter) or thick liquid (e.g., consistency of honey or molasses) at room temperatures.

In some embodiments, heater 126 functions as an infrared radiation (IR) source. Thus, heater 126 is able to heat (and thereby melt or soften) precursor composition 111 without directly contacting precursor composition 111. Similarly, heater 126 may function to heat flowing air and/or vapor in the vicinity of heater 126 without directly contacting the air and/or vapor. In an embodiment, the shape and/or composition of the end of reservoir 132 that includes precursor passageway 112 may be configured to reflect and/or direct IR radiation from heater 126. In particular, the shape and/or composition of the end of reservoir 132 that includes precursor passageway 112 may be configured to focus or concentrate IR radiation from heater 126 on a desired target, volume, area, or substance (e.g., entrainment passageway 118 and/or precursor passageway 112).

In some embodiments, reservoir body 110 may be or comprise glass (e.g., borosilicate glass). In some embodiments, reservoir body 110 may be or comprise plastic (e.g., high temperature, non-reactive, food safe, etc.). Reservoir body 110 may be or comprise a molded, formed, and or machined glass (or plastic) tube configured to hold precursor composition 111 and release heated precursor composition 113 via precursor passageway 112. In some embodiments, precursor reservoir 132 may be defined by reservoir body 110 with a first end that is permanently or releasably closed (e.g., by a stopper, a cap, sealing, or other element(s) that functions to prevent the flow of precursor composition 111 out of precursor reservoir 132).

Precursor reservoir 132 may defined by reservoir body with a second end that is substantially closed except for precursor passageway 112. Precursor passageway 112 may be configured (e.g., diameter, length, and/or other dimensions) to not allow precursor composition 111 to flow freely out of reservoir 132 unless precursor composition 111 is heated to a threshold temperature above ambient temperature. In other words, precursor passageway 112 may have a diameter that is small enough to prevent the flow of precursor composition 111 through precursor passageway 112 when precursor composition 111 is within a selected or standardized, and precursor composition 111 composition dependent, temperature range. Examples of temperature ranges that precursor passageway 112 may not allow precursor composition 111 to flow through 112 passageway include: less than 50° C., less than 100° C., less than 120° C., less than 150° C., and less than 200° C. Other ranges and/or temperature thresholds may be selected based on the characteristics of precursor composition 111 (e.g., melting point, viscosity vs. temperature curve) etc., hydrostatic conditions, and the interactions thereof with the dimensions of precursor passageway 112.

When the user activates PVU 100 by closing switch 136, electrical current from battery 138 causes heater 126 to heat precursor composition 111 thereby melting or lowing the viscosity of precursor composition 111 in and/or around precursor passageway 112. This is illustrated in FIG. 1B by heated precursor composition 113.

When the user provides suction at vapor outlet 142 (e.g., by inhaling), air is drawn into PVU 100 via air intake 107. The air is pulled along air intake passageway 108 to entrainment passageway 118 which is located between heater 126 and precursor passageway 112. This is illustrated in FIG. 1C by the arrow running from air intake 107 to entrainment passageway 118.

In an embodiment, heated precursor composition 113 is not heated by heater 126 enough to freely flow into entrainment passageway 118 without further force. Rather, in this embodiment, the air flowing through entrainment passageway 118 (as provided by user 150 inhalation) provides the additional force to mobilize heated precursor composition 113 to flow from entrainment passageway 118. In this manner, the amount of heated precursor composition 113 drawn into entrainment passageway 118 (and thus ultimately inhaled by user 150) is based and/or determined by the amount and force of inhalation by user 150. Thus, user 150 may increase the dosage (per inhale) of precursor composition 111 inhaled by inhaling more rapidly, forcefully, and/or longer. Likewise, a less rapid, forceful, or shorter inhale (or inhale profile) may decrease the dosage per inhale provided to user 150.

In an embodiment, entrainment passageway 118 may be shaped in two or three dimensions to increase the flow of air across the opening of precursor passageway 112. For example, 112 passageway may be configured (e.g., radially-not shown in FIGS. 1A-1I) to create a vortex in the air flowing in the vicinity of the opening of precursor passageway 112. In some embodiments, one or more selected fluid dynamic effects such as the Venturi effect and/or the Coanda may be used (with or without creating a vortex) to aid in the mobilization of heater precursor composition 113 into the air flowing through entrainment passageway 118. In some embodiments, the configuration, shape, and/or dimensions of entrainment passageway 118 and its relationship and configuration in the vicinity of the end of precursor passageway 112 that is in communication with entrainment passageway 118 may be or comprise all or part of elements commonly knowns as air ejectors, Venturi pumps, or vacuum ejectors.

Heated precursor composition 113 is drawn from precursor reservoir 132 and entrained with, and vaporized by, the moving and heated air to form vapor 140. This is illustrated in FIG. 1C by the arrow from heated precursor composition 113 and the arrow running through entrainment passageway 118 leading to vapor 140. As used herein, the term “vapor” should be understood to include not only the state of precursor composition 111 (and other precursors and precursor compositions disclosed herein) as a gas, but may include aerosol forms/states and/or a mixtures of gas and aerosol states.

Vapor 140 is then drawn along vapor passageway to exit PVU 100 via vapor outlet 142 to be inhaled by user 150. This is illustrated in FIG. 1C by the arrow running along vapor passageway 104 from vapor 140 to user 150.

In an embodiment, one or more walls of precursor reservoir 132 may be displaced or be subject to a force or pressure. If the force, displacement, or pressure is disposed to expand the volume of precursor reservoir 132, precursor composition 111 is subject to a lowered pressure relative to ambient conditions. This lowered pressure will tend to draw precursor composition 111 (and heated precursor composition 113, in particular) back into precursor reservoir 132. This is illustrated in FIG. 1D by the arrow displacing the left side of reservoir 130 to increase the volume of reservoir 130.

If the force, displacement, or pressure is disposed to reduce the volume of precursor reservoir 132, precursor composition 111 is subject to a increased pressure relative to ambient conditions. This increased pressure will tend to expel precursor composition 111 (and heated precursor composition 113, in particular) from precursor reservoir 132. This is illustrated in FIG. 1E by the arrow displacing the left side of reservoir 130 to decrease the volume of reservoir 130.

FIGS. 1F-1H further illustrate the construction and operation of PVU 101. In addition to the elements discussed with respect to PVU 100, PVU 101 includes a secondary reservoir 144. Secondary reservoir 144 is configured to receive precursor composition 111 from precursor reservoir 132. In particular, when heater 126 is activated and creates heated precursor composition 113, the lower viscosity of heated precursor composition 113 allows heated precursor composition 113 to flow from precursor reservoir 132 into secondary reservoir 144. This is illustrated in FIG. 1G by the arrows flowing from heated precursor composition 113 into secondary reservoir 144. In an embodiment, heated precursor composition 113 may be heated enough to flow into secondary reservoir 144 but without vaporizing heated precursor composition 113. In an embodiment, this is accomplished when the user 150 activates heater 126 without inhaling via vapor outlet 142.

In another embodiment, heated precursor composition 113 may be heated enough to flow into secondary reservoir 144 but without vaporizing by having two activation states for heater 126: (1) a low power activation that heats precursor composition 111 to a point where heated precursor composition 113 flows into secondary reservoir 144 without vaporizing, and (2) a high power activation that heats precursor composition 111 to a point where heated precursor composition 113 vaporizes and also vaporizes precursor composition 111 that is present in secondary reservoir 144. Typically, the high power activation would be used while the user 150 is inhaling. The activation of PVU 101 with enough heater 126 power to vaporize precursor composition 111 stored in secondary reservoir 144 is illustrated in FIG. 1H.

In another embodiment, heater 126 may be constructed and configured to act as an electrical fuse. This embodiment is illustrated in FIG. 1I by PVU 102. In an example, the materials (e.g., nichrome, tungsten, deposited conductors, etc.) and/or geometry that comprise heater 126a may be selected such that heater 126a such that at least a sacrificial portion 127a of heater 126a melts when too much current flows through heater 126a thereby stopping or interrupting the current from battery 138. Thus, heater 126a may be or comprise a sacrificial portion 127a that once operated in an overcurrent region becomes an open circuit, and must be replaced.

In another embodiment, PVU 100 may include an electrical fuse. This embodiment is illustrated in FIG. 1J by PVU 103. In an example, fuse 127b is in series with heater 126 and battery 138 such that when too much current flows through heater 126 a portion of fuse 127b melts thereby stopping or interrupting the current from battery 138. Thus, once heater 126 is operated in an overcurrent region, fuse 127b becomes an open circuit, and must be replaced.

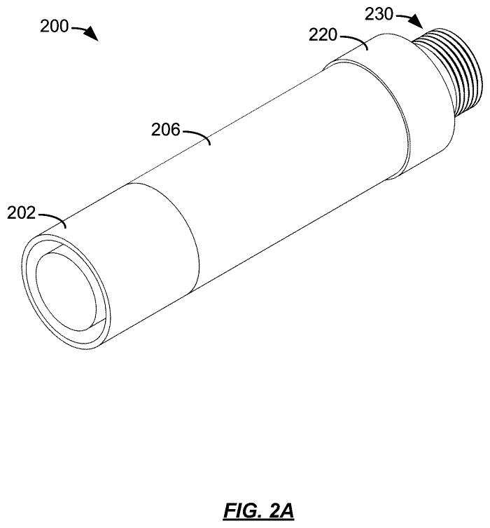

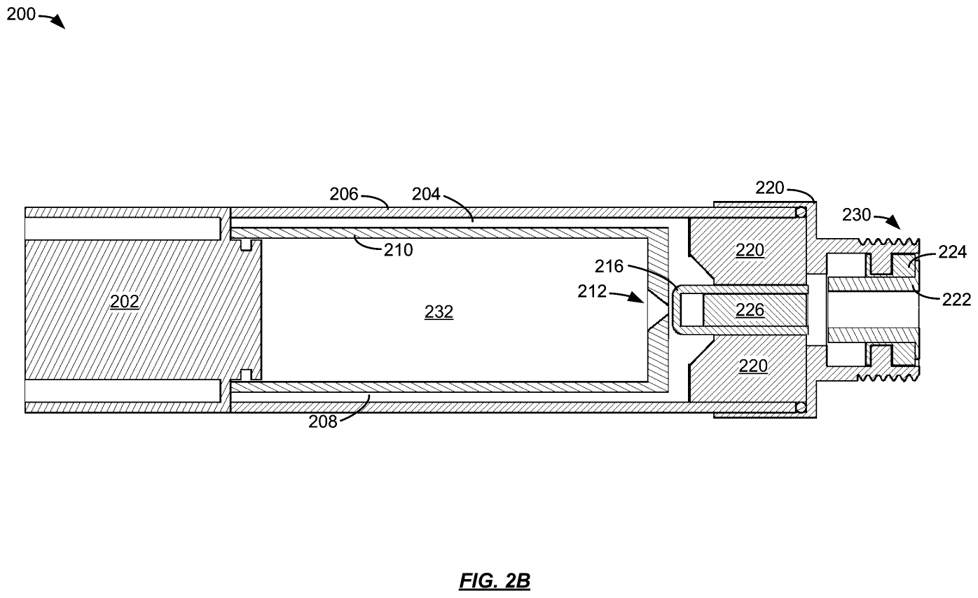

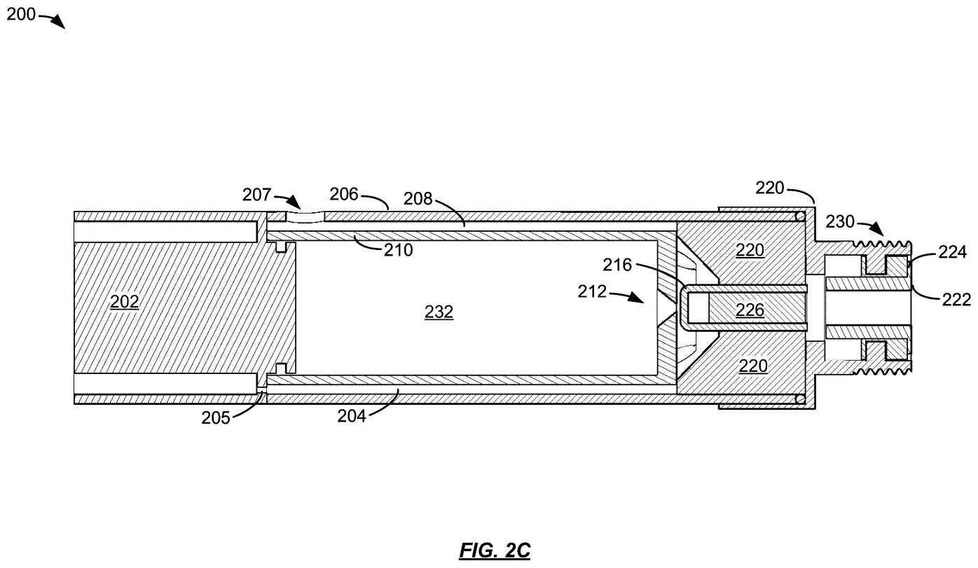

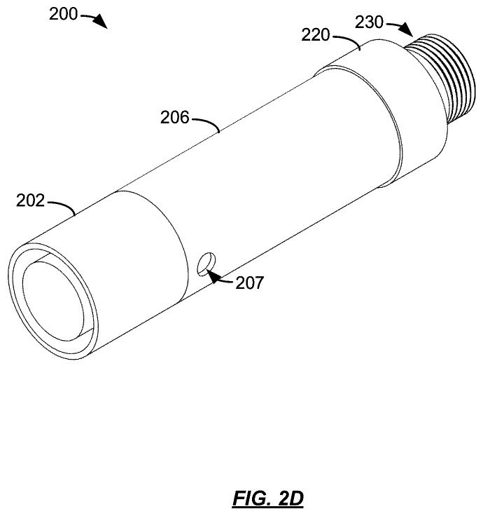

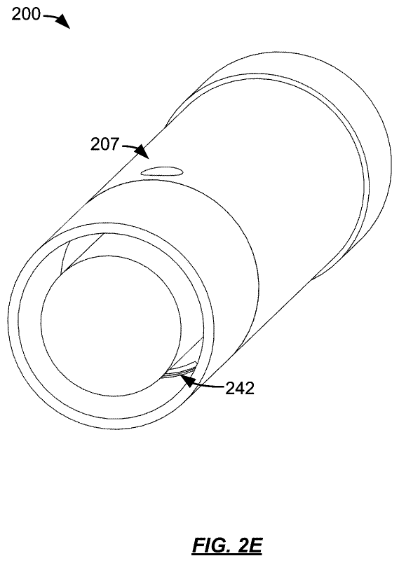

FIGS. 2A-2E illustrate a first example personal vaporizing unit. In FIGS. 2A-2E, PVU 200 comprises mouthpiece 202, vapor passageway 204, exterior housing 206, air intake 207, air intake passageway 208, reservoir body 210, precursor passageway 212, heater housing 216, base 220, electrode 222, electrode O-ring 224, heater 226, threads 230, reservoir 232, and vapor outlet 242. Reservoir 232 comprises at least some of the volume inside reservoir body 210 In some embodiments, the wall of reservoir 232 which defines precursor passageway 212 comprises glass (e.g., fused to a glass tube or formed from a precursor portion of a glass tube). Threads 230 allow PVU 200 to be screwed onto a battery (e.g., battery 138) to provide switched power to heater 226 (not shown in FIGS. 2A-2E) via electrode 222. PVU 200 is constructed and operates in a manner similar to PVU 100 described herein. Accordingly, for the sake of brevity, this discussion will not be repeated with respect to FIGS. 2A-2E. FIG. 2B and FIG. 2C are cross-sections of PVU 200 along different cut lines that additionally illustrate the formation and separation of air intake passageway 208 from vapor passageway 204 and their communication with heater housing 216 and precursor passageway 212.

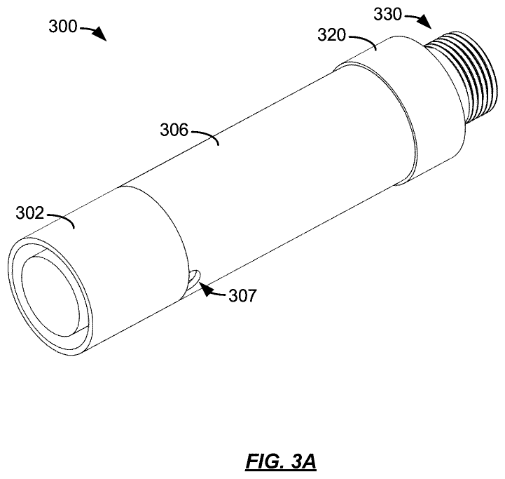

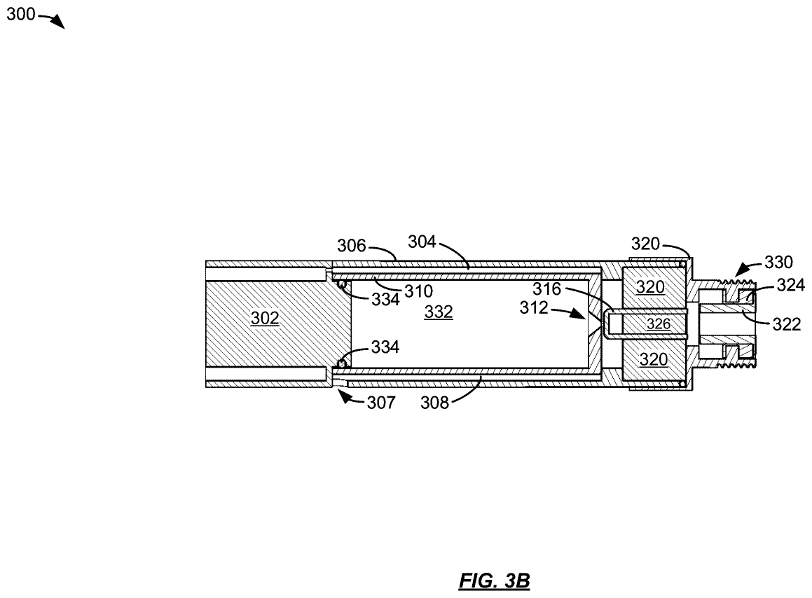

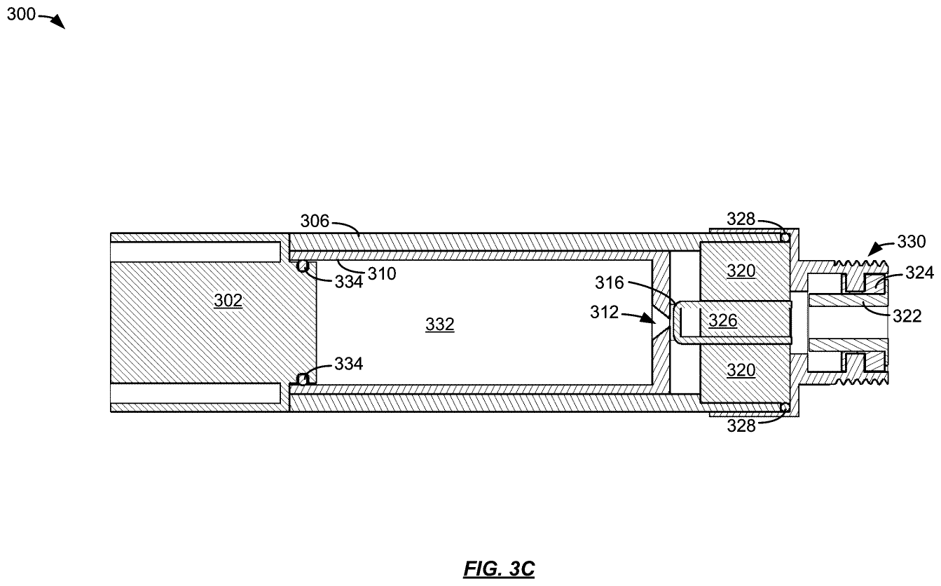

FIGS. 3A-3C illustrate a second example personal vaporizing unit. In FIGS. 3A-3C, PVU 300 comprises mouthpiece 302, vapor passageway 304, exterior housing 306, air intake 307, air intake passageway 308, reservoir body 310, precursor passageway 312, heater housing 316, base 320, electrode 322, electrode O-ring 324, heater 326, mouthpiece O-ring 334, and threads 330. Threads 330 allow PVU 300 to be screwed onto a battery (e.g., battery 138) to provide switched power to heater 326 (not shown in FIGS. 3A-3C) via electrode 322. PVU 300 is constructed and operates in a manner similar to PVU 100 and other PVUs described herein. Accordingly, for the sake of brevity, this discussion will not be repeated with respect to FIGS. 3A-3C. FIG. 3B and FIG. 3C are cross-sections of PVU 300 along different cut lines that additionally illustrate the formation and separation of air intake passageway 308 from vapor passageway 304 and their communication with heater housing 316 and precursor passageway 312.

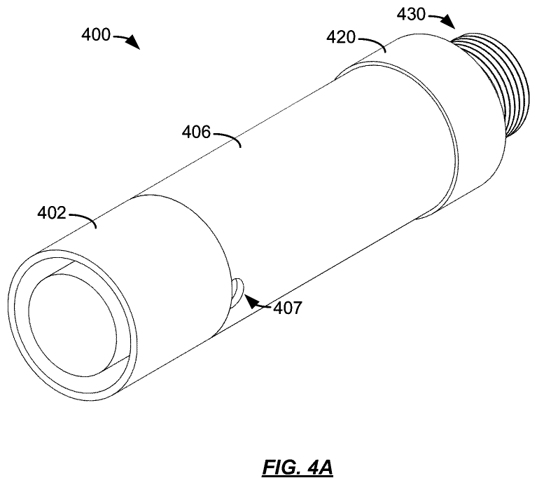

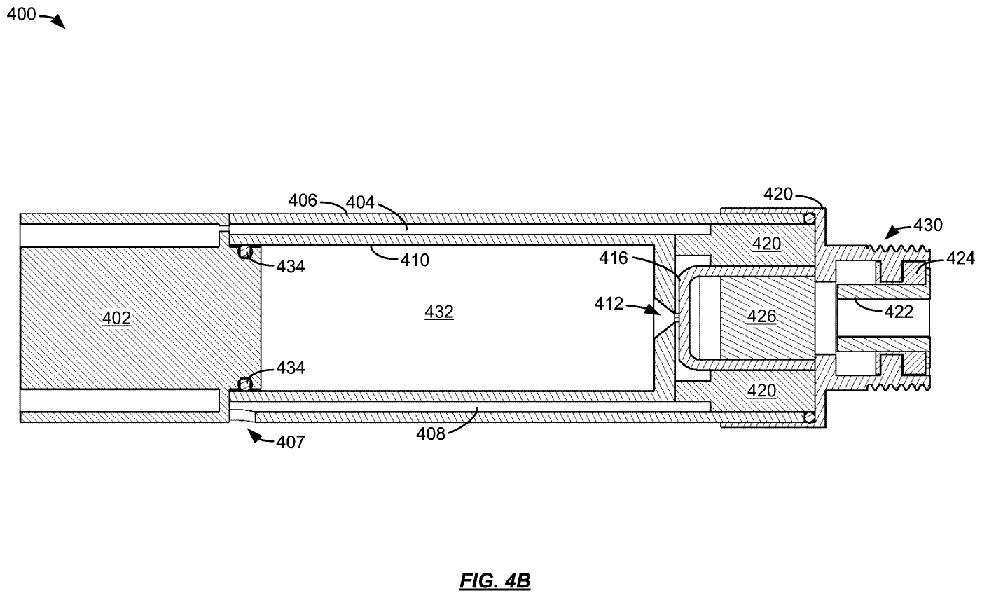

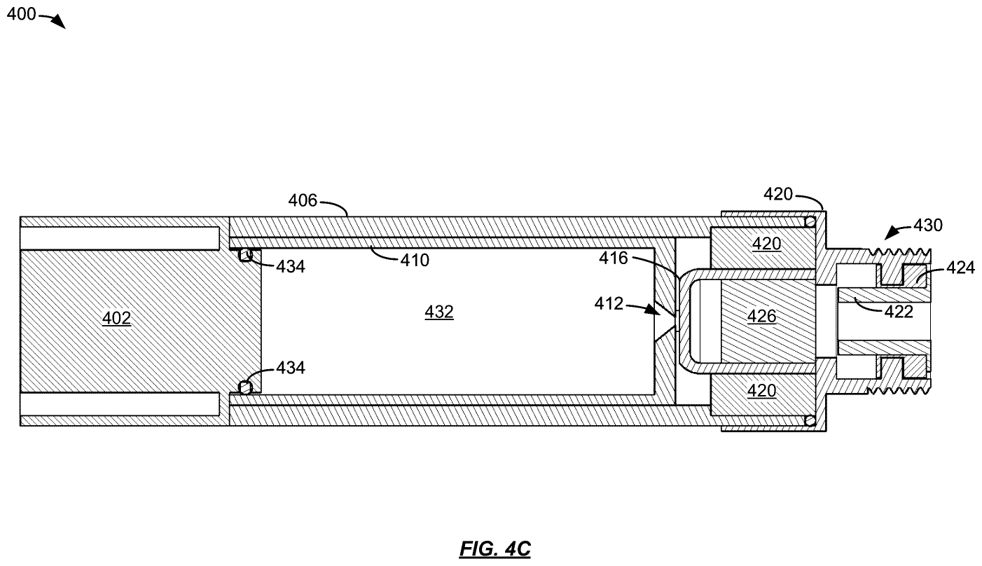

FIGS. 4A-4C illustrate a second example personal vaporizing unit. In FIGS. 4A-4C, PVU 400 comprises mouthpiece 402, vapor passageway 404, exterior housing 406, air intake 407, air intake passageway 408, reservoir body 410, precursor passageway 412, heater housing 416, base 420, electrode 422, electrode O-ring 424, heater 426, mouthpiece O-ring 434, and threads 430. Threads 430 allow PVU 400 to be screwed onto a battery (e.g., battery 138) to provide switched power to heater 426 (not shown in FIGS. 4A-4C) via electrode 422. PVU 400 is constructed and operates in a manner similar to PVU 100 and other PVUs described herein. Accordingly, for the sake of brevity, this discussion will not be repeated with respect to FIGS. 4A-4C. FIG. 4B and FIG. 4C are cross-sections of PVU 400 along different cut lines that additionally illustrate the formation and separation of air intake passageway 408 from vapor passageway 404 and their communication with heater 416 and precursor passageway 412.

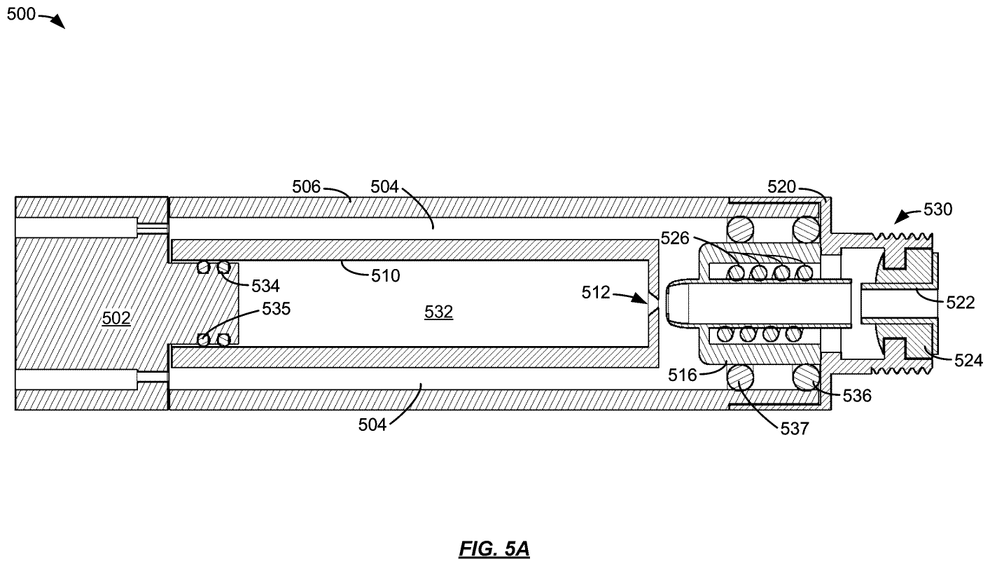

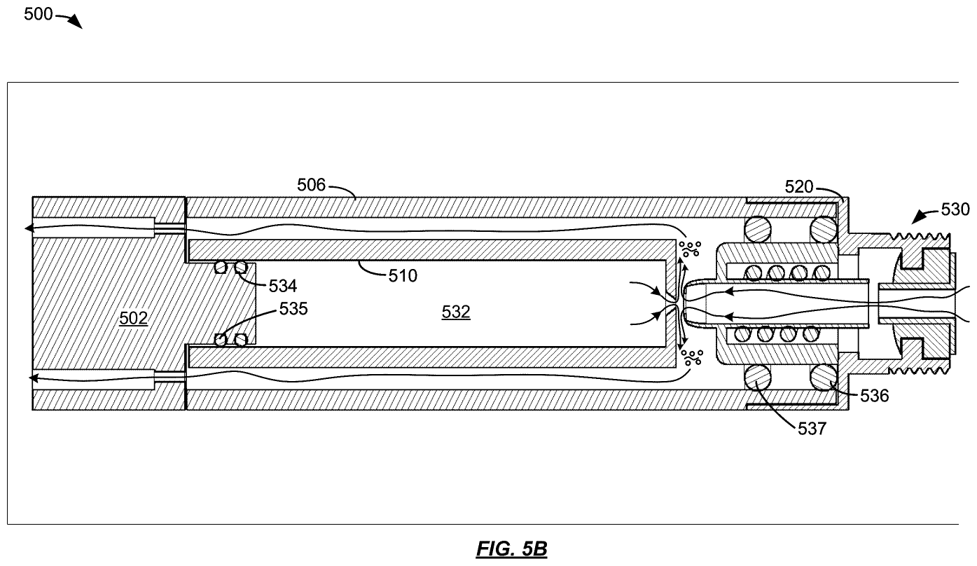

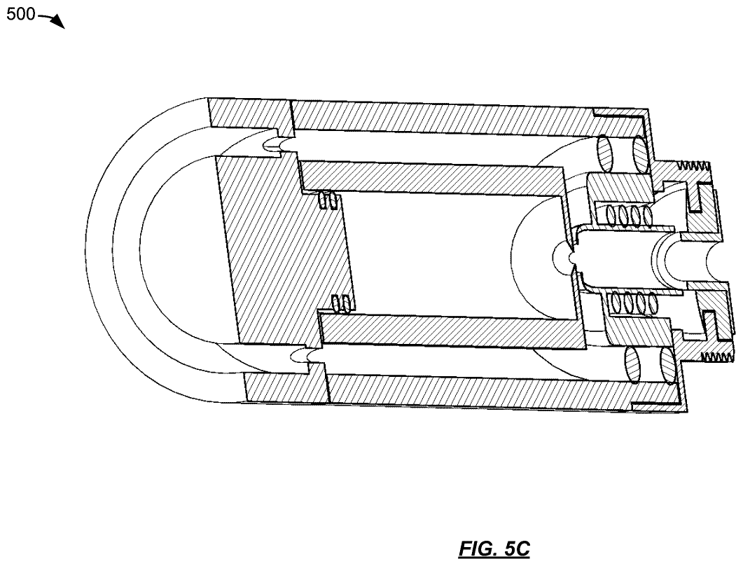

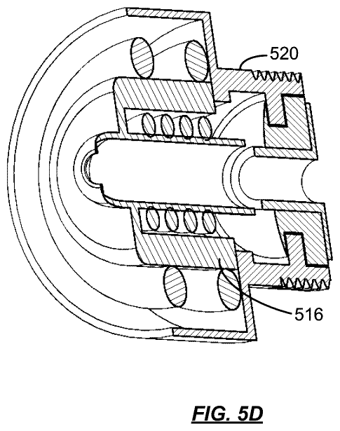

FIGS. 5A-5D illustrate a third example personal vaporizing unit. In FIGS. 5A-5D, PVU 500 comprises mouthpiece 502, vapor passageway 504, exterior housing 506, reservoir body 510, precursor passageway 512, heater housing 516, base 520, electrode 522, electrode O-ring 524, heater 526, mouthpiece O-ring 534, mouthpiece O-ring 535, base O-ring 536, base O-ring 537, and threads 530. Threads 530 allow PVU 500 to be screwed onto a battery (e.g., battery 138) to provide switched power to heater 526 (not shown in FIGS. 5A-5D) via electrode 522. PVU 500 is constructed and operates in a manner similar to PVU 100 and other PVUs described herein except in contrast to PVU 100, the air intake function is performed by a passageway in electrode 522. The air and vapor flows of PVU 500 are illustrated in FIG. 5B. Accordingly, for the sake of brevity, the general discussion of inhaling, heating, entrainment, etc. will not be repeated with respect to FIGS. 5A-5D. FIG. 5C is an isometric cross-section of PVU 500 that additionally illustrate PVU 500. FIG. 5D is an isometric cross-section of the base and heater elements of PVU 500 that additionally illustrate PVU 500.

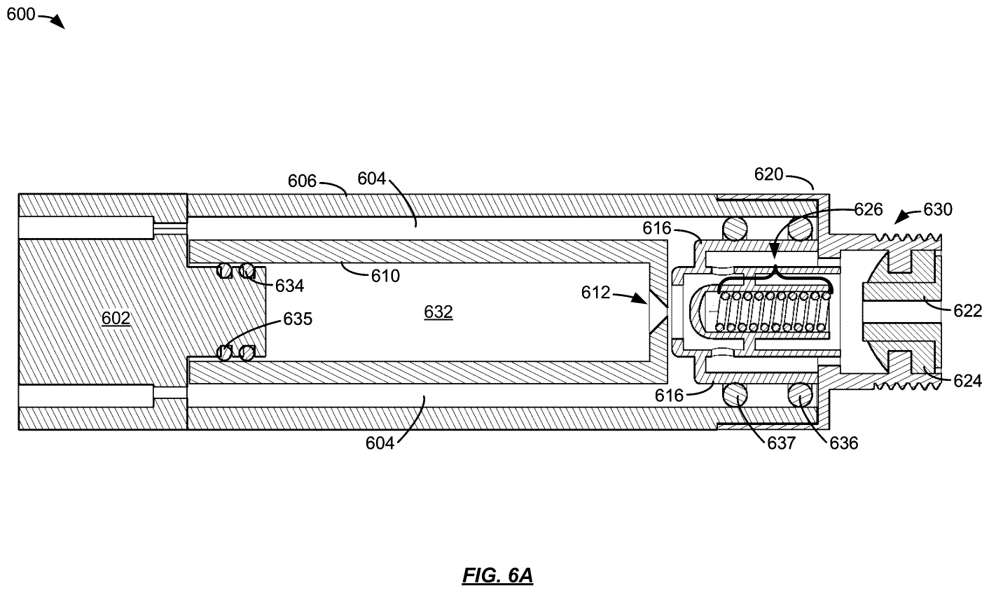

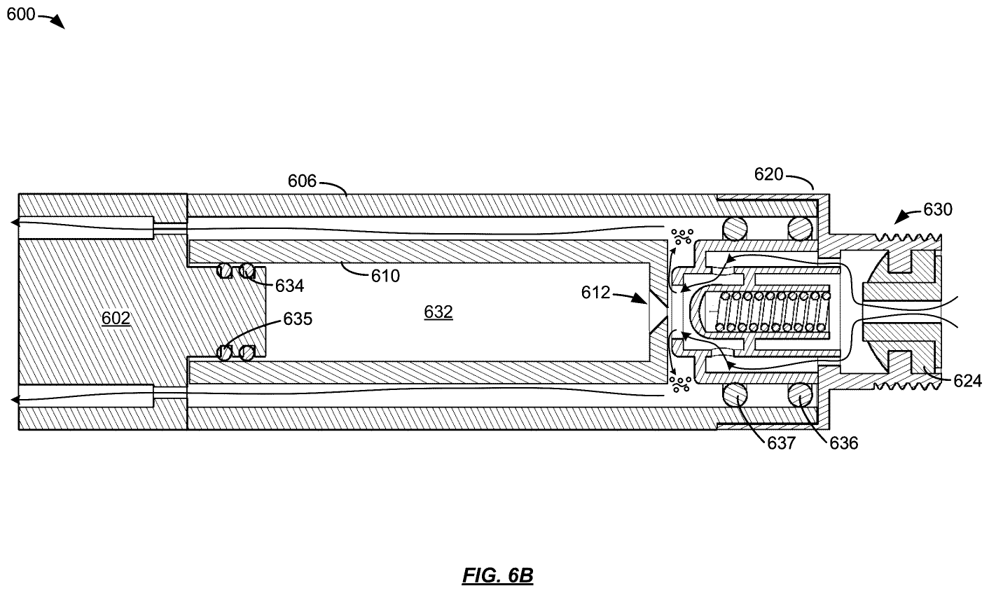

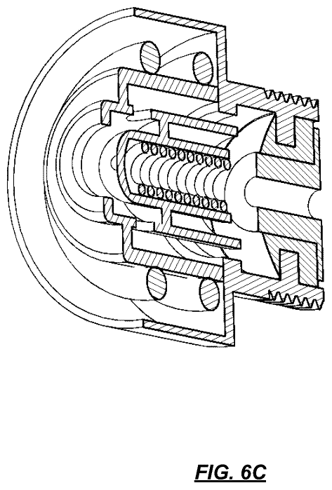

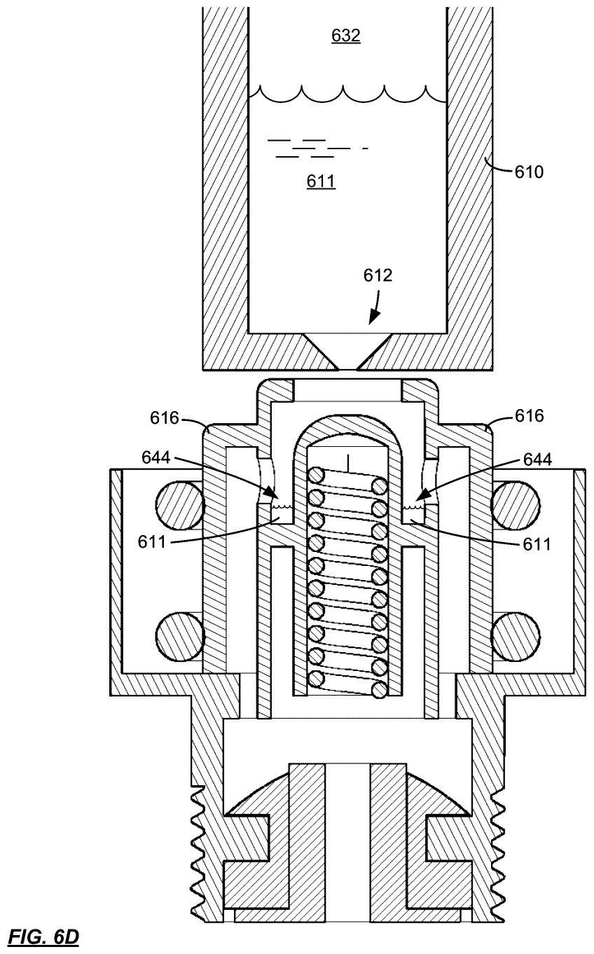

FIGS. 6A-6D illustrate a fourth example personal vaporizing unit. In FIGS. 6A-6D, PVU 600 comprises mouthpiece 602, vapor passageway 604, exterior housing 606, reservoir body 610, precursor composition 611, precursor passageway 612, heater housing 616, base 620, electrode 622, electrode O-ring 624, heater 626, mouthpiece O-ring 634, mouthpiece O-ring 635, base O-ring 636, base O-ring 637, threads 630, and secondary reservoir 644. Threads 630 allow PVU 600 to be screwed onto a battery (e.g., battery 138) to provide switched power to heater 626 (not shown in FIGS. 6A-6D) via electrode 622. PVU 600 is constructed and operates in a manner similar to PVU 101 and other PVUs described herein except that in contrast to PVU 100 the air intake function is performed by a passageway in electrode 622. The air and vapor flows of PVU 600 are illustrated in FIG. 6B. Accordingly, for the sake of brevity, the general discussion of inhaling, heating, entrainment, etc. will not be repeated with respect to FIGS. 6A-6D. FIG. 6C is an isometric cross-section of the base and heater elements of PVU 600 that additionally illustrate PVU 600.

FIG. 6D illustrates in more detail secondary reservoir 644. Secondary reservoir 644 is formed by heater housing 616 such that when unvaporized precursor composition 611 flows out of precursor reservoir 632 via precursor passageway 612 and is not vaporized, the unvaporized precursor composition 611 is “captured” by secondary reservoir 644. Secondary reservoir 644 may capture and/or hold unvaporized precursor composition 611 using one or more of gravity, surface tension, capillary action, and/or viscosity changes (e.g., cooling). Thus, it should be understood that secondary reservoir 644 may performs the same function for PVU 600 as secondary reservoir 144 performs for PVU 101. Accordingly, for the sake of brevity, the function, operating principles, etc. of secondary reservoir 644 of PVU 600 will not be repeated herein with respect to FIG. 6D.

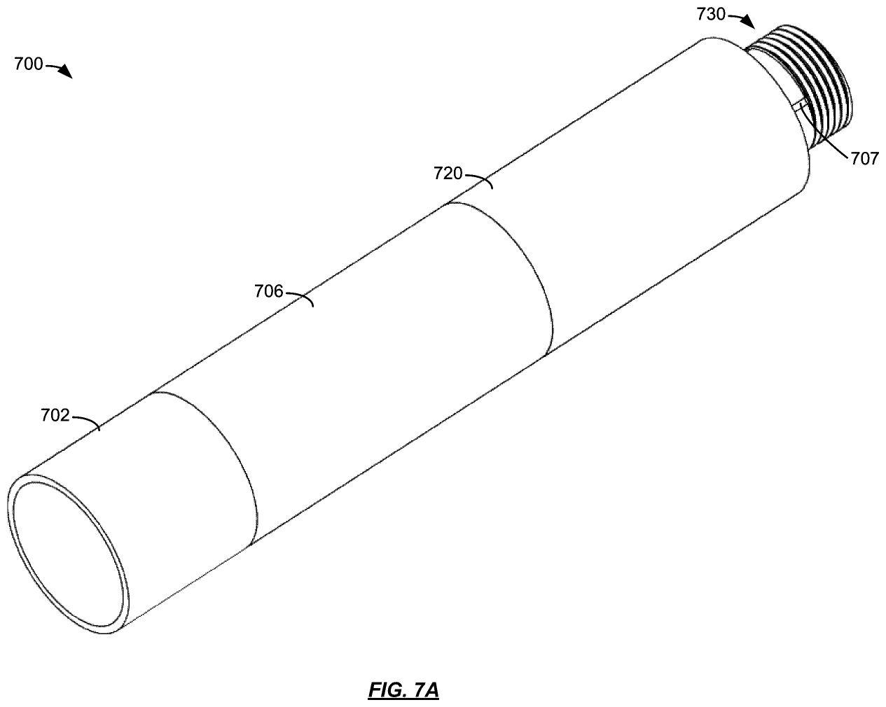

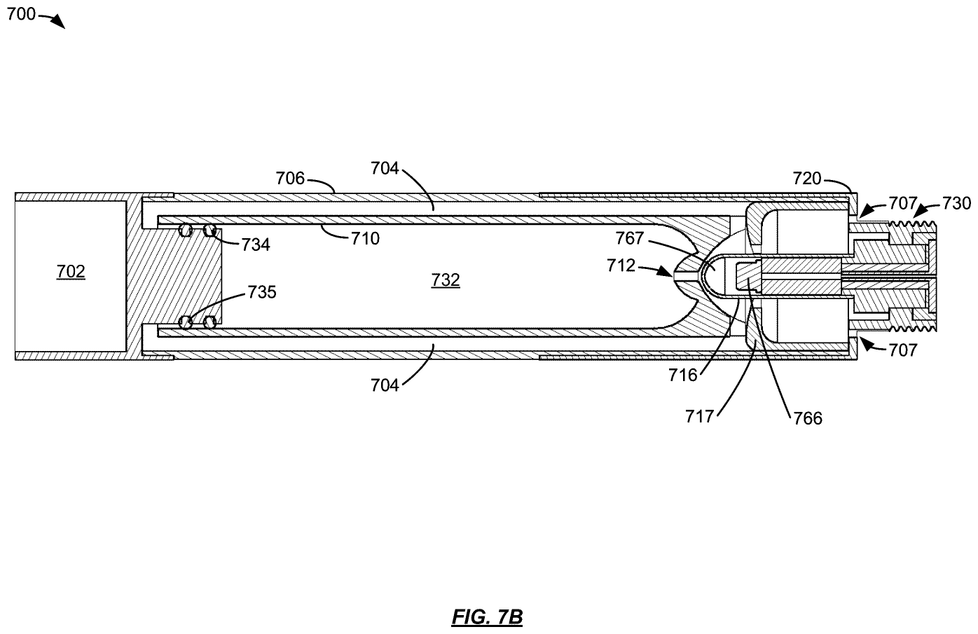

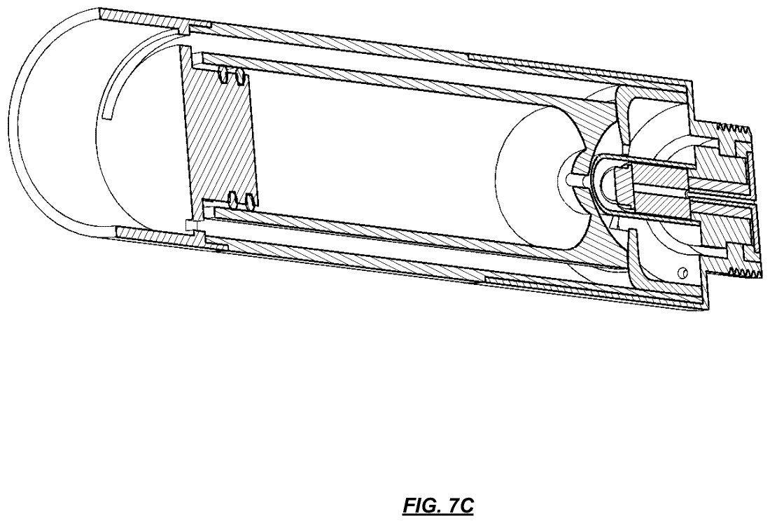

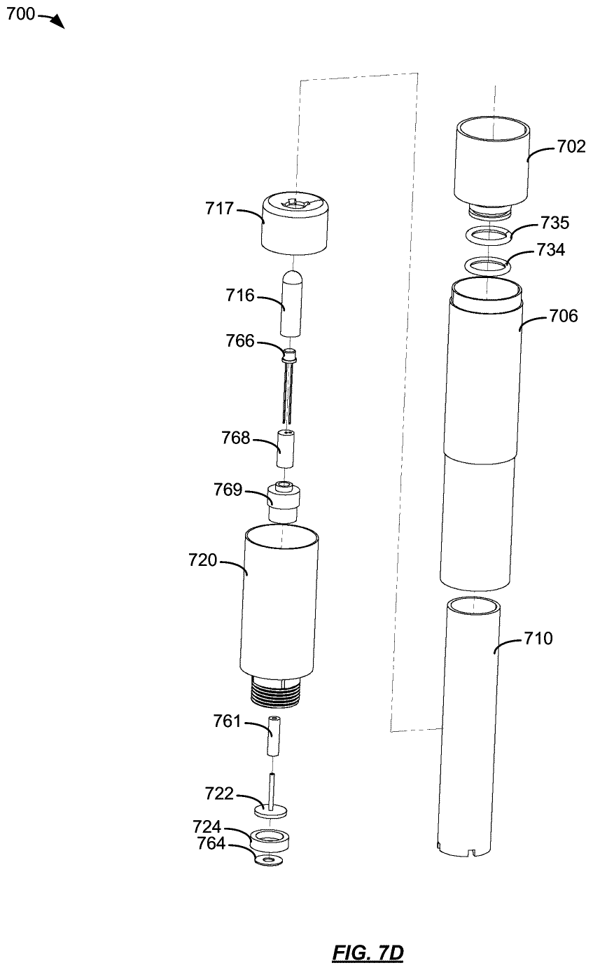

FIGS. 7A-7D illustrate a fifth example personal vaporizing unit. In FIGS. 7A-7D, PVU 700 comprises mouthpiece 702, vapor passageway 704, exterior housing 706, air intake holes 707, reservoir body 710, precursor composition 711, precursor passageway 712, heater housing 716, base 720, electrode 722, electrode O-ring 724, mouthpiece O-ring 734, mouthpiece O-ring 735, base O-ring 736, threads 730, lead seal 761, ground seal 764, laser diode 766, laser target 767, laser lead wire passage/insulation 768, and ground conductor 769. Threads 730 allow PVU 700 to be screwed onto a battery (e.g., battery 138) to provide switched power to heater 726 (not shown in FIGS. 7A-7D) via electrode 722. PVU 700 is constructed and operates in a manner similar to PVU 100 and other PVUs described herein except that the heating function performed by heater 126 is performed by laser diode 766 switchably illuminating laser target 767 with light (e.g., infrared light) thereby causing laser target 767 to rise in temperature and the precursor composition 711 in reservoir 732. Accordingly, for the sake of brevity, the general discussion of inhaling, heating, entrainment, etc. will not be repeated with respect to FIGS. 7A-7D. FIG. 7C is an isometric cross-section of PVU 700 that additionally illustrates PVU 700. FIG. 7D is an exploded view of PVU 700 that additionally illustrate PVU 700.

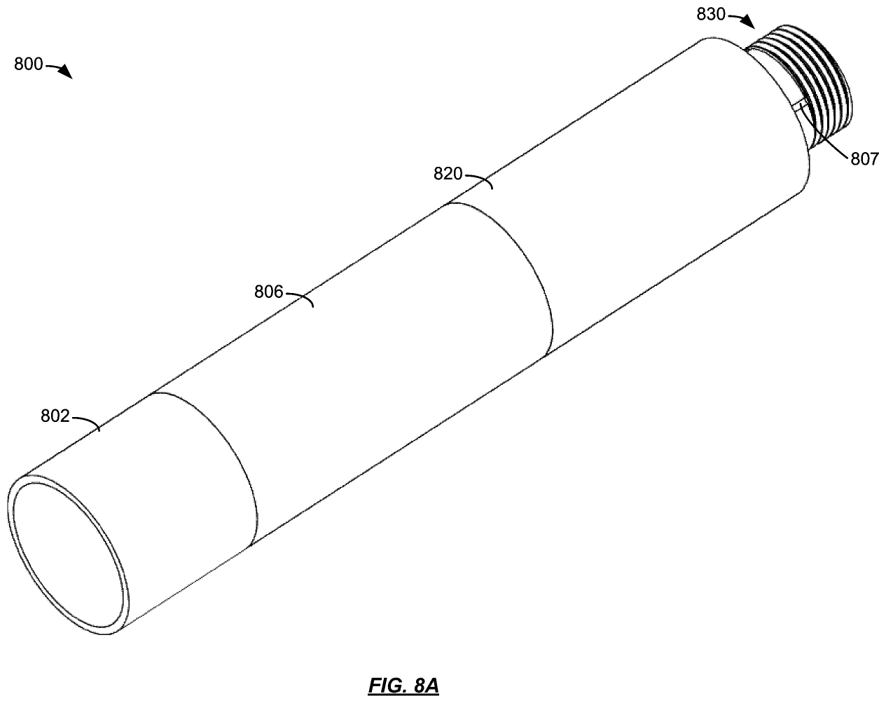

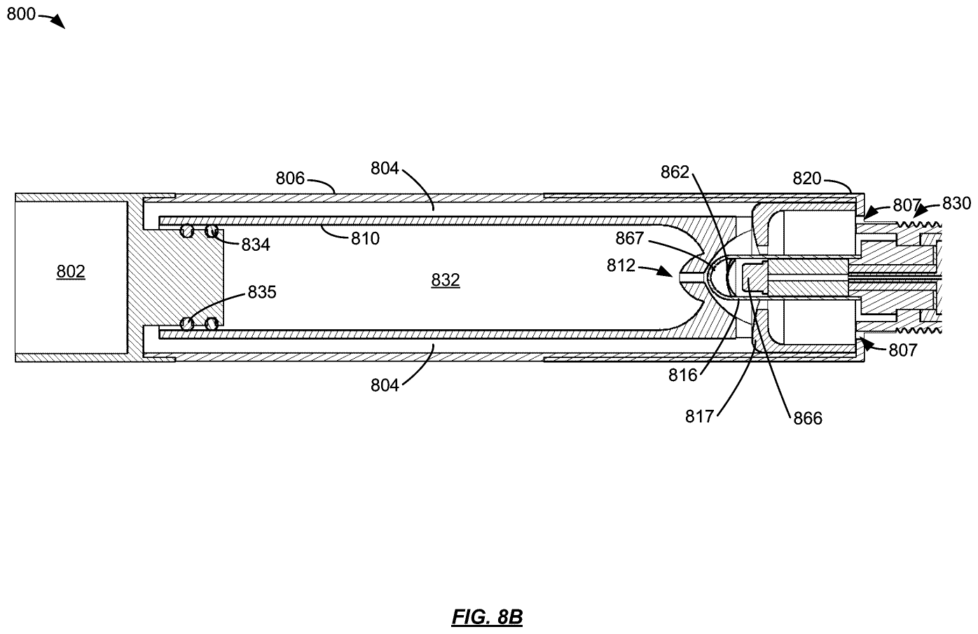

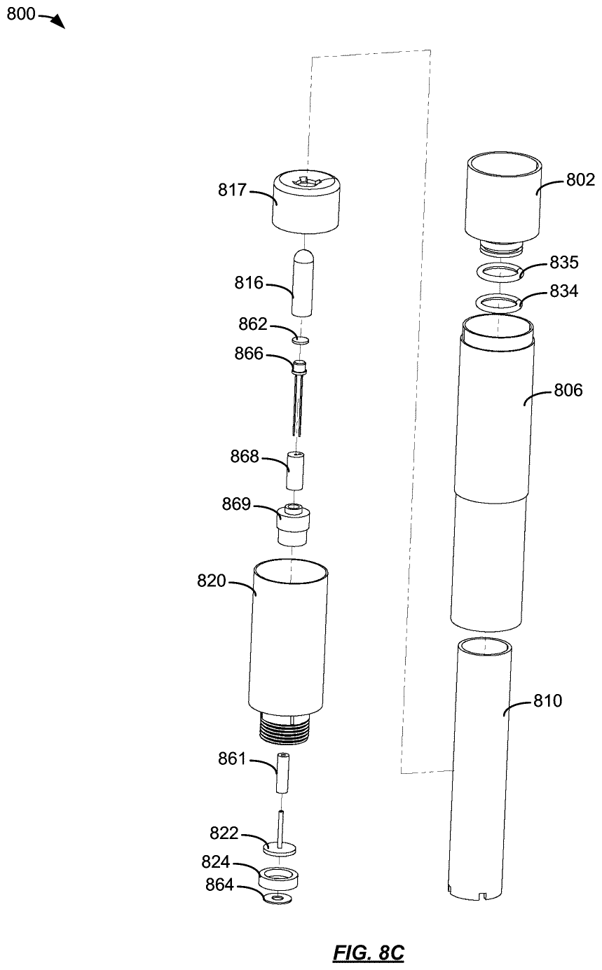

FIGS. 8A-8C illustrate a sixth example personal vaporizing unit. In FIGS. 8A-8C, PVU 800 comprises mouthpiece 802, vapor passageway 804, exterior housing 806, air intake holes 807, reservoir body 810, precursor passageway 812, heater housing 816, base 820, electrode 822, electrode O-ring 824, mouthpiece O-ring 834, mouthpiece O-ring 835, base O-ring 836, threads 830, lead seal 861, lens 862, ground seal 864, laser diode 866, laser target 867, laser lead wire passage/insulation 868, and ground conductor 869. Threads 830 allow PVU 800 to be screwed onto a battery (e.g., battery 138) to provide switched power to heater 826 (not shown in FIGS. 8A-8C) via electrode 822. PVU 800 is constructed and operates in a manner similar to PVU 700 described herein except that lens 862 focuses light from laser diode 866 thereby focusing more light energy on laser target 867 and thereby more efficiently heating the precursor composition in reservoir 832. Accordingly, for the sake of brevity, the general discussion of inhaling, heating, entrainment, etc. will not be repeated with respect to FIGS. 8A-8C. FIG. 8C is an exploded view of PVU 800 that additionally illustrates PVU 800.

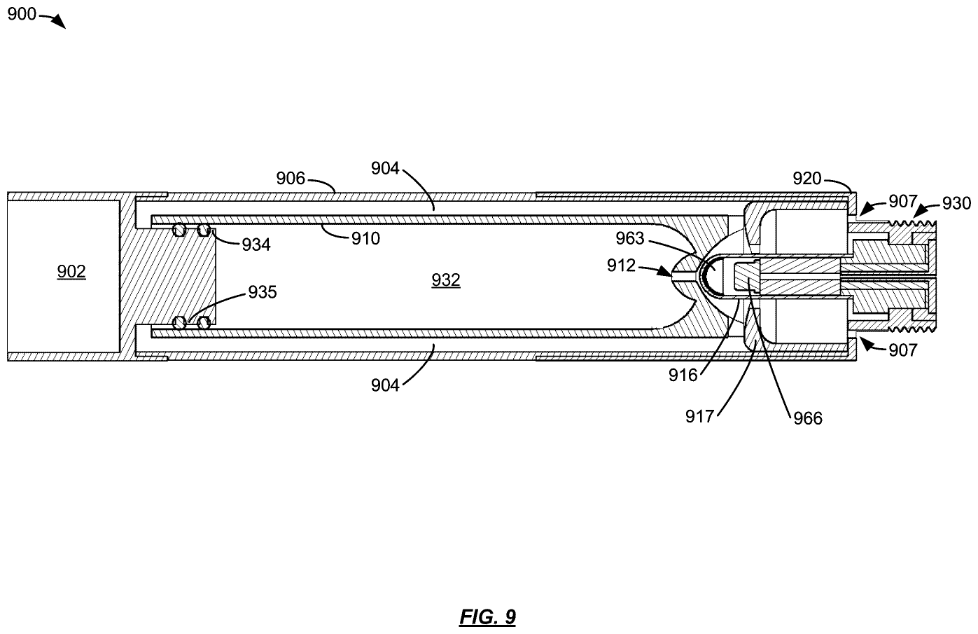

FIG. 9 illustrates a seventh example personal vaporizing unit. In FIG. 9, PVU 900 comprises mouthpiece 902, vapor passageway 904, exterior housing 906, air intake holes 907, reservoir body 910, precursor passageway 912, heater housing 916, base 920, electrode 922, electrode O-ring 924, mouthpiece O-ring 934, mouthpiece O-ring 935, base O-ring 936, threads 930, lead seal 961, blackbody absorber target 963, ground seal 964, laser diode 966, laser lead wire passage/insulation 968, and ground conductor 969. Threads 930 allow PVU 900 to be screwed onto a battery (e.g., battery 138) to provide switched power to heater 926 (not shown in FIG. 9) via electrode 922. PVU 900 is constructed and operates in a manner similar to PVU 700 described herein with the optional feature that blackbody absorber target 963 is comprised of material(s) adapted to absorb the wavelength of light emitted by laser diode 966 and to relatively efficiently convert that light to heat. Accordingly, for the sake of brevity, the general discussion of inhaling, heating, entrainment, etc. will not be repeated with respect to FIG. 9.

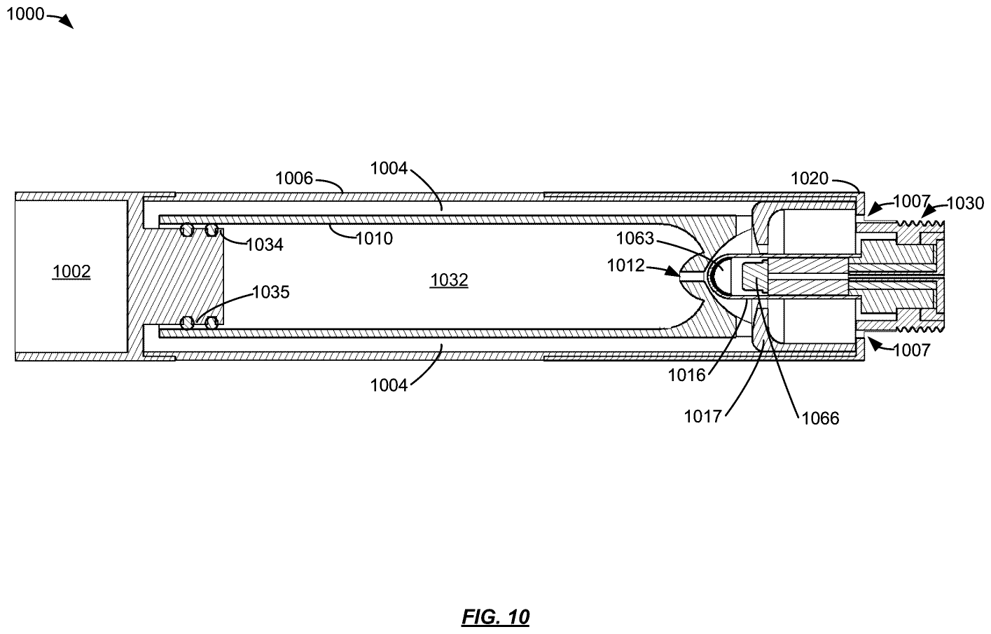

FIG. 10 illustrates an eighth example personal vaporizing unit. In FIG. 10, PVU 1000 comprises mouthpiece 1002, vapor passageway 1004, exterior housing 1006, air intake holes 1007, reservoir body 1010, precursor passageway 1012, heater housing 1016, base 1020, electrode 1022, electrode O-ring 1024, mouthpiece O-ring 1034, mouthpiece O-ring 1035, base O-ring 1036, threads 1030, lead seal 1061, crystal target 1063, ground seal 1064, laser diode 1066, laser lead wire passage/insulation 1068, and ground conductor 1069. Threads 1030 allow PVU 1000 to be screwed onto a battery (e.g., battery 138) to provide switched power to heater 1026 (not shown in FIG. 10) via electrode 1022. PVU 1000 is constructed and operates in a manner similar to PVU 700 described herein with the optional feature that crystal target 1063 is comprised of material(s) (e.g., quartz) adapted to resonate in response to modulated (e.g., pulse width modulation, amplitude modulation, etc.) light emitted by laser diode 1066 and thereby, based at least in part of the resonating, convert the modulated light to heat. In other words, laser diode 1066 may be controlled to emit pulses (or waveforms) of light at or near the resonant frequency of crystal target 1063 thereby causing crystal target 1063 to physically resonate thereby generating heat (e.g., via friction). Accordingly, for the sake of brevity, the general discussion of inhaling, heating, entrainment, etc. will not be repeated with respect to FIG. 10.

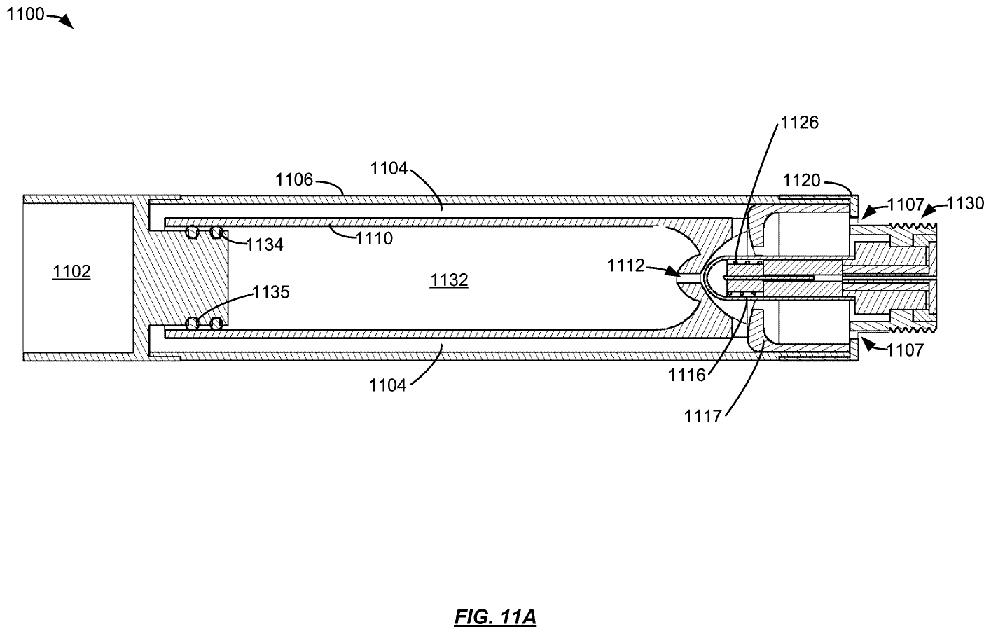

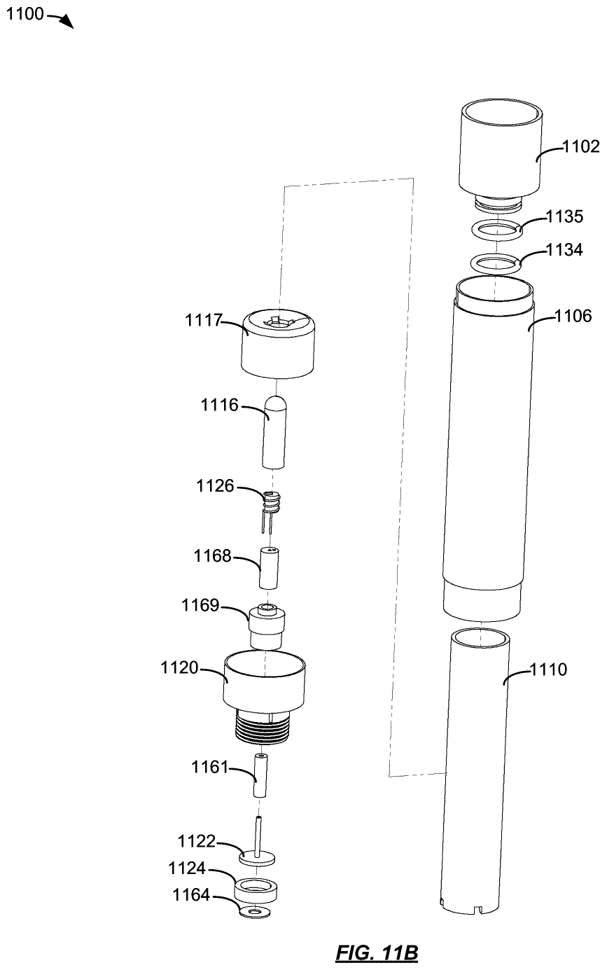

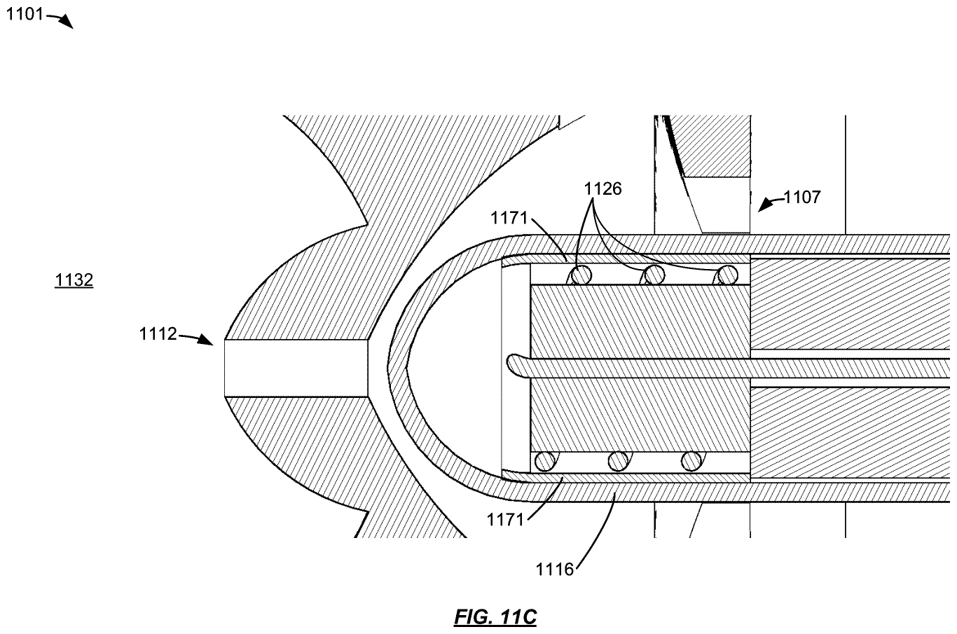

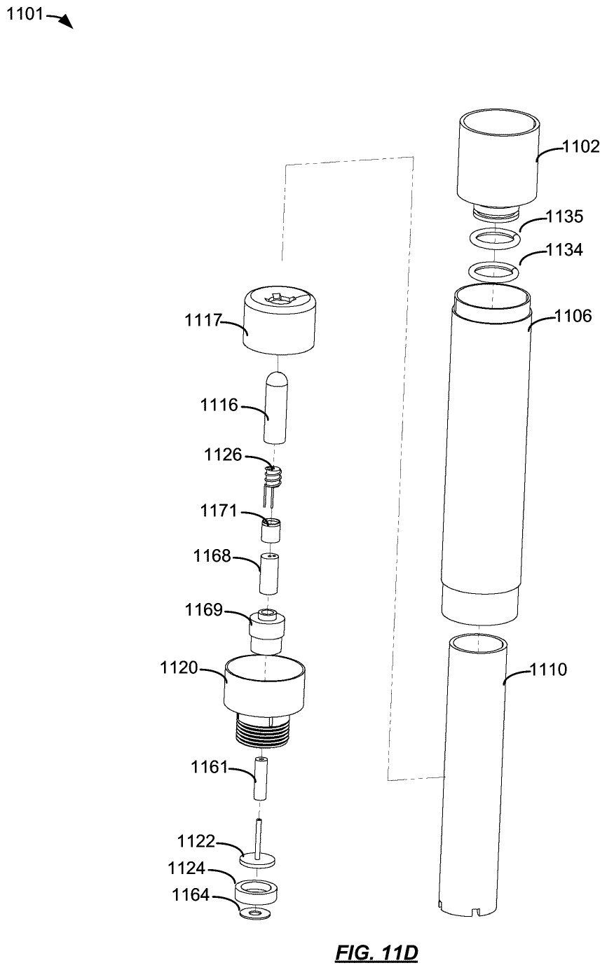

FIGS. 11A-11D illustrate nineth and tenth example personal vaporizing units. In FIGS. 11A-11B, PVU 1100 comprises mouthpiece 1102, vapor passageway 1104, exterior housing 1106, air intake holes 1107, reservoir body 1110, precursor passageway 1112, heater housing 1116, heater (i.e., infrared emitter) 1126, base 1120, electrode 1122, electrode O-ring 1124, mouthpiece O-ring 1134, mouthpiece O-ring 1135, base O-ring 1136, threads 1130, lead seal 1161, ground seal 1164, lead wire passage/insulation 1168, and ground conductor 1169. Threads 1130 allow PVU 1100 to be screwed onto a battery (e.g., battery 138) to provide switched power to heater 1126 (not shown in FIGS. 11A-11B) via electrode 1122. PVU 1100 is constructed and operates in a manner similar to PVU 100 and other PVUs described herein Accordingly, for the sake of brevity, the general discussion of inhaling, heating, entrainment, etc. will not be repeated with respect to FIGS. 11A-11B.

FIGS. 11C-11D illustrate PVU 1101. FIG. 11C is a detail illustration showing reflector (e.g., IR reflective) coating/sleeve 1171 disposed between heater 1166 and heater housing 1116. Reflector 1171 may be or comprise IR reflective materials such as gold, silver, aluminum, etc. In some embodiments, reflector 1171 may be applied to the inside of heater housing 1116 using techniques such as vapor deposition, sputtering, spraying, electroplating etc. Thus, it should be understood that in some embodiments, reflector 1171 may be thin (e.g., 1-10 μm) and/or be integrated with heater housing 1116. In an embodiment, reflector 1171 does not contact heater 1166 in order to prevent reflector 1171 from shorting one or more conductions and/or heating elements of heater 1166.

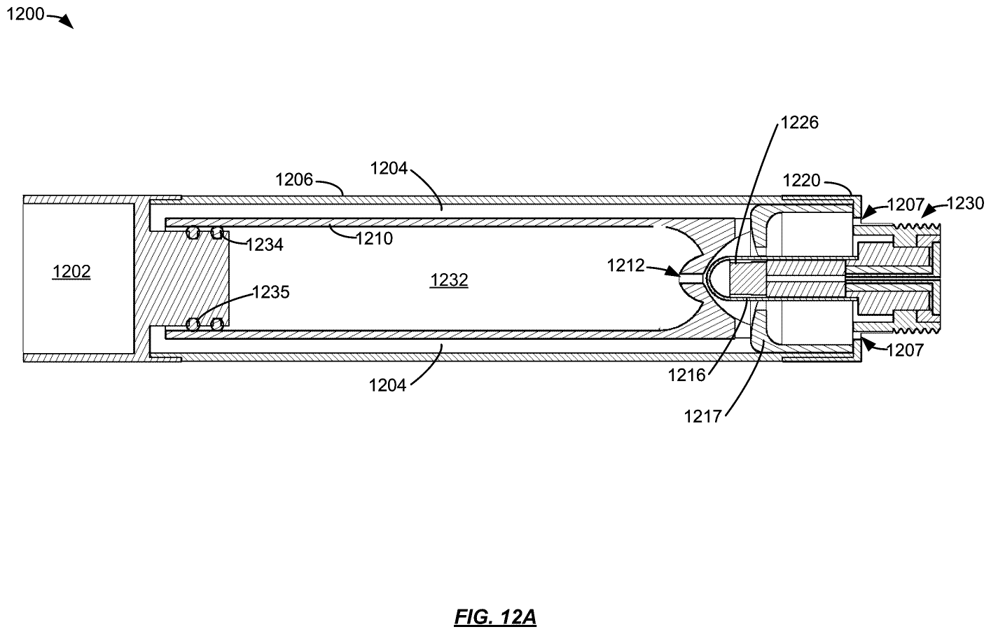

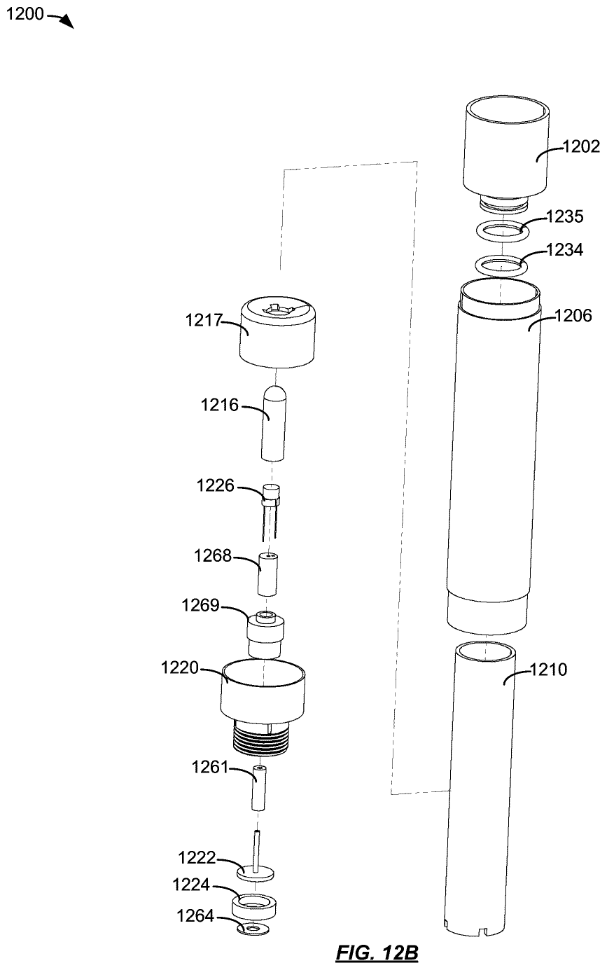

FIGS. 12A-12B illustrate an eleventh example personal vaporizing unit. In FIGS. 12A-12B, PVU 1200 comprises mouthpiece 1202, vapor passageway 1204, exterior housing 1206, air intake holes 1207, reservoir body 1210, precursor passageway 1212, heater housing 1216, integrated heater 1226, base 1220, electrode 1222, electrode O-ring 1224, mouthpiece O-ring 1234, mouthpiece O-ring 1235, base O-ring 1236, threads 1230, lead seal 1261, ground seal 1264, lead wire passage/insulation 1268, and ground conductor 1269. Threads 1230 allow PVU 1200 to be screwed onto a battery (e.g., battery 138) to provide switched power to integrated heater 1226 (not shown in FIGS. 12A-12B) via electrode 1222. In an embodiment, integrated heater 1226 is or comprises a cartridge heater. In another embodiment, integrated heater 1226 is or comprises a ceramic heater. PVU 1200 is constructed and operates in a manner similar to PVU 100 and other PVUs described herein Accordingly, for the sake of brevity, the general discussion of inhaling, heating, entrainment, etc. will not be repeated with respect to FIGS. 12A-12B.

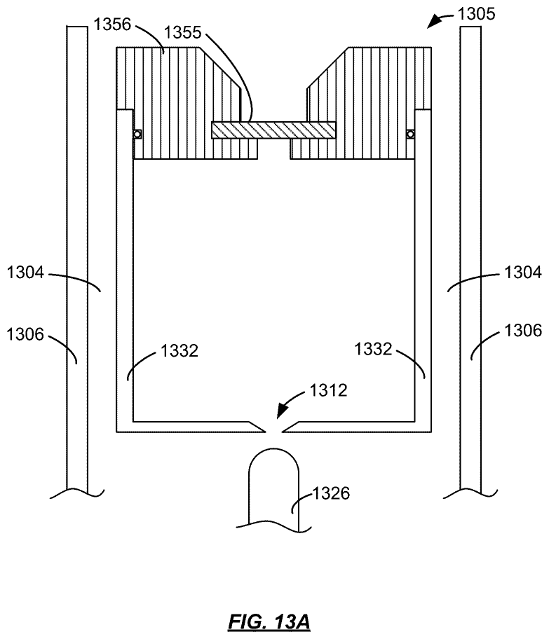

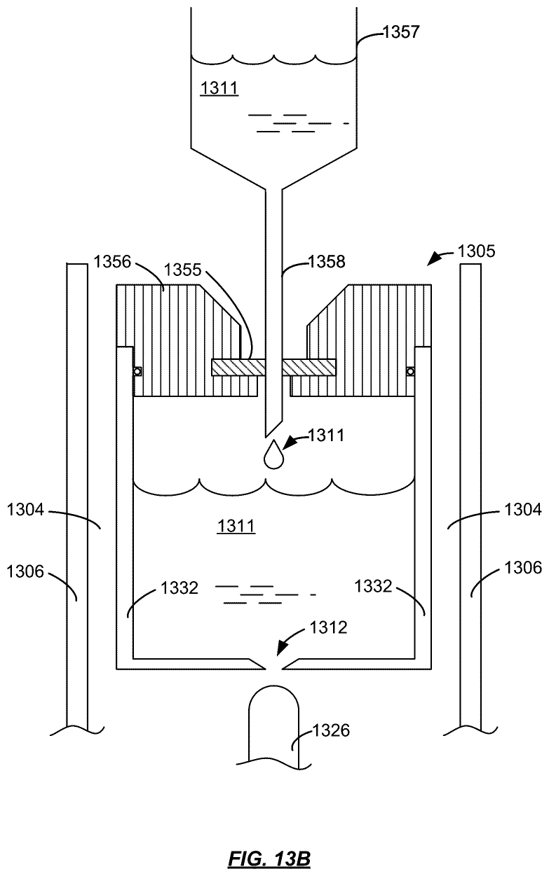

FIGS. 13A-13B illustrate an example scaling and filling system for a personal vaporizing unit cartridge. In FIGS. 13A-13B cartridge 1305 comprises precursor reservoir 1332, septum 1355, and septum plug 1356. Precursor reservoir 1332 includes precursor passageway 1312. Cartridge 1305 may be disposed within housing 1306 such that precursor passageway 1312 is in the proximity of heater 1326. Thus, it should be understood that cartridge 1305 may be filled while still inside a personal vaporizing unit (e.g., by removing a mouthpiece to access septum 1355. However, this is merely an example configuration during the filling operation. In another example, (not shown in the Figures) cartridge 1305 may be removed from the personal vaporizing unit to perform the filling operation.

FIG. 13B illustrates cartridge 1305 during a filling operation. In FIG. 13B, filling needle 1358 penetrates septum 1355. Filling needle 1358 is inserted though septum 1355 such that an open end of filling needle 1358 may carry precursor composition 1311 from filling syringe/reservoir 1357 past septum 1355 in order to fill precursor reservoir 1332 with precursor composition 1311. When filling needle 1358 is removed from precursor reservoir 1332 by withdrawing the end of filling needle 1358 outside of septum 1355, septum 1355 self-seals to retain precursor composition 1311 within precursor reservoir 1332.

In some embodiments, septum 1355 is comprised of a malleable material such as a silicon rubber or similar. Septum 1355 may be comprised of a self-healing material such as a silicon plug. The self-healing property of septum 1355 material allows for filling needle 1358 or other filling tube to enter cartridge 1305. Cartridge 1305 is not in being filled, septum 1355 functionally seals cartridge 1305 such that precursor composition 1311 cannot escape cartridge 1305.

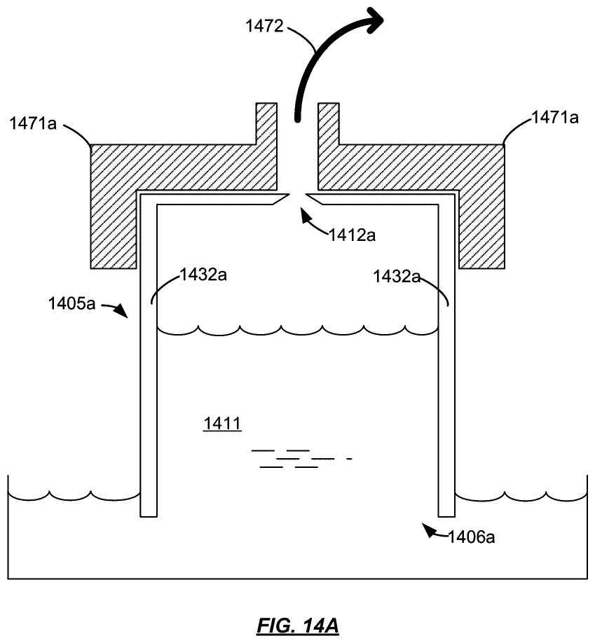

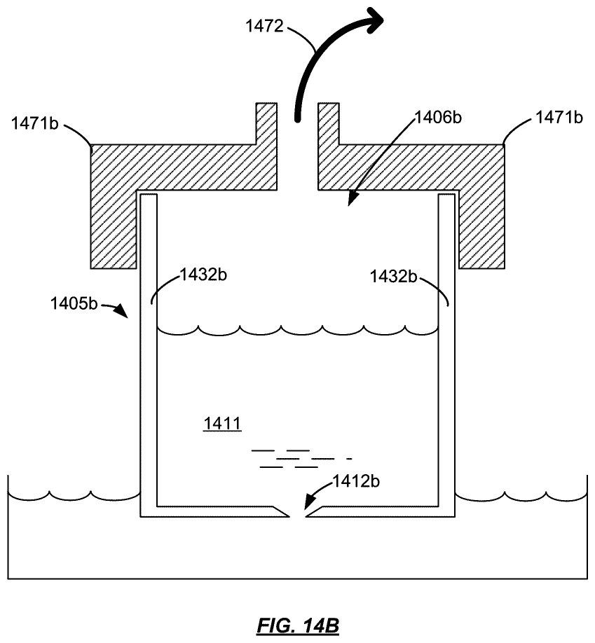

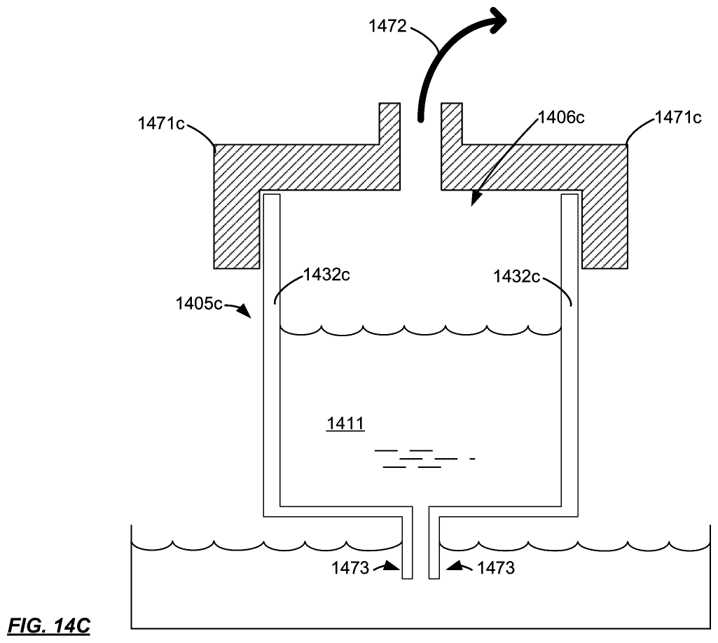

FIGS. 14A-14C illustrate vacuum filling systems for a personal vaporizing unit cartridge. In FIG. 14A cartridge 1405a comprises precursor reservoir 1432a with precursor passageway 1412a. To fill cartridge 1405a, an open end 1406a of precursor reservoir 1432a is disposed below the surface of a pool of precursor composition 1411. The end of the precursor reservoir 1432a having precursor passageway 1412a is disposed above the surface of the pool of precursor composition 1411. A vacuum 1472 or lower than ambient air pressure is applied to precursor passageway 1412a thereby drawing precursor composition 1411 from the pool into precursor reservoir 1432a. This is similar to how liquid is drawn into a straw. A sealing cap 1471a may surround all or part of precursor passageway 1412a and/or precursor reservoir 1432a to allow the vacuum 1472 to draw precursor composition 1411 above the surface of the precursor pool and into precursor reservoir 1432a.

In FIG. 14B cartridge 1405b comprises precursor reservoir 1432b with precursor passageway 1412b. To fill cartridge 1405b, precursor passageway 1412b of precursor reservoir 1432b is disposed below the surface of a pool of precursor composition 1411. The open end 1406b of precursor reservoir 1432b is disposed above the surface of the pool of precursor composition 1411. A vacuum 1472 or lower than ambient air pressure is applied to open end 1406b thereby drawing precursor composition 1411 from the pool into precursor reservoir 1432b via precursor passageway 1412b. This is similar to how liquid is drawn into a straw. A sealing cap 1471b may surround all or part of open end 1406b to allow the vacuum 1472 to draw precursor composition 1411 above the surface of the precursor pool and into precursor reservoir 1432b.

In FIG. 14C cartridge 1405c comprises precursor reservoir 1432c with filling passageway 1473. To fill cartridge 1405c, filling passageway 1473 of precursor reservoir 1432c is disposed below the surface of a pool of precursor composition 1411. The open end 1406c of precursor reservoir 1432c is disposed above the surface of the pool of precursor composition 1411. A vacuum 1472 or lower than ambient air pressure is applied to open end 1406c thereby drawing precursor composition 1411 from the pool into precursor reservoir 1432c via filling passageway 1473. This is similar to how liquid is drawn into a straw. A scaling cap 1471c may surround all or part of open end 1406c to allow the vacuum 1472 to draw precursor composition 1411 above the surface of the precursor pool and into precursor reservoir 1432c.

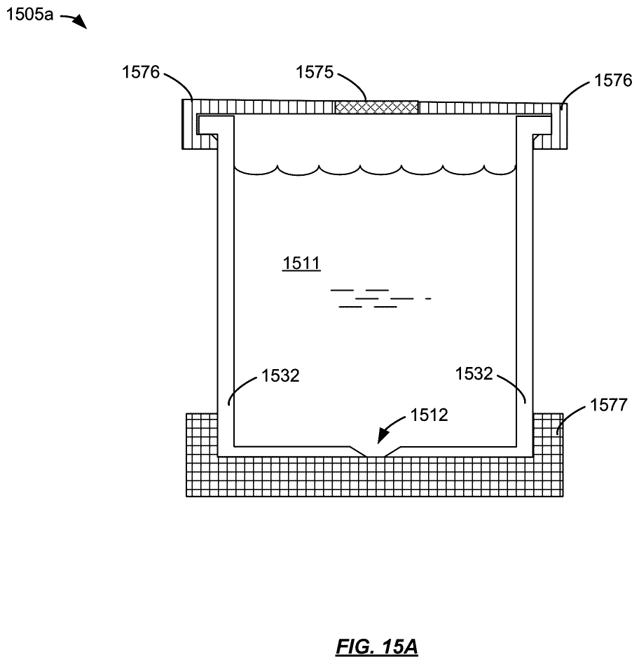

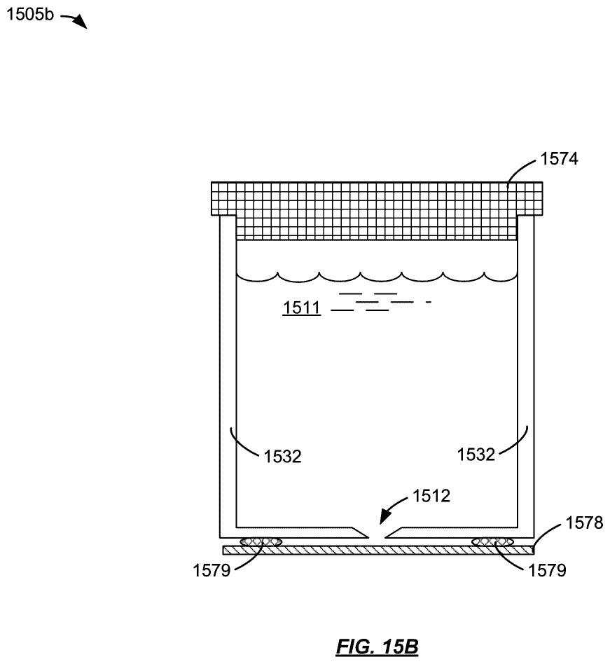

FIGS. 15A-15B illustrates examples of systems that seal personal vaporizing unit cartridges. In FIGS. 15A-15B, sealed cartridges 1505a-1505b comprise precursor reservoir 1532 holding precursor composition 1511. Precursor reservoir 1532 includes precursor passageway 1512. In FIG. 15A, sealed cartridge 1505a includes silicone (and/or rubber, plastic, shrink wrap, etc.) plug 1577 to prevent precursor composition 1511 from leaking via precursor passageway 1512. Sealing the other end of precursor reservoir 1532 is a child resistant foil 1576 and septum 1575 seal crimp fitted around the end of precursor reservoir 1532. This foil 1576 and septum 1575 is similar to those used to seal vials of injectable medication. The septum 1575 in this system, however, may be used to fill precursor reservoir 1532.

In FIG. 15B, sealed cartridge 1505b includes silicone (and/or rubber, plastic, shrink wrap, etc.) plug 1574 to prevent precursor composition 1511 from exiting via the end opposite precursor passageway 1512. Sealing the precursor passageway 1512 end of precursor reservoir 1532 is a child resistant foil 1578 attached via adhesive 1579.

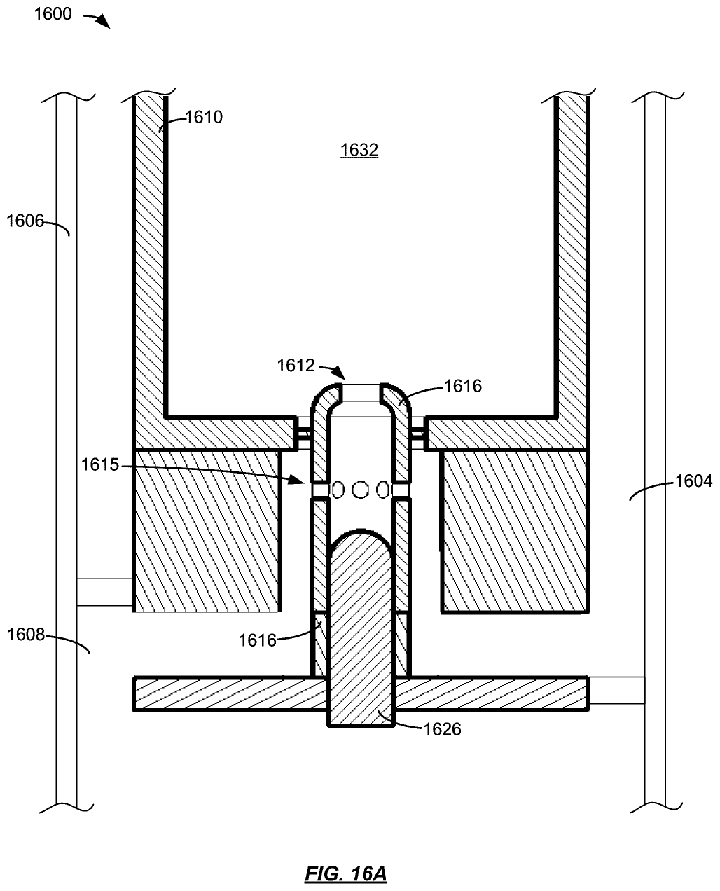

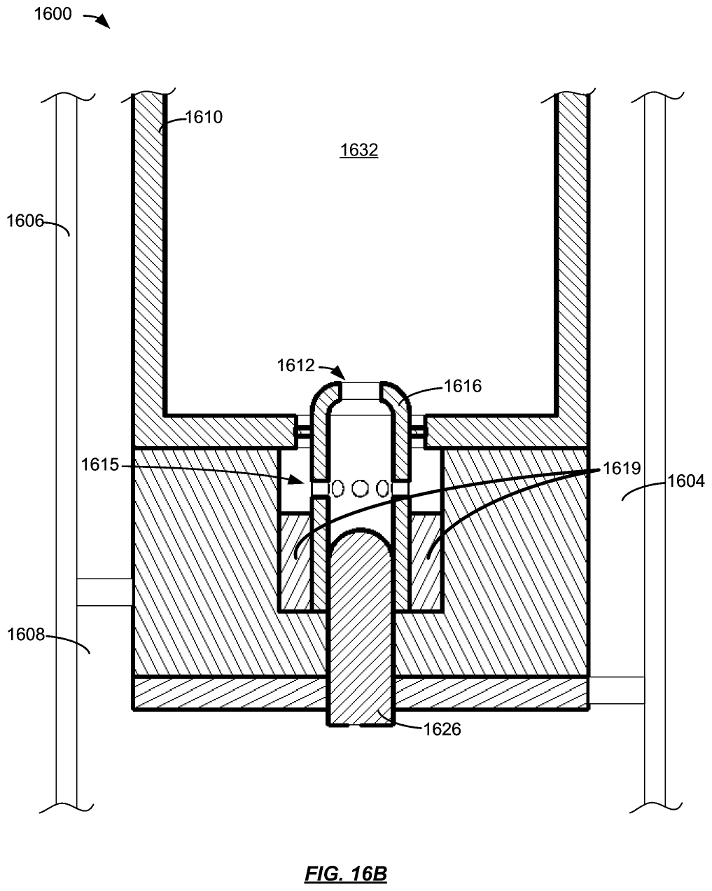

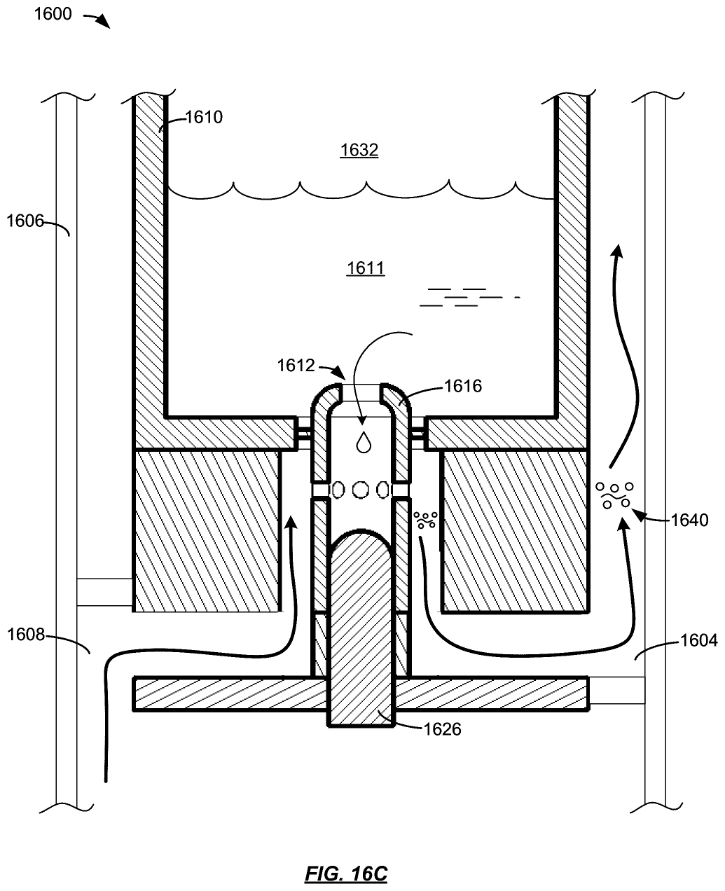

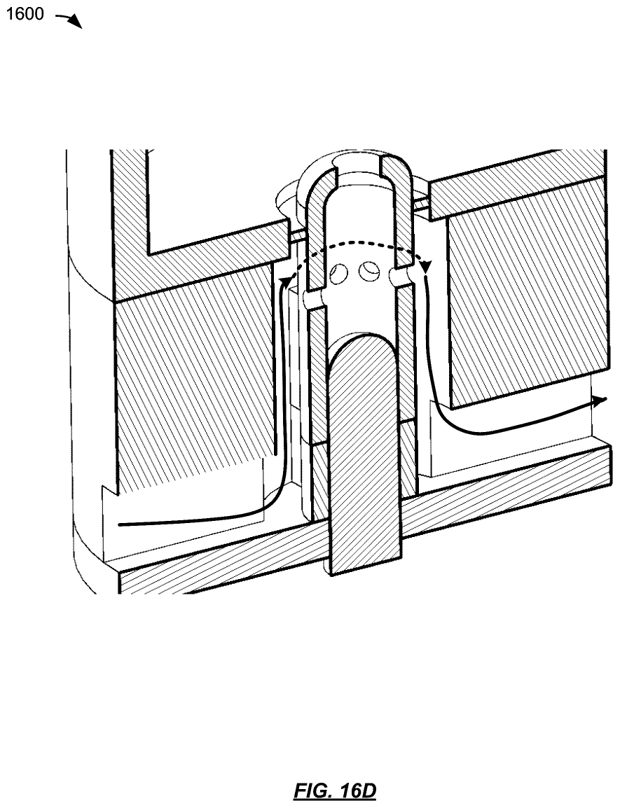

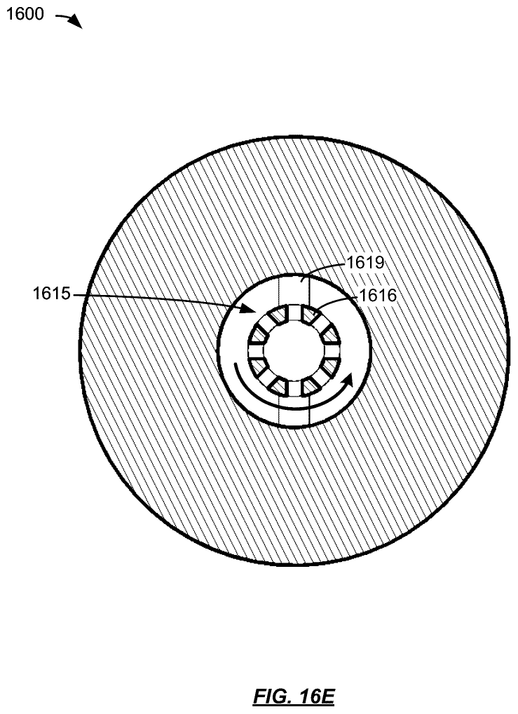

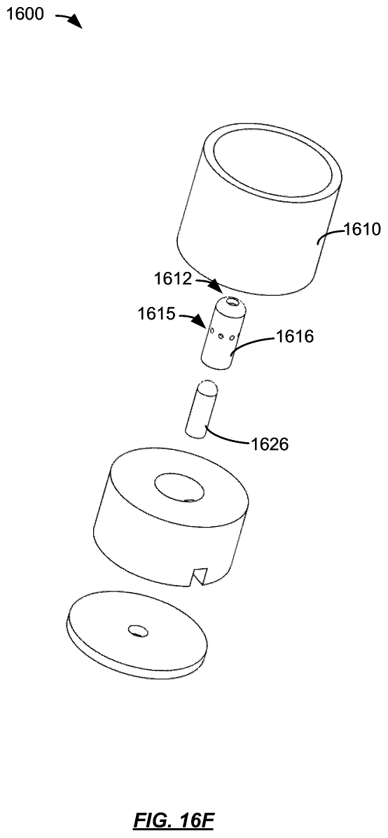

FIGS. 16A-16F illustrate a twelfth example personal vaporizing unit. In FIGS. 16A-16F, for the sake of brevity, some elements of PVU 1600 such as a mouthpiece, air intake, base, electrodes, O-rings, etc. are not shown. In FIGS. 16A-16F, PVU 1600 comprises vapor passageway 1604, exterior housing 1606, air intake passageway 1608, reservoir body 1610, precursor passageway 1612, entrainment holes 1615, heater housing 1616, flow separators 1619, heater 1626, reservoir 1632, and vapor passageway 1604. Reservoir 1632 comprises at least some of the volume inside reservoir body 1610. Heater housing 1616 of PVU 1600 has an end disposed within reservoir 1632. The end of heater housing 1616 disposed within reservoir 1632 (and therefore, in contact or communication with a precursor composition 1611) includes precursor passageway 1612. Disposed radially around heater housing 1616 are entrainment holes 1615. Heater 1616 is disposed within heater housing 1616 via the opposite end from precursor passageway. Radially distributed entrainment holes 1615 are disposed in a longitudinal position along heater housing 1616 such that they are between to end of heater 1616 closest to precursor passageway 1612 and the end of heater housing 1616 having precursor passageway 1612. Heater housing 1616 and heater 1626 thus define a cavity that precursor composition 1611 may enter via precursor passageway 1612, and be heated (or further heated) by heater 1626 (via either convection, or radiation, or both). In operation, the heated (and/or vaporized) precursor composition 1611 may then be drawn from the cavity (e.g., by the inhaling of a user) via entrainment holes 1615. In some embodiments, the volume of this cavity determines the amount of precursor composition 1611 that can be inhaled by a user in one inhale and/or over a selected time period (e.g., amount of time to melt and refill the cavity and/or at least to the level of entrainment holes 1615).

FIGS. 16A and 16B are cross-sections of PVU 1600 along different cut lines (e.g., perpendicular to each other) that additionally illustrate the formation and separation (i.e., by flow separators 1619) of air intake passageway 1608 from vapor passageway 1604 in the vicinity of heater housing 1616. FIGS. 16C-16D illustrate the flows of air, precursor composition 1611, and vapor 1640 as PCU 1600 is operated. FIG. 16E is a top view of a cross-section cut through the entrainment holes to illustrate the flow of air radially around heater housing 1616 and entrainment holes 1615—thereby entraining heated/melted precursor composition 1611 to exit the cavity as (or to become) vapor 1640. FIG. 16F is an exploded view of some illustrated elements of PCU 1600 to additionally show the relationship between these elements.

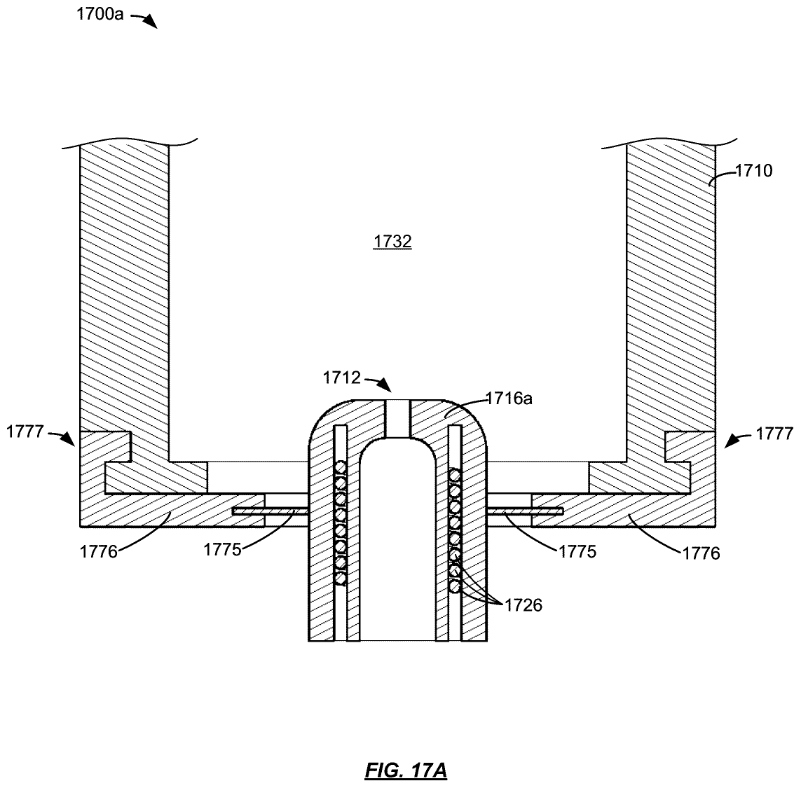

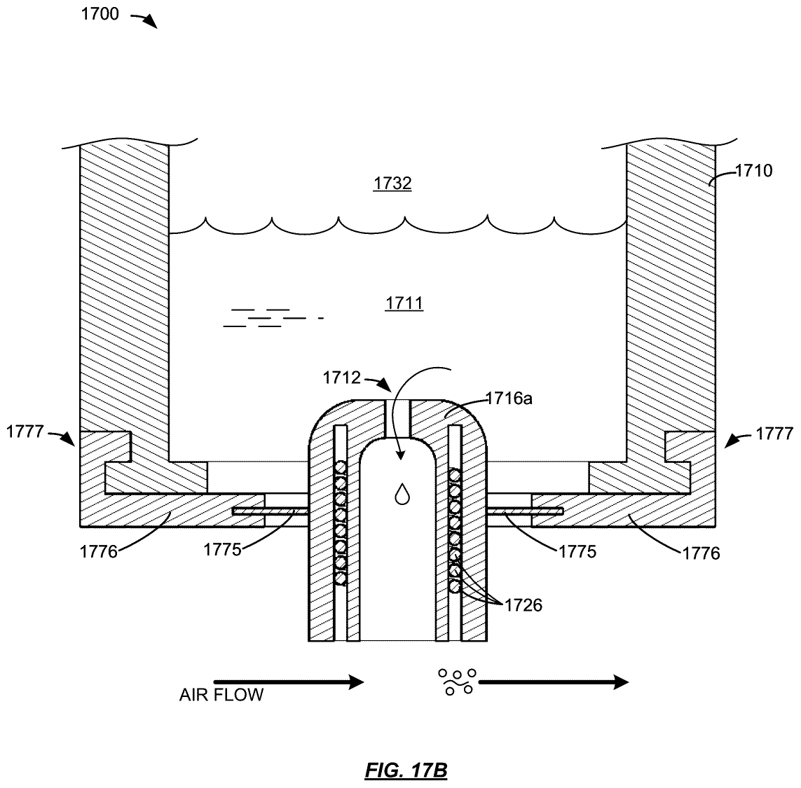

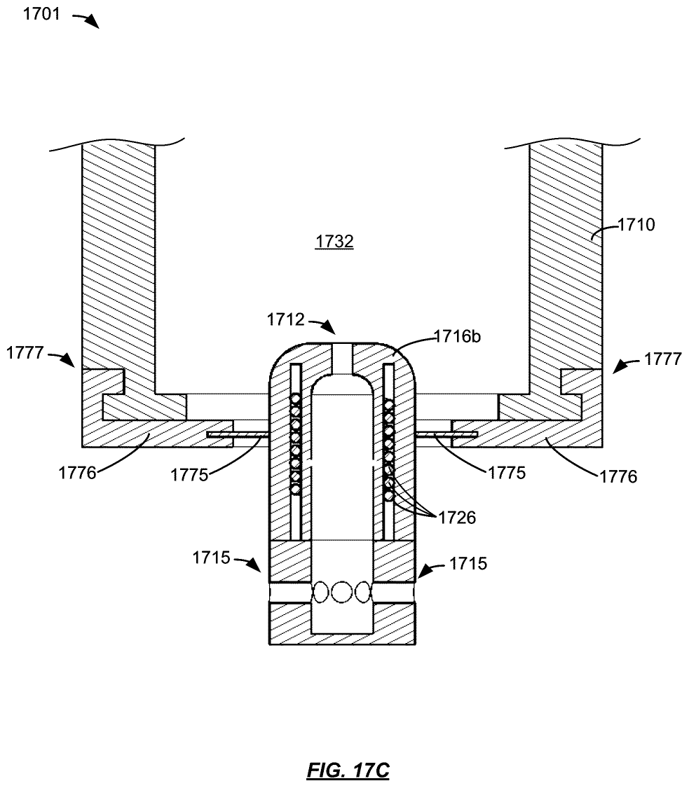

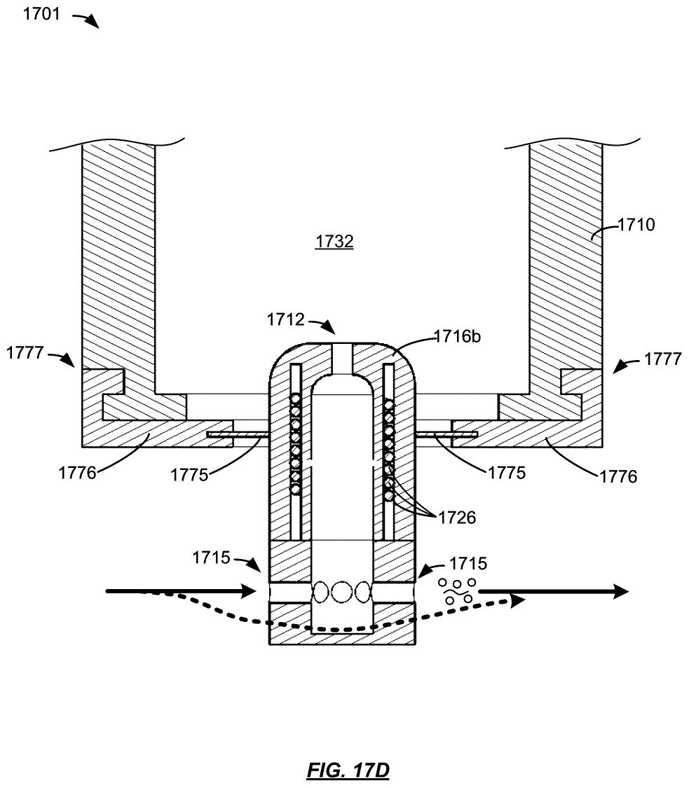

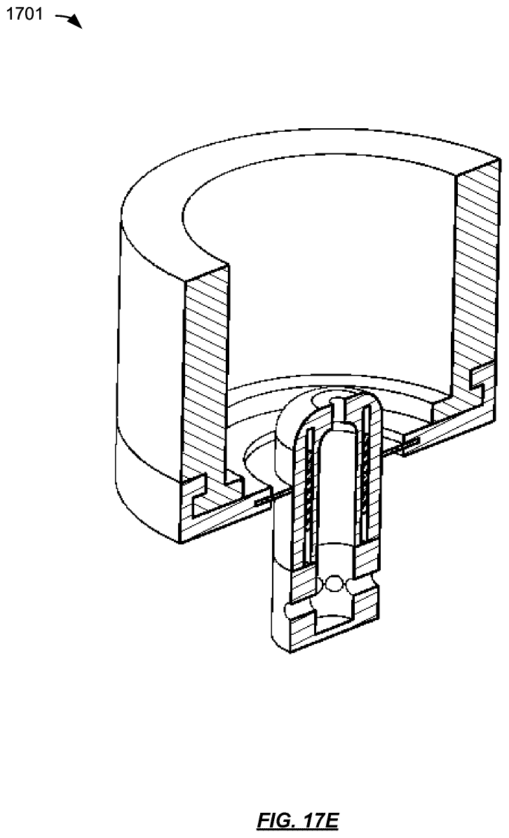

FIGS. 17A-17E illustrate variations of a thirteenth example personal vaporizing unit. In FIGS. 17A-17E, for the sake of brevity, some elements of PVU 1700 and PVU 1701 such as an exterior housing, mouthpiece, air intake, base, electrodes, O-rings, vapor passageway, air intake passageway, etc. are not shown. In FIGS. 17A-17B, PVU 1700 comprises reservoir body 1710, precursor passageway 1712, heater housing 1716a, heater 1726, reservoir 1732, child resistant foil 1776, septum 1775, and seal crimp 1777. Reservoir 1732 comprises at least some of the volume inside reservoir body 1710. Heater housing 1716a of PVU 1700 has an end disposed within reservoir 1732. The end of heater housing 1716a disposed within reservoir 1732 (and therefore, in contact or communication with a precursor composition 1711) includes precursor passageway 1712. Encapsulated within the walls of heater housing 1716a is heater 1726. Thus, heater 1726 surrounds at least a portion of the cavity formed by the hollow interior of heater housing 1726a.

In FIGS. 17C-17E, PVU 1701 comprises reservoir body 1710, precursor passageway 1712, heater housing 1716b, heater 1726, reservoir 1732, child resistant foil 1776, septum 1775, and seal crimp 1777. Reservoir 1732 comprises at least some of the volume inside reservoir body 1710. Heater housing 1716b of PVU 1700 has an end disposed within reservoir 1732. The end of heater housing 1716b disposed within reservoir 1732 (and therefore, in contact or communication with a precursor composition 1711) includes precursor passageway 1712. Encapsulated within the walls of heater housing 1716b is heater 1726. Thus, heater 1726 surrounds at least a portion of the cavity formed by the hollow interior of heater housing 1726a.

Radially distributed entrainment holes 1715 are disposed in a longitudinal position along heater housing 1716b such that they are between to end of heater housing 1716b having precursor passageway 1712 and an opposite end from precursor passageway 1712. Heater housing 1716b thus defines a cavity that precursor composition 1711 may enter via precursor passageway 1712, and be heated (or further heated) by heater 1726 (via either convection, or radiation, or both). In operation, the heated (and/or vaporized) precursor conmoposition 1711 may then be drawn from the cavity (e.g., by the inhaling of a user) via entrainment holes 1715. In some embodiments, the volume of this cavity determines the amount of precursor composition 1711 that can be inhaled by a user in one inhale and/or over a selected time period (e.g., amount of time to melt and refill the cavity and/or at least to the level of entrainment holes 1715).

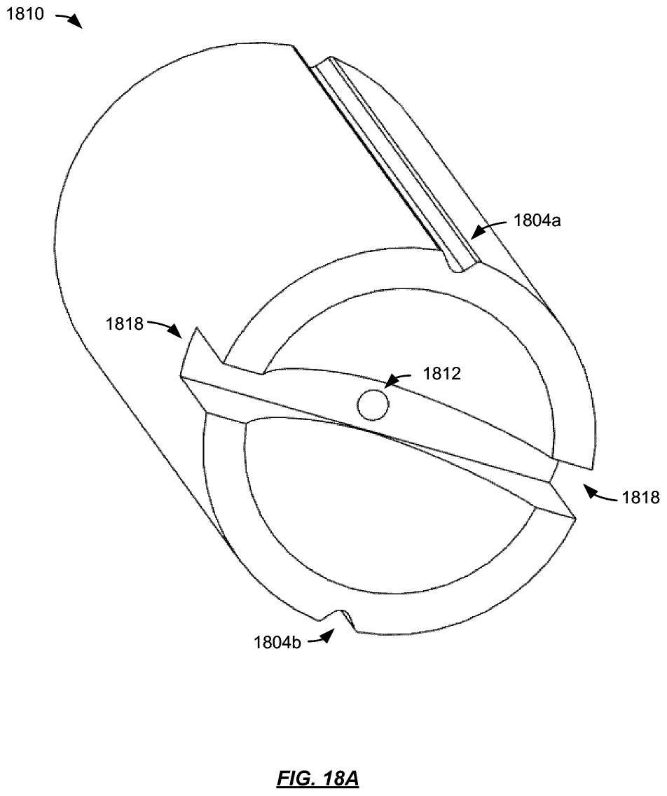

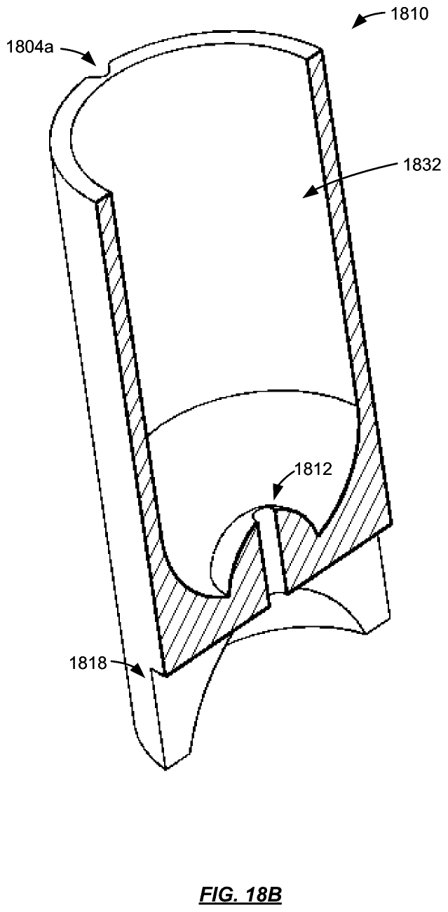

FIGS. 18A-18B illustrate an example reservoir body of a personal vaporizing unit cartridge. In FIGS. 18A-18B, reservoir body 1810 is substantially a hollow cylinder (i.e., forming reservoir 1832) that is open at a first end, and closed at a second end except for a precursor passageway 1812. The exterior surface of the cylinder includes one or more grooves or indents running the length of the cylinder to act as first flow channels 1804a-1804b. The bottom (closed) end of the cylinder includes second flow channels 1818. The ends of second flow channels 1818 and first flow channels 1804a-1804b are positioned substantially perpendicular around the circular end of reservoir body 1810. In an embodiment, reservoir body 1810 comprises glass or may be substantially all glass.

In an example, air flow may be drawn (e.g., by a user's inhale) into second flow channels 1818, flow across precursor passageway 1812 thereby entraining a precursor composition held by reservoir 1832 and forming a vapor. The vapor may then flow along first flow channels 1804a-1804b towards a user. Thus, first flow channels 1804a-1804b may be understood to perform a similar function to vapor passageway 104, etc. (but without requiring a gap between Likewise, second flow channels 1818 may be understood to perform a similar function as entrain entrainment passageway 118 and precursor passageway 1812 understood to perform a similar function as precursor passageway 112.

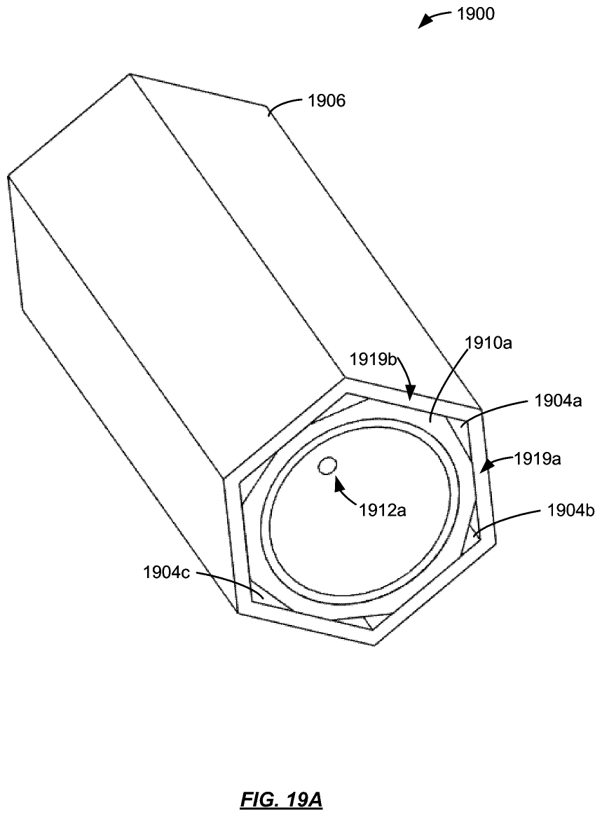

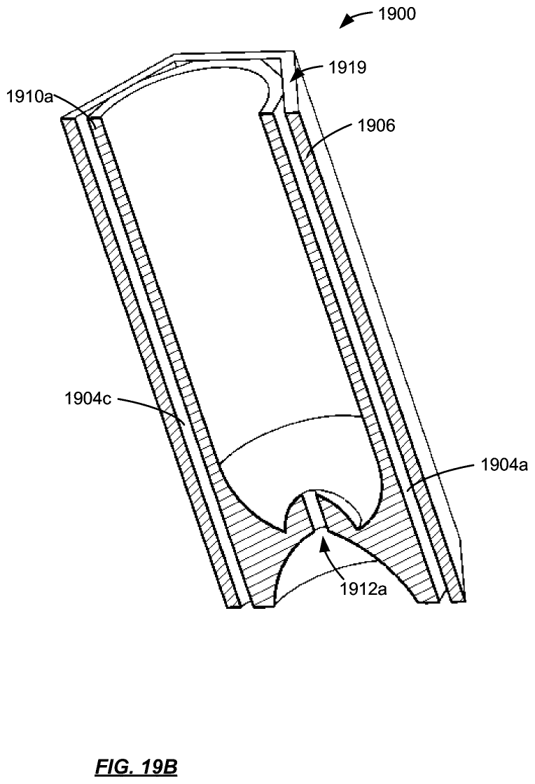

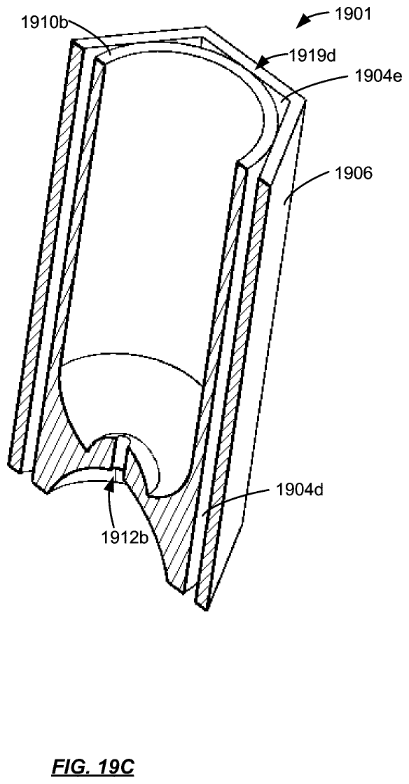

FIGS. 19A-19C illustrate example flow channel assemblies of a personal vaporizing unit. In FIGS. 19A-19B, flow channel assembly 1900 comprises reservoir body 1910a, and housing 1906. In FIGS. 19A-19B, reservoir body 1910a is a substantially hollow twelve-sided cylinder that is open at a first end, and closed at a second end except for a precursor passageway 1912a. Housing 106 is a hollow hexagonal (i.e., six-sided) cylinder. Reservoir body 1910a and housing 1906 are dimensioned such that at least two external sides/faces of reservoir body 1910a contact 1919a-1919b corresponding internal sides/faces of housing 1906 (i.e., reservoir body 1910a is inscribed within housing 1906). These contacts 1919a-1919b act separate contacting sides/faces of reservoir body 1910a and housing 1906 thereby defining longitudinal flow channels 1904a-1904c radially in non-contacting spaces. In an embodiment, reservoir body 1910a and/or housing 1906 comprises glass or may be substantially all glass. In an embodiment, reservoir body 1910a and housing 1906 may be dimensioned such that contacts 1919a-1919b are made at the junction (i.e., edge) of the external sides/faces of reservoir body 1910a (i.e., reservoir body 1910a is circumscribed within housing 1906). It should be understood that the selection of six sides for reservoir body 1910a and twelve sides for housing 1906 is merely one example. Other numbers of sides/faces (e.g., 3, 4, 5, etc.) for either reservoir body 1910a and/or housing 1906 may be selected, and dimensioned (e.g., inscribed or circumscribed) as appropriate, to form contacts 1919a-1919c.

In FIG. 19C, reservoir body 1910b is a substantially hollow circular cylinder that is open at a first end, and closed at a second end except for a precursor passageway 1912b. Housing 106 is a hollow hexagonal (i.e., six-sided) cylinder. Reservoir body 1910b and housing 1906 are dimensioned such that at least two internal sides/faces of housing 1906 contact the external surface of reservoir body 1910b (i.e., reservoir body 1910a is circumscribed within housing 1906). These contacts 1919d act separate contacting sides/faces of housing 1906 and reservoir body 1910c and thereby defining longitudinal flow channels 1904d-1904c radially in non-contacting spaces. In an embodiment, reservoir body 1910b and/or housing 1906 comprises glass or may be substantially all glass. It should be understood that the selection of a circular cylinder for reservoir body 1910a and an N-sided (e.g., 3, 4, 5, etc.) cylinder for housing 1906 is merely one example. Reservoir body 1910b may be selected as an N-sided (e.g., 3, 4, 5, etc.) cylinder and housing 1906 as a circular cylinder and be dimensioned (e.g., inscribed or circumscribed) as appropriate, to form contacts 1919d. Flow channels 1904a-1904e may be understood to perform a similar function to vapor passageway 104, etc.

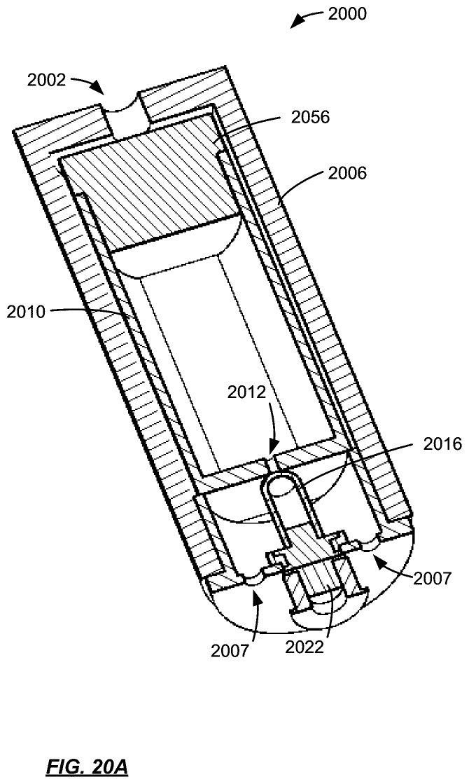

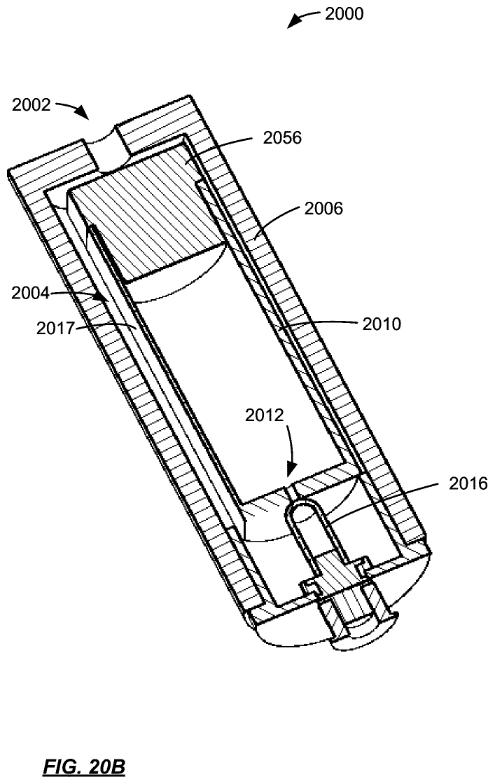

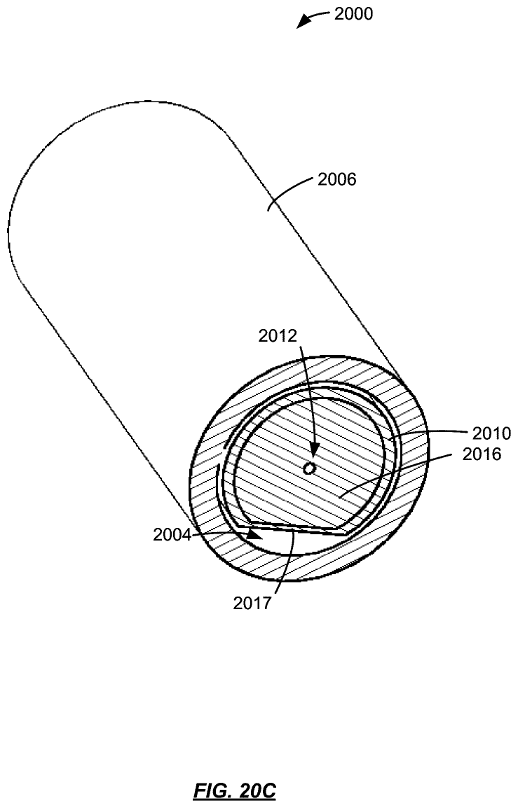

FIGS. 20A-20C illustrate a fourteenth example personal vaporizing unit. In FIGS. 20A-20C, PVU 2000 comprises mouthpiece 2002, vapor passageway 2004, exterior housing 2006, air intakes 2007, reservoir body 2010, precursor passageway 2012, heater housing 2016, and electrode 2022. The exterior profile of reservoir body 2010 is cylindrical with a longitudinal flat (i.e., a chord of the circle of the cylinder) which, together with the interior surface of housing 2006 defines vapor passageway 2004. In an embodiment, reservoir body 2010 and housing 2016 comprise or substantially comprise glass. In some embodiments, due at least in part to the nature of housing 2006 substantially encapsulating reservoir body 2010 (e.g., within a glass housing 2006), PVU 2000 may be more tamper resistant and/or less expensive to manufacture—due to a reduced part count—when compared to some other PVU embodiments.

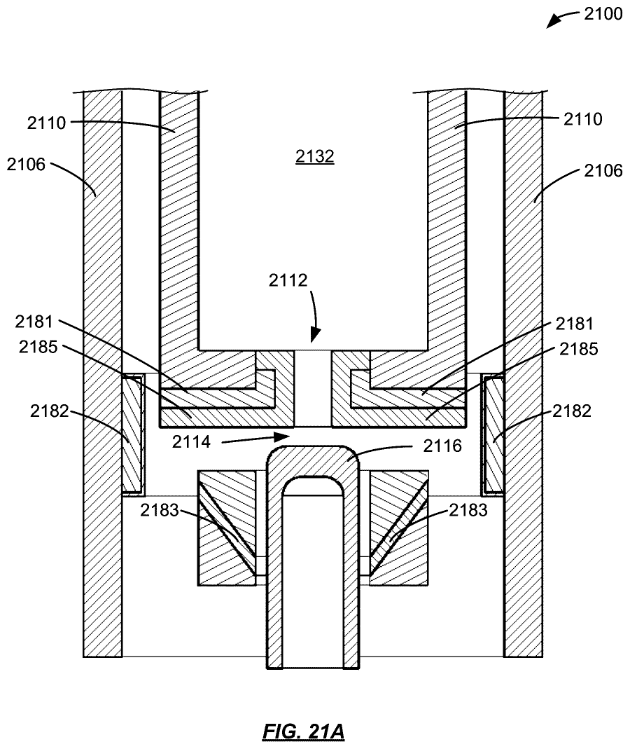

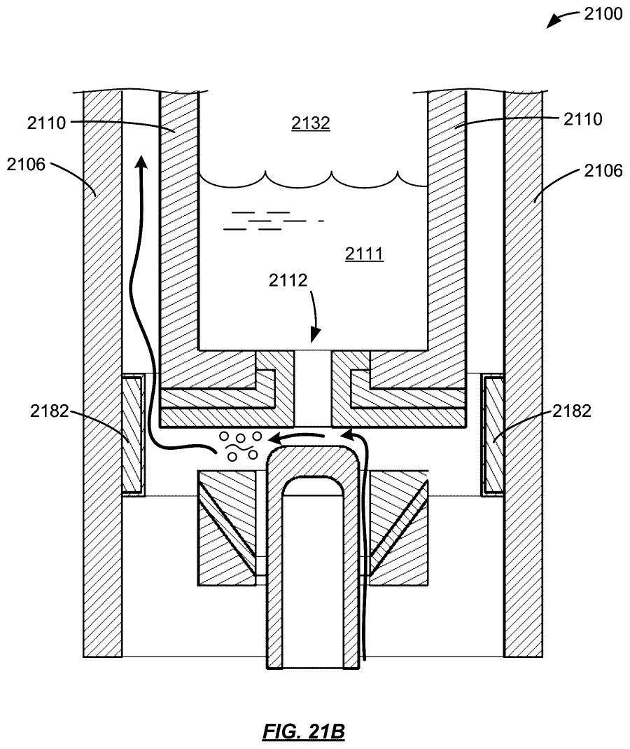

FIGS. 21A-21B illustrate a fifteenth example personal vaporizing unit. In FIGS. 21A-21B, PVU 2100 comprises exterior housing 2106, reservoir body 2110, precursor passageway 2112, entrainment zone/gap 2114, heater housing 2116, IR reflector 2181, IR reflector 2182, IR reflector 2183, and thermal insulator 2185. IR reflectors 2181-2183 function at least to reflect IR radiation from the heater in heater housing 2116 toward entrainment zone/gap 2114 that would otherwise be wasted or absorbed elsewhere (e.g., absorbed by housing 2106). Thermal insulator 2185 at least helps thermally isolate reservoir body 2110 from IR radiation (and heat therefrom) from heater housing 2116. This may reduce undesired heating of portions of precursor composition 2111 not in the vicinity of precursor passageway 2112 by IR radiation (and/or heat) from heater housing 2116 (and/or heated air and/or heated vapor). FIG. 21B illustrates an example air/vapor flow pattern for PVU 2100.

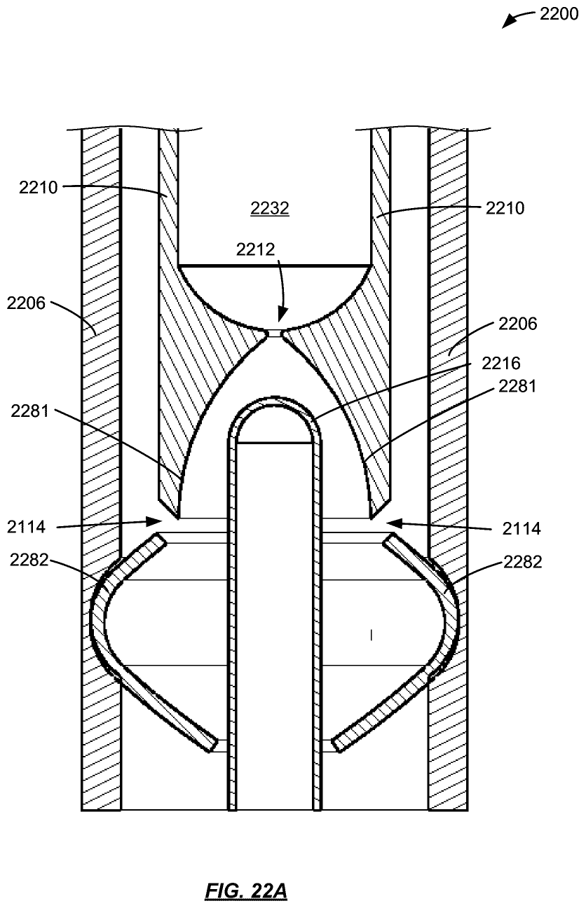

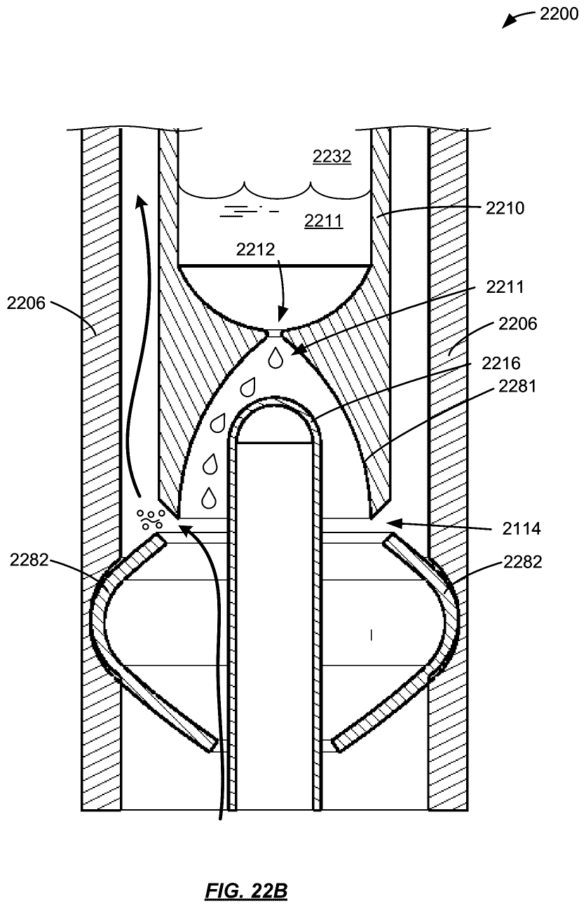

FIGS. 22A-22B illustrate a sixteenth example personal vaporizing unit. In FIGS. 22A-22B, PVU 2200 comprises exterior housing 2206, reservoir body 2210, precursor passageway 2212, entrainment zone/gap 2214, heater housing 2216, parabolic IR reflector 2281, and parabolic IR reflector 2282. Parabolic IR reflectors 2281-2282 function at least to reflect and focus IR radiation from the heater in heater housing 2216 toward entrainment zone/gap 2214. FIG. 22B illustrates an example precursor/air/vapor flow pattern for PVU 2200. Although depicted in FIGS. 22A-22B a parabolic, reflectors 2281-2282 may have other shapes/profiles (e.g., spherical) that function to reflect and/or focus IR radiation on/into entrainment zone/gap 2214, and precursor composition 2211, in particular. In some embodiments, one or more of reflectors 2281-2282 (or another reflector not shown in FIGS. 22A-22B) may function to reflect and/or focus IR radiation on/into precursor passageway 2212.

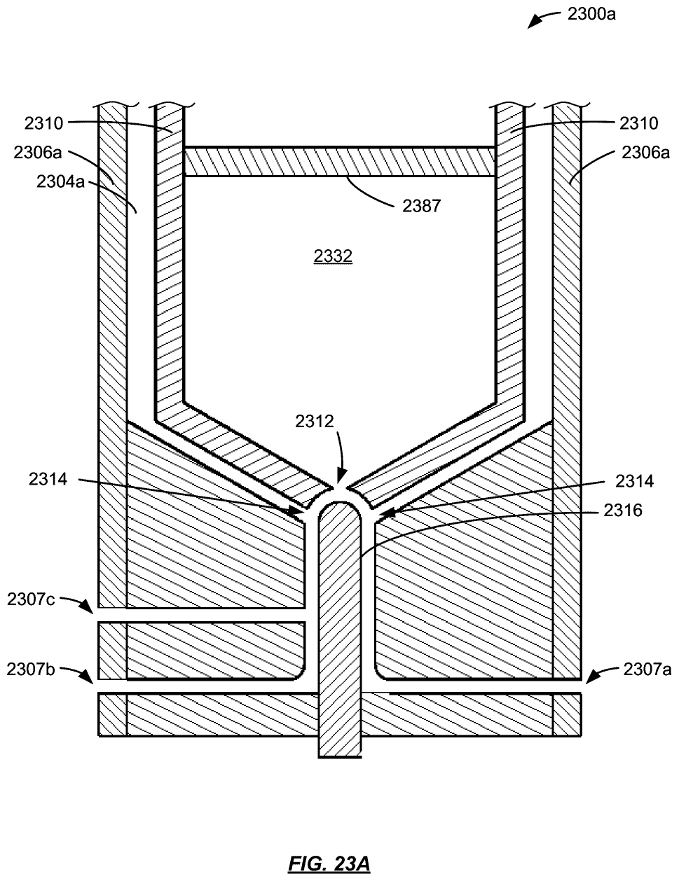

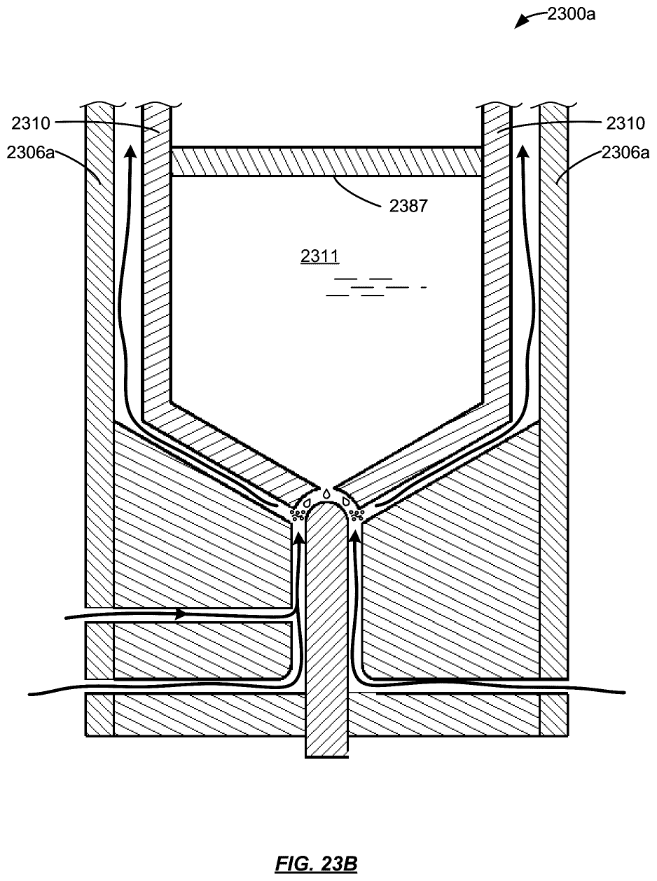

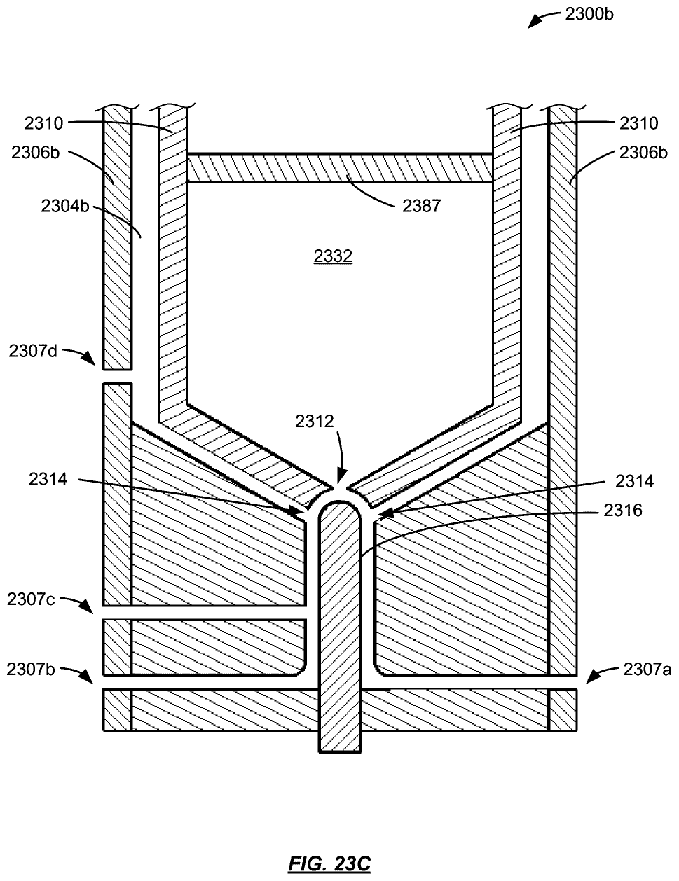

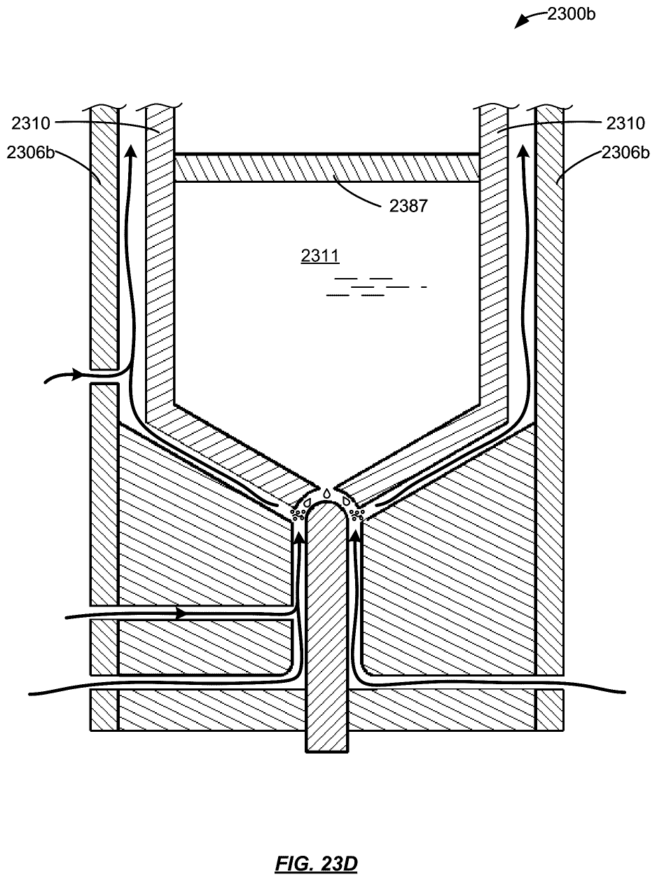

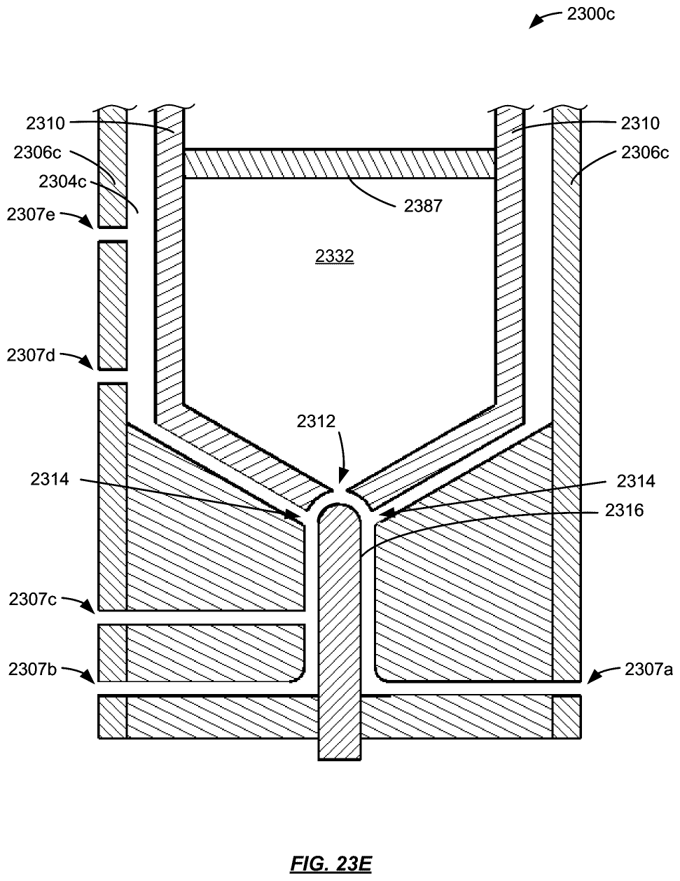

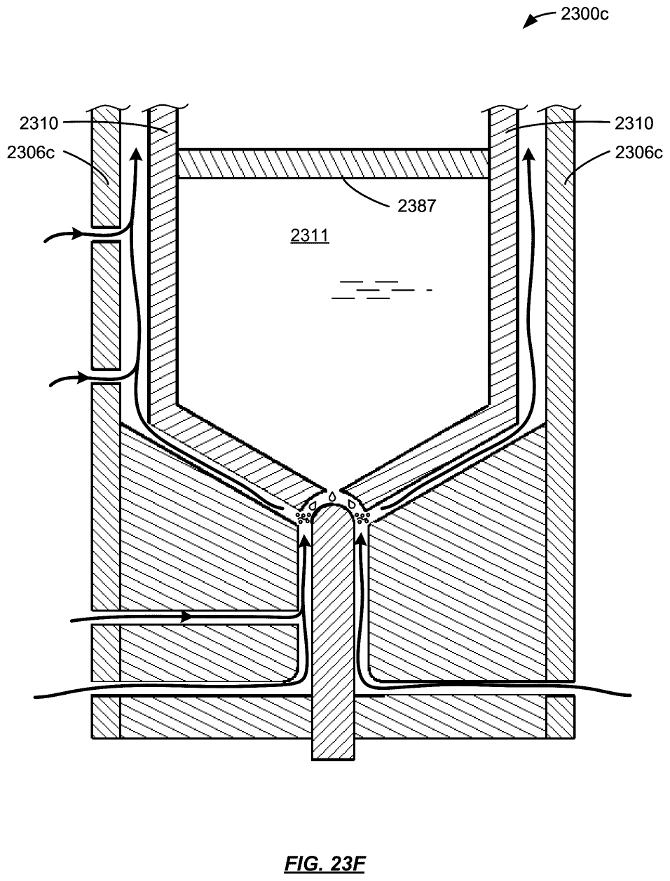

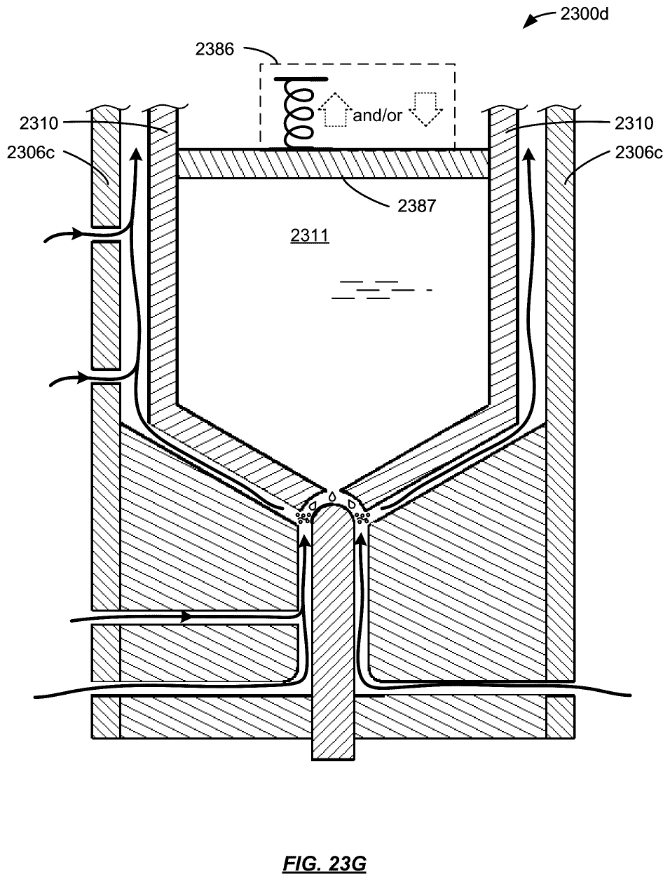

FIGS. 23A-23G illustrate variations of a seventeenth example personal vaporizing unit. In FIGS. 23A-23G, as shown in the Figures, one or more of PVUs 2300a-2300d may comprise one or more of vapor passageways 2304a-2304c, exterior housings 2306a-2306c, air intake passageways 2307a-2307e, reservoir body 2310, precursor passageway 2312, heater housing 2316, and moving reservoir seal 2387. Reservoir seal 2300a-2300d covers the top surface of precursor composition 2311 thereby at least preventing oxidation of precursor composition 2311. In some embodiments, reservoir seal moves as precursor composition 2311 is drained from reservoir 2332. This movement allows reservoir seal 2387 to maintain contact with 2311 composition 2311 thereby keeping precursor composition from coming into contact with ambient air that may oxidize or otherwise degrade precursor composition 2311. It should be understood that moving reservoir seal 2387 or a like function may be added to or be a component of any of the PVUs described herein.

FIGS. 23A-23B illustrate PVU 2300a. In FIGS. 23A-23B, PVU 2300a includes vapor passageway 2304a, exterior housings 2306a, air intake passageways 2307a-2307c, reservoir body 2310, precursor passageway 2312, entrainment zone/gap 2314, heater housing 2316, and reservoir seal 2387. FIG. 23B illustrates the air and vapor flows of PVU 2300a when being operated.

When a user inhales and PVU 2300a is activated, air flows into primary air intake passageways 2307a-2307b and proceeds along one or more exterior surfaces of heater housing 2316 and is thereby heated. The air received via air intake passageway 2307b also flows past/across an interior end of secondary air intake passageway 2307c. Based on one or more of Coanda and/or Venturi effects, additional air received via the secondary air intake passageway 2307c joins the flow of air from air intake passageway 2307b that is flowing along heater housing 2316. The combined airflow proceeds to (and through) entrainment zone 2314.

As the combined airflow flows through entrainment zone 2314, the combined airflow also flows past a passageway that leads to precursor passageway 2312. Thus, based on one or more of Coanda and/or Venturi effects, the air flowing through entrainment zone 2314 exerts a negative pressure force (e.g., vacuum) on the precursor composition 2311 (both in the passageway and in reservoir 2332). In an embodiment, the combined effects of heating precursor composition 2311 (i.e., increasing precursor composition 2311 temperature—ΔT↑) and the vacuum effect (i.e., decreasing pressure on precursor composition 2311 relative to ambient—ΔP↓) is required to mobilize precursor composition 2311 to move from reservoir 2332 to entrainment zone 2314. Note that in some embodiments, decreasing pressure on precursor composition 2311 also reduces boiling, melting, and/or viscosity target temperature (e.g., according to the ideal gas law equation—PV=nRT). In these embodiments, for example, the temperature precursor composition 2311 (and/or air flowing through entrainment zone 2214) may be selected or controlled to determine the amount or flow of precursor composition 2311 relative to the force of the user's inhale (i.e., AP).

Similarly, in some embodiments, the characteristics of the heater, heater housing 2316, air intake channels 2307a-2307c, and/or the flow channels of PVU 2300a may be selected and/or balanced to form a feedback loop that controls the amount or flow of precursor composition 2311 dispensed. For example, a relatively forceful (as compared to a baseline) inhale by the user increases the flow of air along the exterior of heater housing 2316 (when compared to a baseline inhale). One or more of the aforementioned characteristics may be selected such that this increased flow decreases the temperature on the exterior of heater housing 2316 because, for example, the increased mass of the increased flow draws more heat from heater housing 2316. The decreased temperature of heater housing 2316 may result in a decreased temperature of precursor composition 2311 thereby increasing its viscosity and lowering its flow rate. Thus, as a result of an airflow/pressure/temperature/viscosity feedback loop, when the characteristics of PVU 2300a are selected appropriately, the pressure decrease caused by the forceful inhale is offset (or approximately offset) by an increase in the viscosity of precursor composition 2311 to result in the same (or approximately the same) dose for the baseline inhale as the forceful inhale.

FIGS. 23C-23D illustrate PVU 2300b. In FIGS. 23C-23D, PVU 2300b includes vapor passageway 2304b, exterior housings 2306b, air intake passageways 2307a-2307d, reservoir body 2310, precursor passageway 2312, entrainment zone/gap 2314, heater housing, 2316, and reservoir seal 2387. FIG. 23D illustrates the air and vapor flows of PVU 2300b when being operated. PVU 2300b operates similarly to, uses the same principles, and may be designed for a feedback loop, as PVU 2300b, except with the addition of air intake passageway 2307d along vapor passageway 2304b. Accordingly, for the sake of brevity, a discussion of these principles etc. will not be repeated with respect to FIGS. 23C-23D.

FIGS. 23E-23F illustrate PVU 2300c. In FIGS. 23E-23F, PVU 2300c includes vapor passageway 2304c, exterior housings 2306c, air intake passageways 2307a-2307e, reservoir body 2310, precursor passageway 2312, entrainment zone/gap 2314, heater housing 2316, and reservoir seal 2387. FIG. 23F illustrates the air and vapor flows of PVU 2300c when being operated. PVU 2300c operates similarly to, uses the same principles, and may be designed for a feedback loop, as PVU 2300b, except with the addition of a second air intake passageway 2307e along vapor passageway 2304c. Accordingly, for the sake of brevity, a discussion of these principles etc. will not be repeated with respect to FIGS. 23C-23D.

FIG. 23G illustrates PVU 2300d. In FIG. 23G, PVU 2300d includes vapor passageway 2304c, exterior housings 2306c, air intake passageways 2307a-2307e, reservoir body 2310, precursor passageway 2312, entrainment zone/gap 2314, heater housing 2316, reservoir seal 2387, and seal force 2386. Thus, PVU 2300d operates similarly to, uses the same principles, and may be designed for a feedback loop, as PVUs 2300a-2300c, except with the addition of seal force 2386. Accordingly, for the sake of brevity, a discussion of these principles etc. will not be repeated with respect to FIGS. 23C-23D. Seal force 2386 functions to either increase the pressure on precursor composition 2311 inside reservoir 2332 (thereby aiding in the expulsion of precursor composition 2311 and increasing its melting point) or decrease the pressure on precursor composition 2311 (thereby retarding in the expulsion of precursor composition 2311 and reducing its melting point). Seal force 2386 may be provided by, for example, a spring, positive gas pressure (e.g., air above ambient air pressure), negative gas pressure (e.g., a vacuum or partial vacuum), gravity, etc.

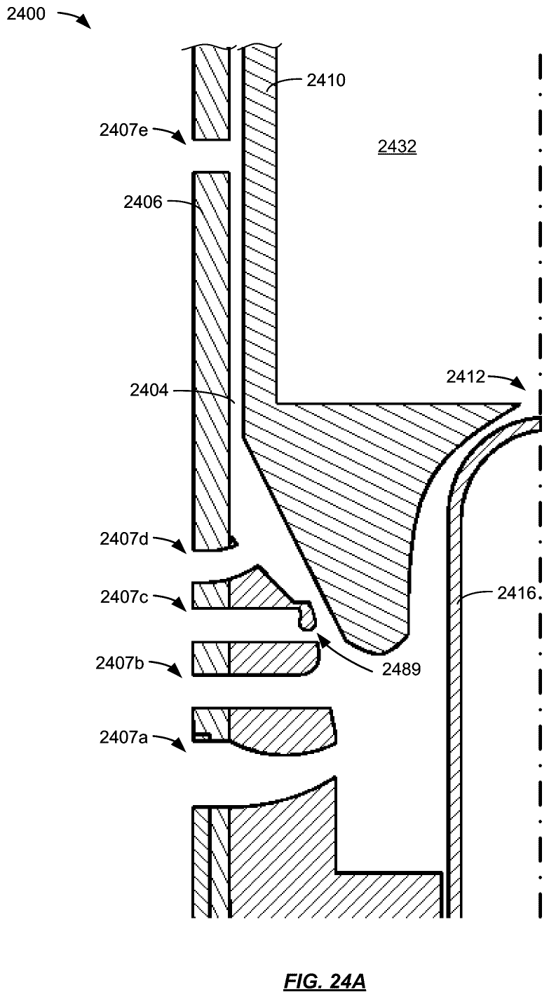

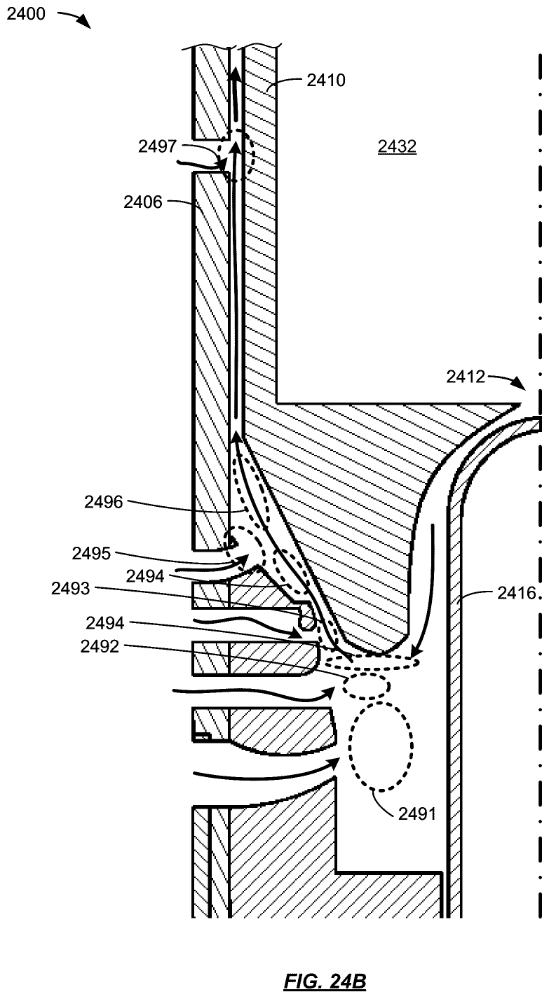

FIGS. 24A-24B illustrate an eighteenth example personal vaporizing unit. In FIGS. 24A-24B, in order to improve the visibility of certain features, only the left half of the cross-section of PVU 2400 is illustrated. In FIGS. 24A-24B, PVU 2400 may comprise one or more of exterior housing 2406, air intake passageways 2407a-2407e, reservoir body 2410, precursor passageway 2412, heater housing 2416, and reservoir 2432. In FIG. 24B, the approximate location and extent of a number of airflow regions 2491-2497 are illustrated.

When a user inhales, air flows into PVU 2400 via air intake passageway 2407a and enters region 2491. Region 2491 is characterized by laminar flow of air that is increasing in velocity, increasing in temperature (i.e., being heated by heater housing 2416), and increasing in pressure. To increase the entrainment of the precursor composition from reservoir 2432, air entering via air intake passageway 2407a may be induced to increase in velocity by the decreasing cross-section of the passageway.

Air also enters PVU 2400 via air intake passageway 2407b. The flow of air entering PVU 2400 via air intake passageway 2407b may be increased via the Coanda effect which is aided by the change in pressure between air intake passageway 2407a and air intake passageway 2407b. The air that entered via air intake passageway 2407a is mixed with the air that entered via air intake passageway 2407b in region 2492. The mixing of these two flows in region 2492 may be aided or rely upon Venturi effects. In region 2492, the temperature, pressure, and velocity of the flow is decreased by the mixing of the two flows. The mixed air flows proceed from region 2492 to entrainment region 2493. In entrainment region 2493, the pressure of the air flow is increased by its mixing with the increased temperature of the heated precursor composition.

Air also enters PVU 2400 via air intake passageway 2407c. The flow of air entering PVU 2400 via air intake passageway 2407b may be increased via the Coanda effect. Coanda wing feature 2489 helps to increase the pressure and velocity of the flow in region 2493. From region 2493, the flow proceeds to expansion region 2494. In expansion region 2494, pressure decreases, velocity decreases, and temperature is increased to allow large particle return (e.g., to entrainment region). Additional air enters PVU 2400 via air intake passageway 2407d. The flow of air entering PVU 2400 via air intake passageway 2407c may be increased via the Coanda effect. The shape of air intake passageway 2407c and the shape of its junction with vapor passageway 2404 in region 2495 increases laminar flow, increases the velocity of the flow, decreases the temperature, and increases the pressure of the flowing vapor mixture. In region 2496, vapor passageway 2404 narrows (e.g., cross-sectional area is decreased) thereby increasing the pressure, increasing the velocity, and decreasing temperature of the flow. Additional air may be drawn into PVU 2400 via air intake 2497 and mix with the flow moving along vapor passageway 2404 in region 2497.

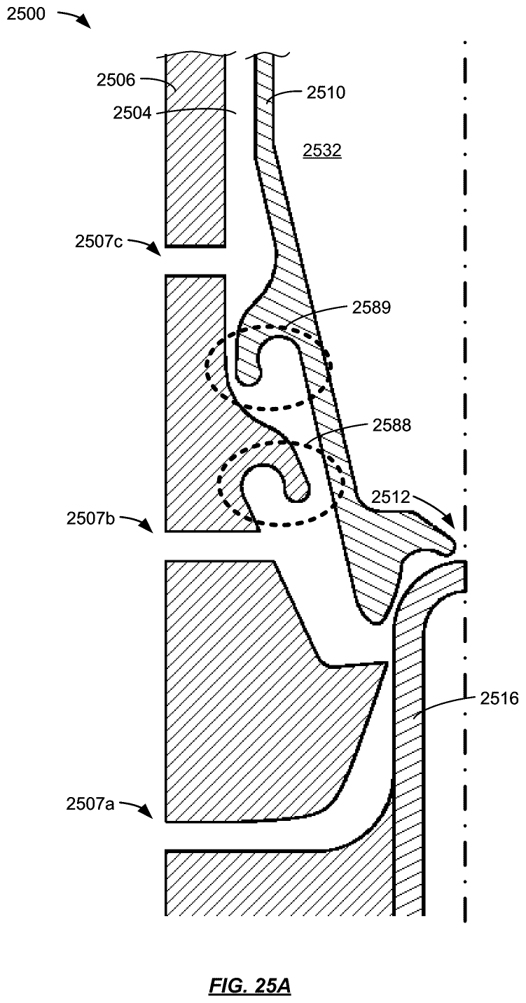

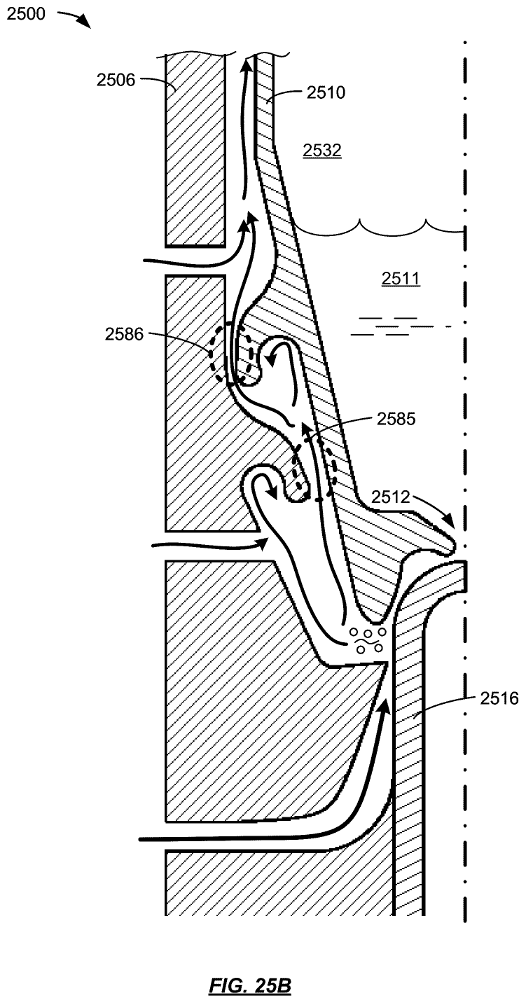

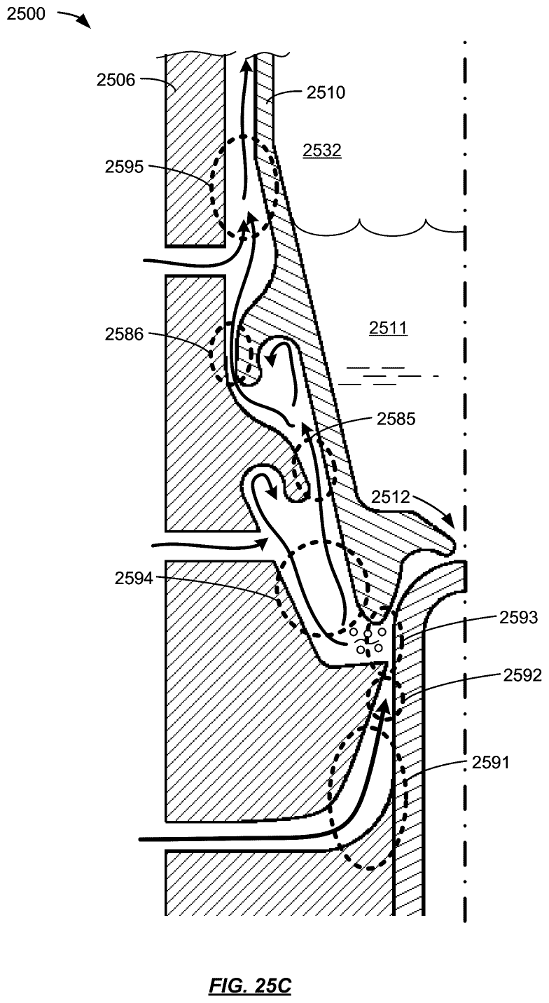

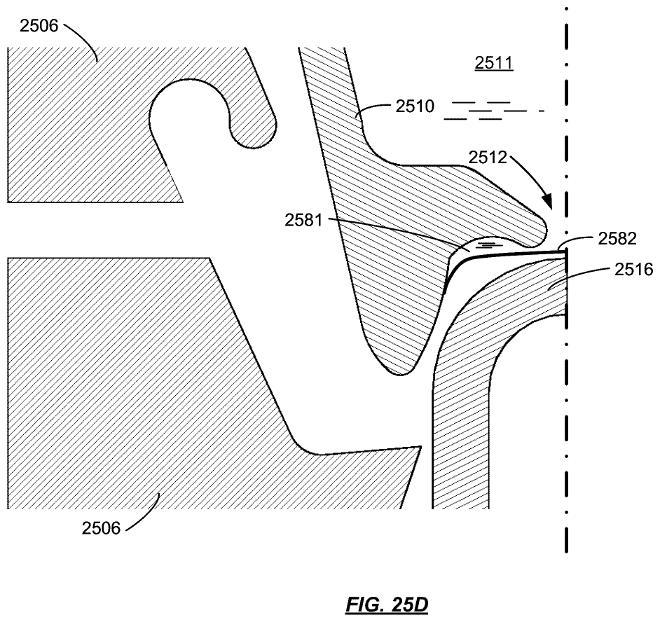

FIGS. 25A-25D illustrate a nineteenth example personal vaporizing unit. In FIGS. 25A-25D, in order to improve the visibility of certain features, only the left half of the cross-section of PVU 2500 is illustrated. In one or more of FIGS. 25A-25D, PVU 2500 may comprise one or more of exterior housing 2506, air intake passageways 2507a-2507c, reservoir body 2510, precursor composition 2511, precursor passageway 2512, heater housing 2516, reservoir 2532, particle impaction flow features 2588-2589, and flow constriction/director regions 2585-2586.

When a user inhales, air flows into PVU 2500 via air intake passageway 2507a and enters region 2591. In region 2591, the flow is substantially laminar and increasing in velocity as the passageway narrows. The flow is also being heated by heater housing 2516 while passing through region 2591. From region 2591, the flow proceeds to region 2592. In region 2592, the flow reaches a peak and/or maximum velocity. Also in region 2592, the convective heating of the flow (i.e., heat energy transfer to) reaches a peak and/or maximum rate. From region 2592, the flow proceeds to region 2593.

Region 2593 corresponds to the entrainment region where precursor composition 2511 is entrained in the flow as vapor and/or aerosol particles. In region 2593, peak pressure for precursor composition and the flow may be reached with the narrowing of the passageway. Also in region 2593, the temperature of the flow increases due at least in part to the flow mixing/entraining with heated precursor 2511. From region 2593, the flow, which now includes precursor composition 2511 (vapor and/or aerosol), proceeds to region 2594.

In region 2594, the passageway expands relative to region 2593. This results in the pressure, temperature, and velocity of the flow decreasing in region 2594. The flow also may return to having laminar flow characteristics. Also in region 2594, large particles may be trapped and/or fall out of suspension due at least in part to the decreasing velocity of the flow. For region 2594, the flow proceeds to particle impaction feature 2588. From particle impaction feature 2588, the flow proceeds to particle impaction feature 2589. Before reaching impaction feature 2588, additional air is received into the flow via air intake passageway 2507b. Air intake passageway 2507b may be configured to use one or more of the Venturi and Coanda effects to increase the amount additional air received air intake passageway 2507b.

In the region of particle impaction features 2588-2589, the pressure of the flow decreases, and the temperature and velocity increase. Particle impaction features 2588-2589 serve as impaction surfaces and help select, by mass, the small (or smaller) (e.g., less than or equal to approximately 10 μm) particles to pass beyond the respective impaction feature 2588-2589. Impaction features 2588-2589 include flow constriction/director regions 2585-2586, respectively, that increase the flow velocity, decrease flow temperature, and increase the pressure of the flow.

From impaction feature 2589, the flow proceeds to region 2595. Before reaching region 2595, additional air is received into the flow via air intake passageway 2507c. Air intake passageway 2507c may be configured to use one or more of the Venturi and Coanda effects to increase the amount additional air received air intake passageway 2507c. In region 2595 and in the vicinity of air intake passageway 2507c, the temperature, pressure, and velocity of the flow decrease. Also in region 2595, the flow may return to having laminar flow characteristics.

In an embodiment, in the vicinity of air intake passageway 2507c, the velocity of the flow decreases and pressure increases (due at least in part to the increased amount of air received from air intake passageway 2507c, and the Coanda and/or Venturi effects). The relatively high velocity air received via air intake passageway 2507c may also select for smaller particles sizes e.g., less than or equal to approximately 10 μm).

FIG. 25D illustrates some details that may be used in the vicinity of region 2593 (entrainment region). As illustrated in FIG. 25D, region 2593 (and reservoir body 2510, in particular) may have features that use a capillary action of precursor composition 2511 to form a capillary pocket 2581 of precursor composition 2511. This is illustrated in FIG. 25D by capillary pocket 2581 of precursor composition 2511 being held in place by meniscus 2582 and in communication with the bulk of precursor composition 2511 in reservoir 2532 via precursor passageway 2512. In an embodiment, capillary pocket 2581 of precursor composition 2511 has a hydrostatic pressure of precursor composition 2511 that is greater than or equal to the hydrostatic pressure of precursor composition 2511 in reservoir 2532. The hydrostatic forces exerted on precursor composition 2511 in capillary pocket 2581 (which includes gravity) dictate precursor composition 2511 in capillary pocket 2581 is hydrostatically “locked” in capillary pocket 2581 unless and until additional forces (e.g., reduced pressure caused by an inhale) free the precursor composition 2511 in capillary pocket 2581.

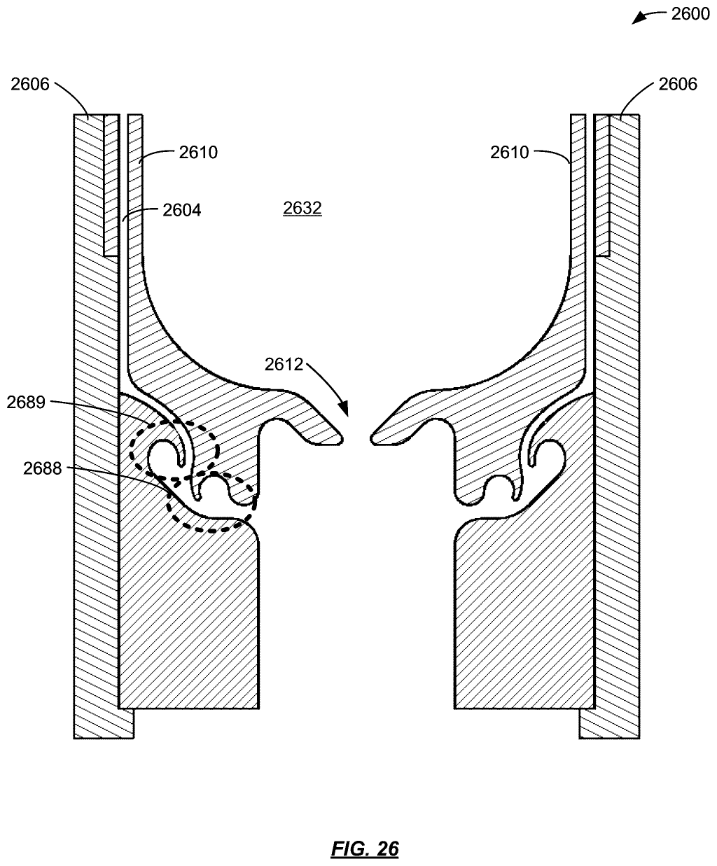

FIG. 26 illustrates example particle impaction features and flow path. FIG. 26 is a cross-section of an example housing 2606 and reservoir body 2610 configuration. In FIG. 26, PVU 2600 includes vapor passageway 2604, housing 2606, reservoir body 2610, precursor passageway 2612, reservoir 2632, and particle impaction features 2688-2689. Housing 2606 and reservoir body 2610 are configured to form vapor passageway 2604. Housing 2606 and reservoir body 2610 are also configured to form example particle impaction features 2688-2689 along vapor passageway 2604.

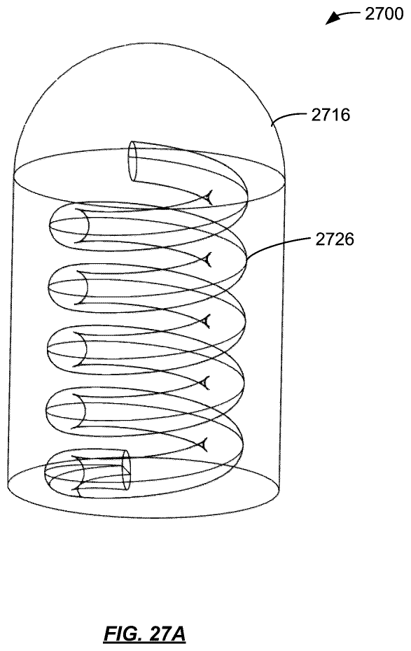

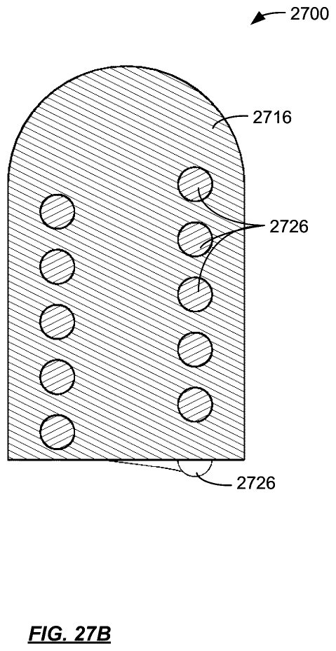

FIGS. 27A-27B illustrates an example heater and heater housing assembly. FIGS. 27A-27B heater assembly 2700 comprises heater housing 2716 and heater 2726. FIG. 27A is a view of heater assembly 2700 showing both internal and externally visible components. FIG. 27B is a cross-section of heater assembly 2700. In an embodiment, heater 2726 may comprise a heater coil (e.g., of nichrome wire). In an embodiment, heater housing 2716 may be glass that contacts a majority of the external surface(s) of heater 2726 and substantially encapsulates heater 2726 in three dimensions. The substantial encapsulation in three dimensions, and contact with, heater 2726 and heater housing 2716 may increase the thermal transfer of heat from heater 2726 to the external surface of heater housing 2716.

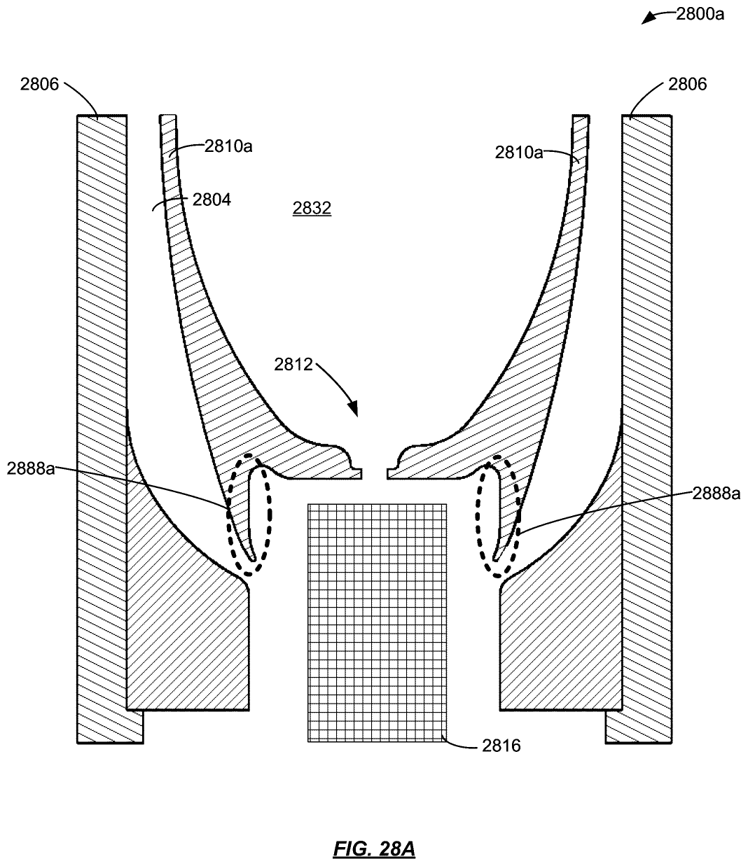

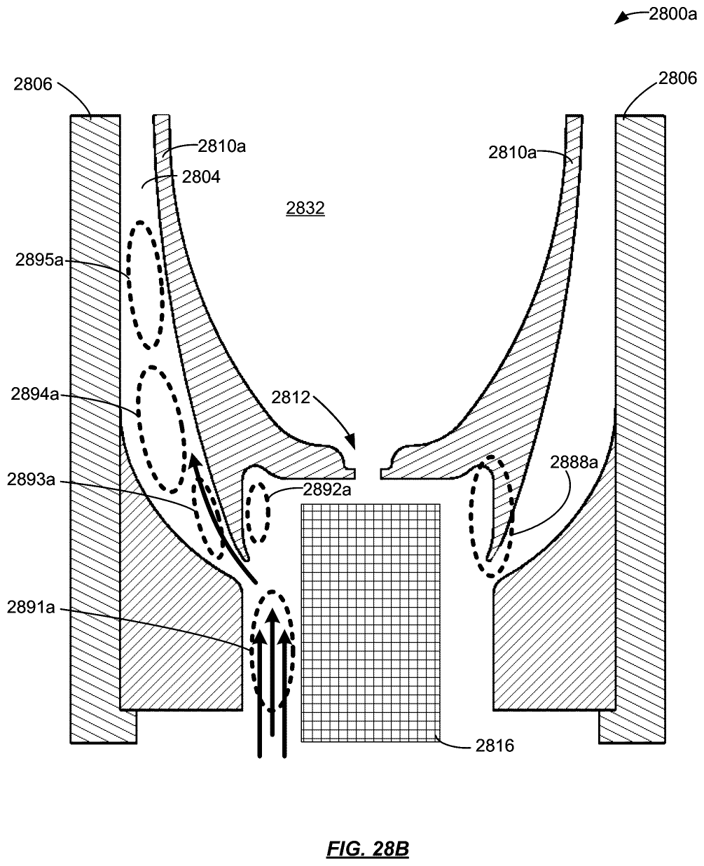

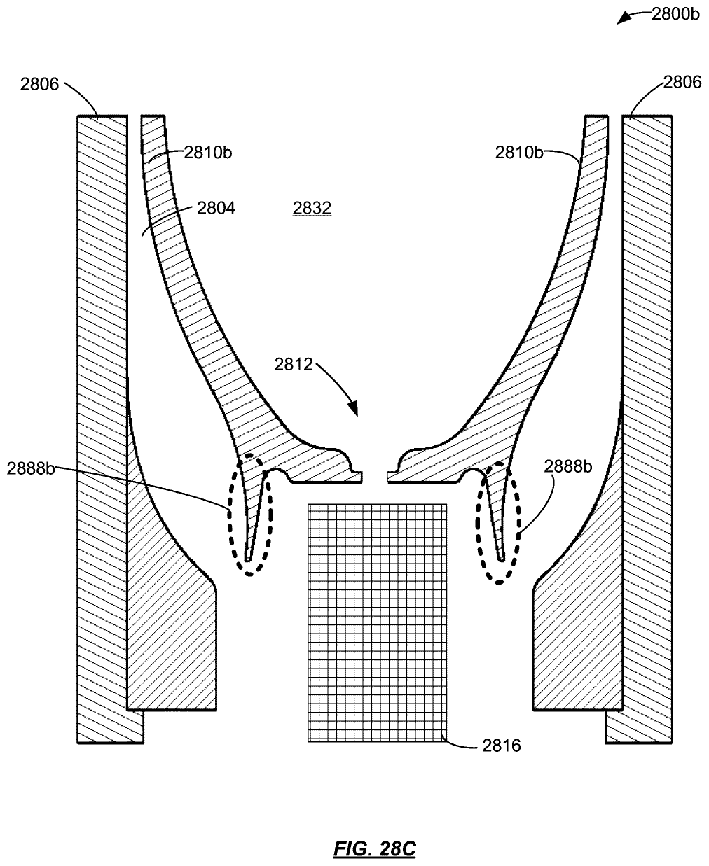

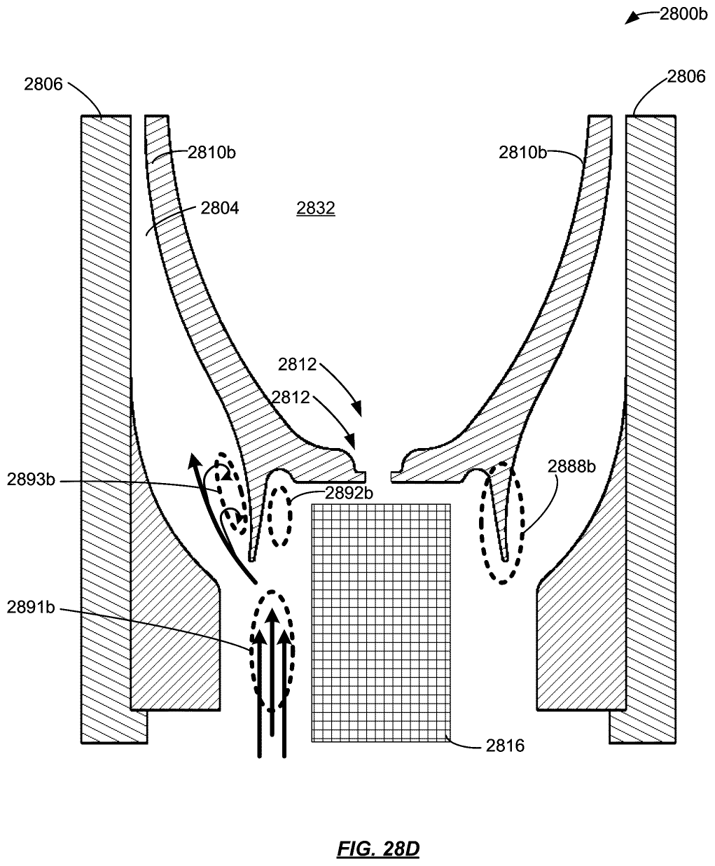

FIGS. 28A-28D illustrate example flow directing features and flowpath. FIGS. 28A-28B illustrate a cross-section of an example housing 2806 and reservoir body 2810a configuration. In FIGS. 28A-28B, PVU 2800a includes vapor passageway 2804, housing 2806, reservoir body 2810a, precursor passageway 2812a, heater housing 2816, reservoir 2832a, and flow directing features 2888a. Housing 2806 and reservoir body 2810a are configured to form vapor passageway 2804. Housing 2806 and reservoir body 2810a are also configured to form example flow directing features 2888a along vapor passageway 2804. Referenced to the vertical (e.g., long direction of housing 2806 and or laminar flow direction of air moving over flow directing feature 2888a), flow directing features 2888a have a positive (e.g., 20°) angle of attack.

When a user inhales, air flows into PVU 2800a and enters region 2891a. In an embodiment, in region 2891a, the flow has laminar characteristics. The flow is also heated by at least one of radiation or convection. Flow then proceeds to region 2893a. In region 2893a, the flow may be understood to be flowing of the “top” of the wing-like flow directing feature 2888a. Thus, region 2892a, which is on the “bottom” of the wing-like flow directing feature 2888a has the characteristic of a relatively constant pressure. In an embodiment the pressure in region 2892a is greater than the pressure of region 2893a.

In an embodiment, in region 2893a, the flow has laminar characteristics a relatively (e.g., to region 2981a and/or region 2892a) high velocity. In some embodiments, however, the angle of attack of flow director 2888a has been selected such that at least some turbulent flow forms in region 2893a. This turbulent flow may aid in the formation of small aerosol particles and/or in the selection of smaller aerosol particles. In region 2893a, the temperature of the flow increases and the pressure decreases. From region 2893a, the flow proceeds to an expansion region 2894a (e.g., cross section of vapor passageway 2802 increases).

In region 2894a, the velocity of the flow decreases and the temperature increases. The decreasing velocity of the flow helps induce larger aerosol particles (e.g., greater than 10 μm) to fall out of entrainment/suspension. From region 2894a, the flow proceeds to region 2895a. In region 2895a, the flow is compressed (e.g., cross section of vapor passageway 2802 decreases). In region 2895a, the velocity of the flow increases. The increasing velocity of the flow helps select smaller aerosol particles (e.g., less than 10 μm) to remain in the flow and proceed to the user.

In FIGS. 28C-28D, PVU 2800b includes vapor passageway 2804, housing 2806, reservoir body 2810b, precursor passageway 2812b, heater housing 2816, reservoir 2832b, and flow directing features 2888b. Housing 2806 and reservoir body 2810b are configured to form vapor passageway 2804. Housing 2806 and reservoir body 2810b are also configured to form example flow directing features 2888b along vapor passageway 2804. Referenced to the vertical (e.g., long direction of housing 2806 and or laminar flow direction of air moving over flow directing feature 2888b), flow directing features 2888b have a positive (e.g., −5°) angle of attack.

When a user inhales, air flows into PVU 2800b and enters region 2891b. In an embodiment, in region 2891b, the flow has laminar characteristics. The flow is also heated by at least one of radiation or convection. Flow then proceeds to region 2893b. In region 2893b, the flow may be understood to be flowing over the “bottom” of the wing-like flow directing feature 2888b. Region 2892b, which is on the “top” of the wing-like flow directing feature 2888b has the characteristic of a relatively constant pressure. In an embodiment the pressure in region 2893a is greater than the pressure of region 28932.

In an embodiment, in region 2893b, the flow has laminar characteristics a relatively (e.g., to region 2981b and/or region 2892b) high velocity. In some embodiments, however, the angle of attack of flow director 2888b has been selected such that at least some turbulent flow forms in region 2893b. This turbulent flow may aid in the formation of small aerosol particles and/or in the selection of smaller aerosol particles.

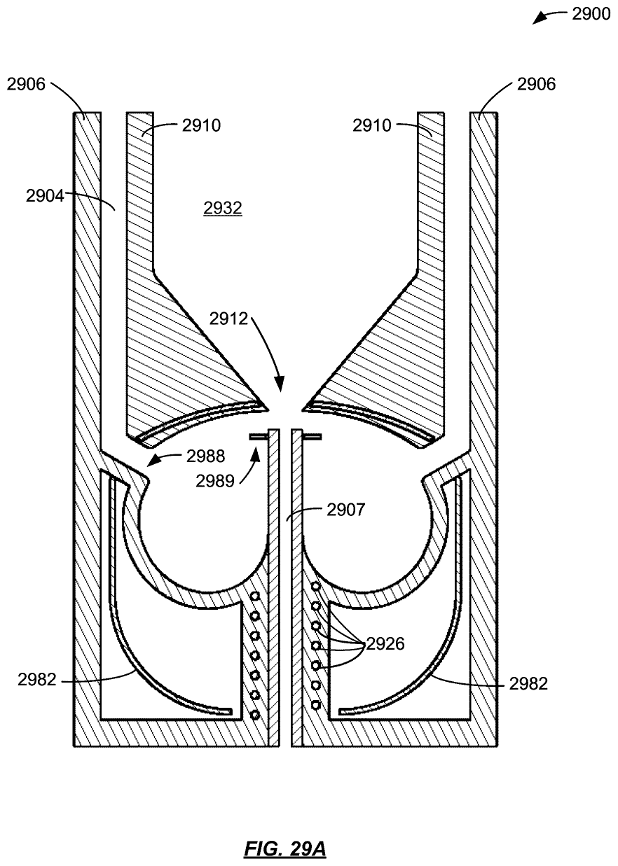

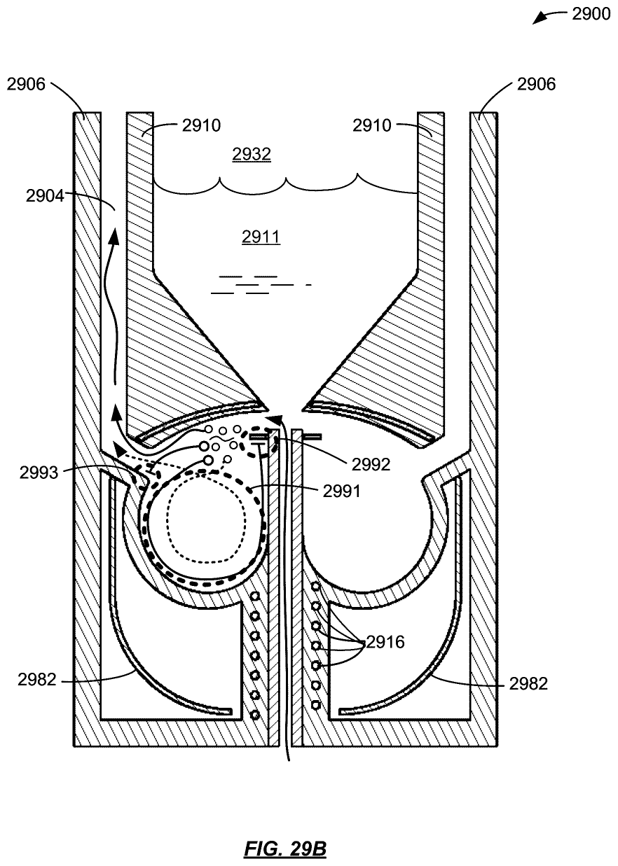

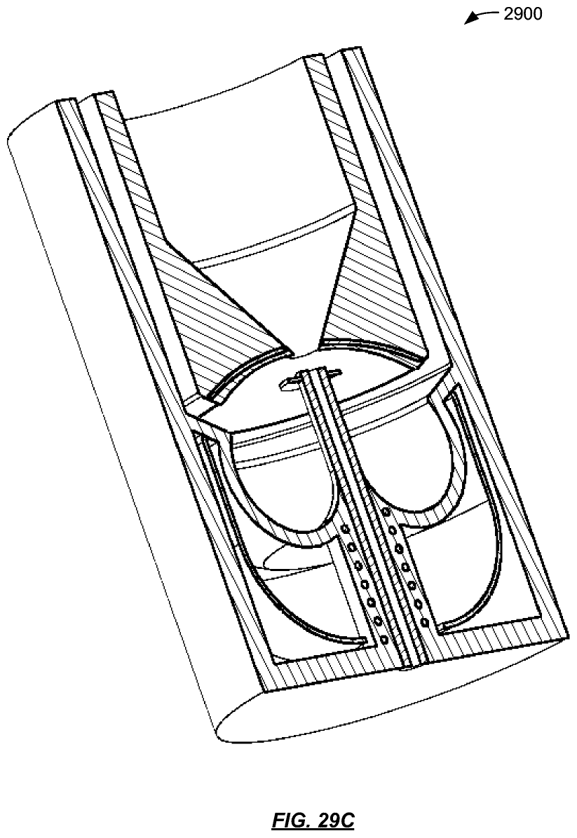

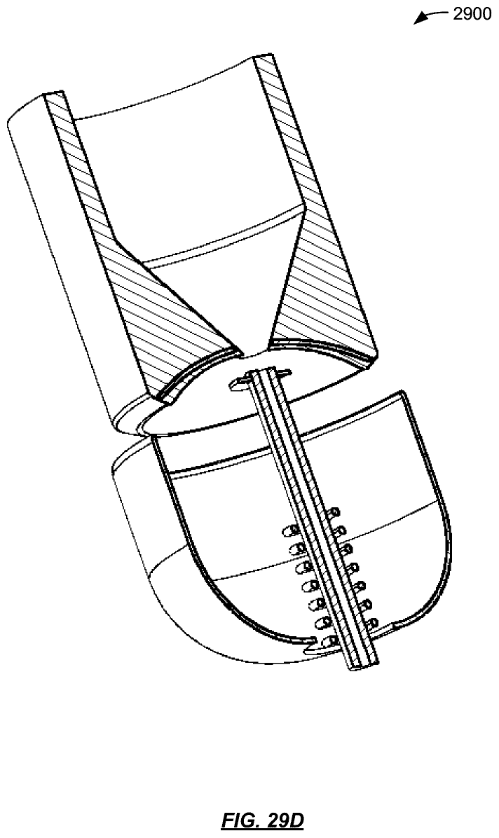

FIGS. 29A-29D illustrate a twentieth example personal vaporizing unit. In one or more of FIGS. 29A-29D, PVU 2900 may comprise one or more of exterior housing 2906, air intake passageway 2907, reservoir body 2910, precursor composition 2911, precursor passageway 2912, heater 2926, reservoir 2932, IR reflector 2982, and particle impaction flow features 2988-2989. FIGS. 29A-29B are cross-sectional diagrams. FIG. 29C is an isometric cross-section. FIG. 29D is an isometric cross-section with exterior housing 2906 not shown in order to better illustrate some internal features and/or components of PVU 2900.

When a user inhales, air flows into PVU 2900 via air intake passageway 2907. In an embodiment, the flow in air intake passageway 2907 is substantially laminar. The flow is also being heated by heater 2926 while traveling through air intake passageway 2907. In an embodiment, the flow in air intake passageway may be non-laminar therby increasing, when compared to a laminar flow, the transit time that air in the flow spends in air intake passageway 2907 thereby increasing the air in the flow is subject to heating by heater 2926. In the vicinity where the flow exits of air intake passageway 2907, precursor composition 2911 is entrained in the flow as vapor and/or aerosol particles. The flow comprising heated air, precursor composition 2911 vapor, and/or precursor composition 2911 aerosol particles then enters aerosol generating region/chamber 2993.

In aerosol generating region 2993, the flow may form at least one vorticle. The vorticle and laminar increasing velocity of the flow induces larger entrained aerosol particles to the outer flow boundary based on centrifugal forces. These larger particles may strike housing 2906 in region 2993 and thereby be removed from the flow. The precursor 2911 that is removed from the flow as larger particles may be further heated/reheated by IR radiation from heater 2926 to become smaller particles and/or vapor. IR radiation from heater 2916 may be reflected by IR reflector 2982 to direct IR radiation at region 2993. Smaller and/or lighter particles can exit the vorticle near the center of region 2993 where the velocity of the flow is lower. The larger entrained particles may also be removed from the flow by particle impaction flow features 2988-2989 in regions 2992-2993 which are disposed along the vorticle boundary layer. The vaporized precursor composition 2911 and smaller aerosol particles of precursor composition 2911 are able to remain in suspension and exit region 2993 via vapor passageway 2904 to be inhaled by the user.

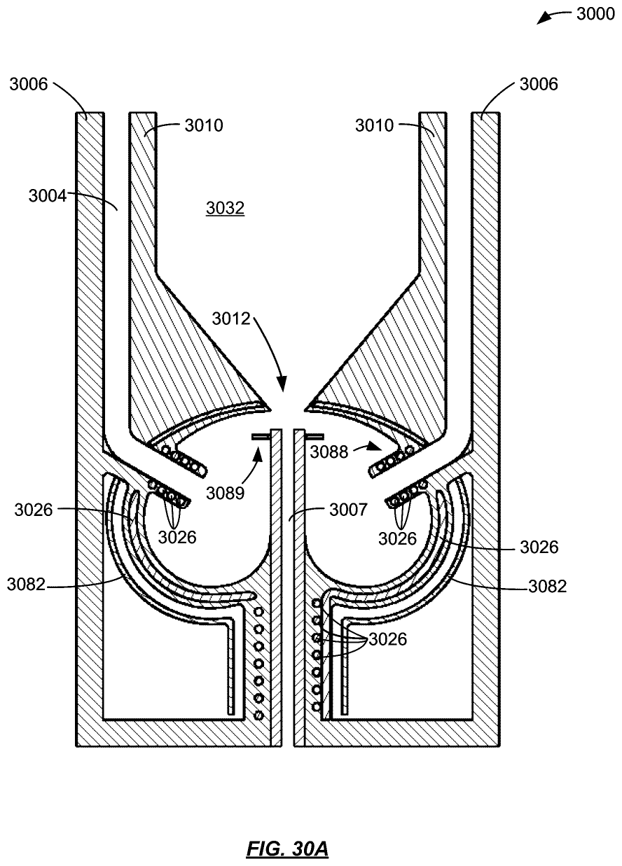

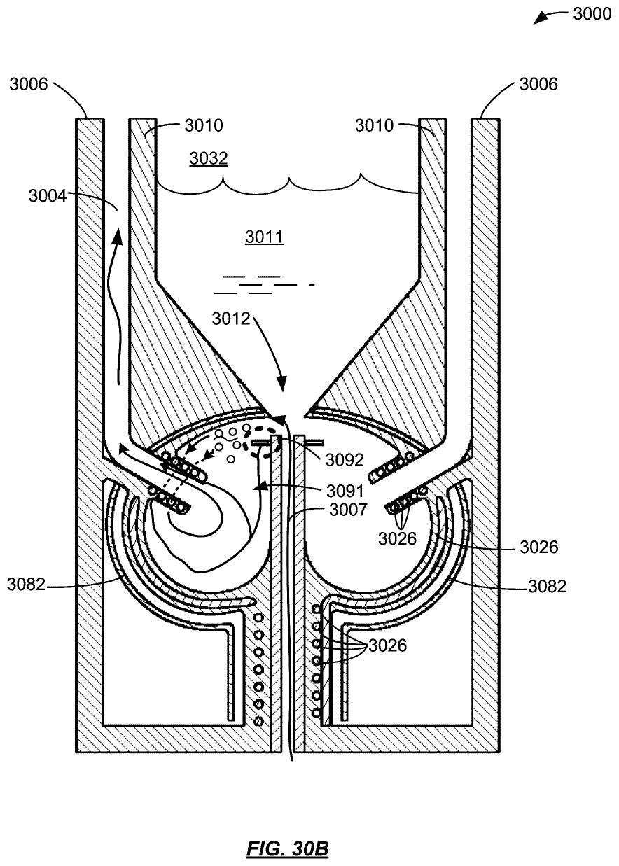

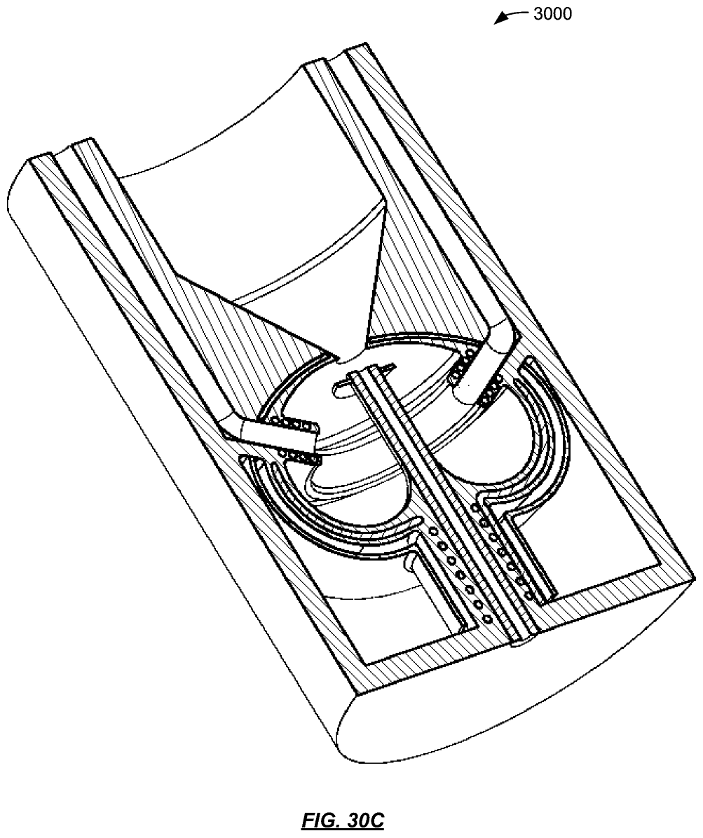

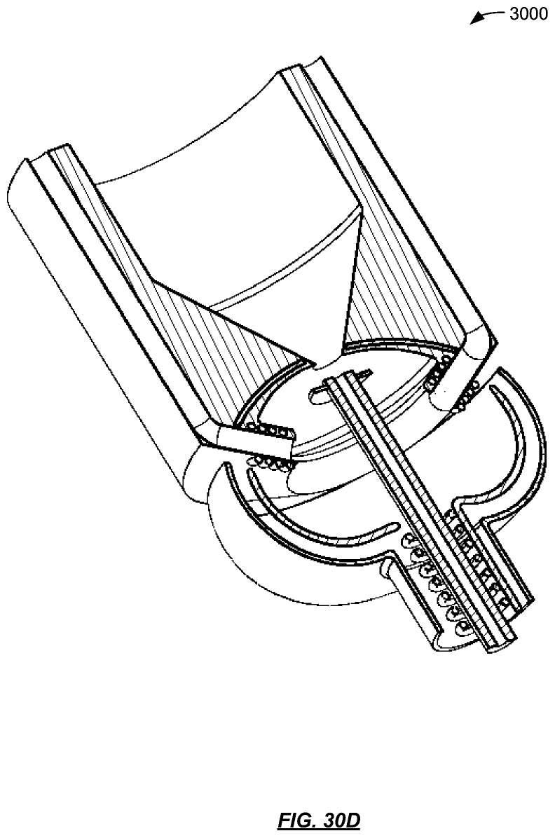

FIGS. 30A-30D illustrate a twenty-first example personal vaporizing unit. In one or more of FIGS. 30A-30D, PVU 3000 may comprise one or more of exterior housing 3006, air intake passageway 3007, reservoir body 3010, precursor composition 3011, precursor passageway 3012, heater 3026, reservoir 3032, IR reflector 3082, and particle impaction flow features 3088-3089. FIGS. 30A-30B are cross-sectional diagrams. FIG. 30C is an isometric cross-section. FIG. 30D is an isometric cross-section with exterior housing 3006 not shown in order to better illustrate some internal features and/or components of PVU 3000.

When a user inhales, air flows into PVU 3000 via air intake passageway 3007. In an embodiment, the flow in air intake passageway 3007 is substantially laminar. The flow is also being heated by heater 3026 while traveling through air intake passageway 3007. In an embodiment, the flow in air intake passageway may be non-laminar thereby increasing, when compared to a laminar flow, the transit time that air in the flow spends in air intake passageway 3007 thereby increasing the air in the flow is subject to heating by heater 3026. In the vicinity where the flow exits of air intake passageway 3007, precursor composition 3011 is entrained in the flow as vapor and/or aerosol particles. The flow comprising heated air, precursor composition 3011 vapor, and/or precursor composition 3011 aerosol particles then enters aerosol generating region/chamber 3091.

In aerosol generating region 3091, the flow may form at least one vorticle. The vorticle and laminar increasing velocity of the flow induces larger entrained aerosol particles to the outer flow boundary based on centrifugal forces. These larger particles may strike housing 3006 in region 3091 and thereby be removed from the flow. The precursor 3011 that is removed from the flow as larger particles may be further heated/reheated by IR radiation from heater 3026 to become smaller particles and/or vapor. IR radiation from heater 3026 may be reflected by IR reflector 3082 to direct IR radiation at region 3091. Smaller and/or lighter particles can exit the vorticle near the center of region 3091 where the velocity of the flow is lower. The larger entrained particles may also be removed from the flow by particle impaction flow features 3088-3089 which are disposed along the vorticle boundary layer. The vaporized precursor composition 3011 and smaller aerosol particles of precursor composition 3011 are able to remain in suspension and exit region 3091 via vapor passageway 3004 to be inhaled by the user. The flow in vapor passageway 3004 (and near region 3091, in particular) may also be further heated by heater 3026 while traveling through vapor passageway 3004.

Some heaters (e.g., 126, 226, 326, 426, 526, 626, and 1326) disclosed herein have been illustrated either in generic form (e.g., heaters 226, 326, 426, and 1326) or have an appearance suggesting a coil (e.g., heaters 126, 526, and 626). These appearances are merely for illustration purposed. It should be understood that one or more of heaters 126, 226, 326, 426, 526, 626, and 1326 may be one or more of coiled wire, ceramic heater cartridge, light bulb (e.g., tungsten, halogen, etc.) electro plated conductor on a substrate, directly written conductor, and/or deposited conductors manufactured via know methods of metal deposition. In addition, heaters 126, 226, 326, 426, 526, 626, and 1326 may be, or comprise, a coherent and/or non-coherent optical emitter irradiating a target on the inside of a housing (e.g., glass) that gets hot when irradiated (e.g., similar to laser diodes 766 and 866 irradiating laser target 767 and laser target 867, respectively). In other words, heaters 126, 226, 326, 426, 526, 626, and 1326 are not necessarily coils, but may be, or comprise, coils and/or other heating elements.

Implementations discussed herein include, but are not limited to, the following examples:

Example 1: A vaporizer, comprising: a reservoir to hold a precursor composition and comprising a first end having a passageway, the passageway having a first end to be in contact with the precursor composition and a second end on an exterior of the reservoir, the passageway adapted to not allow free flow of the precursor composition without heating at least a portion of the precursor composition in a vicinity of the passageway; an infrared radiation source to, when activated, heat the portion of the precursor composition in the vicinity of the passageway; and an entrainment passageway in communication with the second end of the passageway to, when the portion of the precursor composition is heated above a first temperature and an air flow is induced to pass through the entrainment passageway, draw heated precursor composition from the second end of the passageway to be entrained in the air flow.

Example 2: The vaporizer of example 1, wherein the heated precursor composition entrained in the air flow comprises vaporized precursor composition.

Example 3: The vaporizer of example 1, wherein the heated precursor composition entrained in the air flow is further heated by the infrared radiation source.

Example 4: The vaporizer of example 3, wherein the infrared radiation source heats the heated precursor composition entrained in the air flow producing vaporized precursor composition.

Example 5: The vaporizer of example 1, wherein the air flow is at least partially heated by the infrared radiation source prior to flowing past the second end of the passageway.

Example 6: The vaporizer of example 5, wherein the air flow is heated above a second temperature that produces a vapor from the precursor composition entrained in the air flow.

Example 7: The vaporizer of example 1, wherein the reservoir comprises glass.

Example 8: A vaporizer, comprising: a housing; a reservoir disposed within the housing, a gap between an exterior surface of the reservoir and an interior surface of the housing defining a vapor passageway, the reservoir configured to contain a precursor at ambient temperatures and to release the precursor via a precursor passageway when the vaporizer is being operated; an entrainment passageway in communication with the precursor passageway to receive released precursor from the precursor passageway, entrain the released precursor in an airflow generated by a user, and at least partially vaporize the released precursor; and an infrared radiation source to, when activated, heat the released precursor and the airflow to form a vapor from the released precursor.

Example 9: The vaporizer of example 8, wherein an amount of precursor released from the precursor passageway is based on at least one characteristic of an inhalation performed by the user.

Example 10: The vaporizer of example 9, wherein the release the precursor via the precursor passageway when the vaporizer is being operated is based at least in part of a heating of the precursor contained by the reservoir.

Example 11: The vaporizer of example 8, wherein the user inhales the vapor from the released precursor via the vapor passageway and a mouthpiece.

Example 12: The vaporizer of example 8, wherein the infrared radiation source comprises an electrically heated wire.

Example 13: The vaporizer of example 8, wherein the infrared radiation source comprises a diode to emit infrared radiation.

Example 14: The vaporizer of example 8, wherein the infrared radiation source comprises a crystal material adapted to resonate in response to modulated light.

Example 15: A cartridge for a vaporizer, comprising: a reservoir to contain a vapor precursor composition, the reservoir configured to be disposed within a housing of the vaporizer thereby forming a vapor passageway between a first exterior surface of the reservoir and an interior surface of the housing the reservoir further configured to contain the vapor precursor composition at ambient temperatures and to release the vapor precursor composition via a precursor passageway when the vaporizer is being operated; the vaporizer configured to form an entrainment passageway using a second exterior surface of the reservoir that includes the precursor passageway, the entrainment passageway in communication with the precursor passageway to receive released vapor precursor composition from the precursor passageway, entrain the released vapor precursor composition in an airflow generated by a user, and at least partially vaporize the released vapor precursor composition; and the vaporizer including an infrared radiation source to, when activated, heat the released vapor precursor composition and the airflow to form a vapor from the released vapor precursor composition.

Example 16: The cartridge of example 15, wherein an amount of vapor precursor composition released from the precursor passageway is based on at least one characteristic of an inhalation performed by the user.

Example 17: The cartridge of example 16, wherein the release the vapor precursor composition via the precursor passageway when the vaporizer is being operated is based at least in part of a heating of the vapor precursor composition contained by the reservoir.

Example 18: The cartridge of example 16, wherein the reservoir further comprises a septum to contain the vapor precursor composition within the reservoir.

Example 19: The cartridge of example 18, wherein the septum comprised a self-healing material.

Example 20: The cartridge of example 15, wherein at least the first exterior surface and the second exterior surface are composed of glass.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A vaporizer, comprising:
a reservoir to hold a precursor composition and comprising a first end having a passageway, the passageway having a first end to be in contact with the precursor composition and a second end on an exterior of the reservoir, the passageway adapted to not allow free flow of the precursor composition without heating at least a portion of the precursor composition in a vicinity of the passageway;
an infrared radiation source to, when activated, heat the portion of the precursor composition in the vicinity of the passageway; and
an entrainment passageway in communication with the second end of the passageway to, when the portion of the precursor composition is heated above a first temperature and an air flow is induced to pass through the entrainment passageway, draw heated precursor composition from the second end of the passageway to be entrained in the air flow.

2. The vaporizer of claim 1, wherein the heated precursor composition entrained in the air flow comprises vaporized precursor composition.

3. The vaporizer of claim 1, wherein the heated precursor composition entrained in the air flow is further heated by the infrared radiation source.

4. The vaporizer of claim 3, wherein the infrared radiation source heats the heated precursor composition entrained in the air flow producing vaporized precursor composition.

5. The vaporizer of claim 1, wherein the air flow is at least partially heated by the infrared radiation source prior to flowing past the second end of the passageway.

6. The vaporizer of claim 5, wherein the air flow is heated above a second temperature that produces a vapor from the precursor composition entrained in the air flow.

7. The vaporizer of claim 1, wherein the reservoir comprises glass.

8. A vaporizer, comprising:
a housing;
a reservoir disposed within the housing, a gap between an exterior surface of the reservoir and an interior surface of the housing defining a vapor passageway, the reservoir configured to contain a precursor at ambient temperatures and to release the precursor via a precursor passageway when the vaporizer is being operated;
an entrainment passageway in communication with the precursor passageway to receive released precursor from the precursor passageway, entrain the released precursor in an airflow generated by a user, and at least partially vaporize the released precursor; and
an infrared radiation source to, when activated, heat the released precursor and the airflow to form a vapor from the released precursor.

9. The vaporizer of claim 8, wherein an amount of precursor released from the precursor passageway is based on at least one characteristic of an inhalation performed by the user.

10. The vaporizer of claim 9, wherein the release the precursor via the precursor passageway when the vaporizer is being operated is based at least in part of a heating of the precursor contained by the reservoir.

11. The vaporizer of claim 8, wherein the user inhales the vapor from the released precursor via the vapor passageway and a mouthpiece.

12. The vaporizer of claim 8, wherein the infrared radiation source comprises an electrically heated wire.

13. The vaporizer of claim 8, wherein the infrared radiation source comprises a diode to emit infrared radiation.

14. The vaporizer of claim 8, wherein the infrared radiation source comprises a crystal material adapted to resonate in response to modulated light.

15. A cartridge for a vaporizer, comprising:
a reservoir to contain a vapor precursor composition, the reservoir configured to be disposed within a housing of the vaporizer thereby forming a vapor passageway between a first exterior surface of the reservoir and an interior surface of the housing the reservoir further configured to contain the vapor precursor composition at ambient temperatures and to release the vapor precursor composition via a precursor passageway when the vaporizer is being operated;
the vaporizer configured to form an entrainment passageway using a second exterior surface of the reservoir that includes the precursor passageway, the entrainment passageway in communication with the precursor passageway to receive released vapor precursor composition from the precursor passageway, entrain the released vapor precursor composition in an airflow generated by a user, and at least partially vaporize the released vapor precursor composition; and
the vaporizer including an infrared radiation source to, when activated, heat the released vapor precursor composition and the airflow to form a vapor from the released vapor precursor composition.

16. The cartridge of claim 15, wherein an amount of vapor precursor composition released from the precursor passageway is based on at least one characteristic of an inhalation performed by the user.

17. The cartridge of claim 16, wherein the release the vapor precursor composition via the precursor passageway when the vaporizer is being operated is based at least in part of a heating of the vapor precursor composition contained by the reservoir.

18. The cartridge of claim 16, wherein the reservoir further comprises a septum to contain the vapor precursor composition within the reservoir.

19. The cartridge of claim 18, wherein the septum comprised a self-healing material.

20. The cartridge of claim 15, wherein at least the first exterior surface and the second exterior surface are composed of glass.
